(19) United States
(12) Patent Application Publication
(10) Pub. No.: US 2006/0108294 A1
(43) Pub. Date: May 25, 2006

(54) Sewer system

(75) Inventors: Sakae Kosanda, Tokyo (JP); Yuichi Fuchu, Tokyo (JP); Norio Makita, Tokyo (JP); Yoshiharu Yasuhara, Tokyo (JP); Hideyuki Yoshida, Tokyo (JP); Shojiro Watanabe, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: EBARA CORPORATION, Tokyo (JP)

(21) Appl. No.: 10/991,448

(22) Filed: Nov. 19, 2004

(51) Int. Cl. C02F 1/50

(52) U.S. Cl. 210/754; 210/764; 210/198.1

(57) ABSTRACT

The present invention provides a sewer system having a means to quickly disinfect rainwater-incorporated sewage and pollutant-incorporated rainwater, that is, combined sewer overflow (CSO), separated sewer rainwater overflow and separated sanitary sewer overflow before being discharged to public water body without passing through a sewage treatment plant, and a method and an apparatus for disinfecting rainwater-incorporated sewage and pollutant-incorporated rainwater. One embodiment of the present invention is a sewer system wherein when sewage flows into a sewage treatment plant in an amount of not more than the treatment capacity of the sewage treatment plant, the sewage is subjected to predetermined treatments in the sewage treatment plant, and then disinfection with a chlorine-based disinfectant, and thereafter discharged to public water body, and when sewage containing rainwater in an amount of more than the treatment capacity of the sewage treatment plant flows or may flow into the sewage treatment plant by a big rainfall, the amount of the rainwater-incorporated sewage of more than the treatment capacity is branched in sewer stormwater overflow removing facilities of a sewer, then disinfected with a bromine-based disinfectant, and thereafter discharged to public water body while the rainwater-incorporated sewage in an amount within the treatment capacity of the sewage treatment plant is subjected to predetermined treatments in the sewage treatment plant, then disinfected with a chlorine-based disinfectant, and thereafter discharged to public water body.

### BACKGROUND OF THE INVENTION

The present invention relates to a method and an apparatus for disinfecting drainage, and particularly it relates to a method and an apparatus for disinfecting sewage diluted with rainwater, specifically, combined sewer overflow, separated sewer stormwater overflow or separated sanitary sewer overflow and a sewer system having such an disinfecting apparatus.

In a city, household waste water and industrial drainage are sent to a sewage treatment plant by a combined sewer or a separated sewer and is subjected to treatments in a sand basin for removing sand and the like, solid-liquid separation for removing suspended solids (SS), activated sludge treatment, and then disinfection in the order named, and thereafter discharged to public water body (public water area) such as rivers, lakes, ports and coastal waters.

Disinfection typically involves the use of a chlorine gas or a chlorine-based disinfectant because sewage, human waste, industrial drainage and the like contain pathogens which cause infectious diseases. Generally the chlorine-based disinfectant is added to such drainage to be treated to decrease the number of coliform organisms (coli bacteria) per one milliliter of the drainage to 3,000 CFU (colony forming unit)/mL or less. Alternatively, ultraviolet irradiation or ozonization may be performed without addition of the chlorine-based disinfectant but such a technique requires vast equipment, and accordingly its application is limited.

During or after heavy rains, however, due to the treatment capacity of the sewage treatment plant or the like, such a situation occurs that sewage incorporated with rainwater and rainwater incorporated with various pollutants have to be discharged to public water body without undergoing various treatments and disinfection in the sewage treatment plant. Thus, it is important to quickly disinfect this rainwater-mixed sewage and pollutant-mixed rainwater before being discharged to public water body.

### SUMMARY OF THE INVENTION

The present invention relates to a sewer system provided with means to quickly disinfect these rainwater-incorporated sewage and pollutant-incorporated rainwater which are discharged without passing through a sewage treatment plant or rainwater-incorporated primary effluent which is discharged to public water body without undergoing a biological treatment and disinfection in the sewage treatment plant, and it relates to a method and an apparatus for disinfecting rainwater-incorporated sewage and pollutant-incorporated rainwater.

### BRIEF DESCRIPTION OF THE DRAWINGS

FIG. 1 is a flow chart showing a typical example of the organization of a combined sewer.

FIG. 2 is a flow chart showing a typical example of the organization of a separated sewer.

FIG. 3 is a flow chart showing a typical example of the organization of a sewage treatment plant.

FIG. 4 is a schematic explanatory diagram for explaining a disinfecting apparatus relating to one embodiment of the present invention.

FIG. 5 is a schematic explanatory diagram for explaining one embodiment of the present invention which introduces a disinfectant into a sand basin.

FIG. 6 is a schematic explanatory diagram showing another embodiment of the present invention.

FIG. 7 is a schematic explanatory diagram showing one embodiment of an adding device for adding disinfecting water to sewer storm overflow according to the present invention.

FIG. 8 is a schematic explanatory diagram showing another embodiment which can be employed as a disinfectant storing/feeding device.

FIG. 9 is a diagram showing a specific example of the organization of a solid disinfectant storing section.

FIG. 10 shows one embodiment of a solid disinfectant storage tank.

FIG. 11 shows one embodiment of a solid disinfectant storage tank.

FIG. 12 shows one embodiment of a metering feeder.

FIG. 13 shows one embodiment of a metering feeder.

FIG. 14 is a diagram showing the form of a solid disinfectant storage tank connected to a container.

FIG. 15 is an explanatory diagram for explaining an example of the organization of a solid disinfectant container.

FIG. 16 is an explanatory diagram for explaining one embodiment of the form of installation of solid disinfectant supply facilities.

FIG. 17 is an explanatory diagram for explaining another embodiment of a container containing a solid disinfectant.

FIG. 18 is an explanatory diagram for explaining another example of the organization of a dissolving section for dissolving a solid disinfectant in water to form disinfecting water.

FIG. 19 is a diagram showing another form of a solid bromine-based disinfectant storing/feeding device which can be used in the present invention.

FIG. 20 is a diagram showing another form of a solid bromine-based disinfectant storing/feeding device which can be used in the present invention.

FIG. 21 is a diagram showing another example of a solid bromine-based disinfectant storing/feeding device which uses a single screw pump for fluid/powder transfer.

FIG. 22 is a diagram showing one specific example of a disinfecting apparatus for introducing a solid bromine-based disinfectant as such into the target sewer stormwater overflow to be treated relating to one embodiment of the present invention.

FIG. 23 is a diagram showing one embodiment of a disinfectant introducing device.

FIG. 24 is a diagram showing another embodiment of a disinfectant introducing device.

FIG. 25 is a diagram showing still another embodiment of a disinfectant introducing device.

FIG. 26 is a graph showing the residual ratio of undissolved disinfectant, the residual halogen concentration and the coliform organism count with time after introduction of a solid bromine based disinfectant into sewer stormwater overflow.

FIG. 27 is a diagram showing the concept of a disinfecting apparatus for sewer stormwater overflow relating to another embodiment of the present invention.

FIG. 28 is a diagram showing a varied form of a channel for sewer stormwater overflow after addition of a disinfectant.

FIG. 29 is a diagram showing another embodiment of a varied form of channel 507 of sewer stormwater overflow after addition of a disinfectant.

FIG. 30 is a diagram showing another embodiment of a varied form of channel 507 of sewer stormwater overflow after addition of a disinfectant.

FIG. 31 is a diagram showing the concept of one embodiment of a disinfecting apparatus for introducing a solid disinfectant into the target sewer stormwater overflow to be treated.

FIG. 32 is a diagram showing another example of the organization of a disinfecting apparatus of a system for introducing a solid bromine-based disinfectant as such into the target sewer stormwater overflow to be treated to disinfect it.

FIG. 33 is a diagram showing another example of the organization of a disinfecting apparatus of a system for introducing a solid bromine-based disinfectant as such into the target sewer stormwater overflow to be treated to disinfect it.

FIG. 34 is a graph showing the relationship between the elapsed time after a rainfall and the coliform organism count after disinfection when a predetermined amount of a halogen-based disinfectant is added to stormwater overflow in a sewage treatment facility.

FIG. 35 is graph showing the coliform organism count after disinfection when varied amounts of a halogen-based disinfectant are added to sewer stormwater 0.5 hour (Point A in FIG. 34) after starting rainfall.

FIG. 36 is a graph showing the coliform organism count after disinfection when varied amounts of a halogen-based disinfectant are added to sewer stormwater 45 minutes (Point B in FIG. 34) after starting rainfall.

FIG. 37 is a graph showing the coliform organism count after disinfection when varied amounts of a halogen-based disinfectant are added to sewer stormwater 1.5 hours (Point C in FIG. 34) after starting rainfall.

FIG. 38 are graphs showing the relationship between the elapsed time after addition of a disinfectant and the residual halogen concentration in the treated water when a predetermined amount of a halogen-based disinfectant is added to stormwater overflow after various times elapsed.

FIG. 39 is a diagram showing a example of the organization of a disinfecting apparatus for sewer stormwater overflow relating to one embodiment of the present invention.

FIG. 40 is a diagram for explaining one embodiment of the present invention which performs the treatment of adding a reducing agent to sewer stormwater overflow added with a disinfectant.

FIG. 41 is a diagram showing a sewer network for collecting drainage to be disinfected by a disinfecting apparatus and a region to be treated.

FIG. 42 is a diagram showing a sewer network for collecting drainage be disinfected by a disinfecting apparatus and a region to be treated and the adjacent regions to be treated.

FIG. 43 is a diagram showing an example of the organization of a control unit of a disinfecting apparatus relating to the present invention.

FIG. 44 is a schematic diagram of a mapping processing used in the method of controlling the disinfecting apparatus relating to the present invention, and FIG. 44(a) is a schematic diagram after mapping processing of rainfall information determined at each of region to be treated A, B, C, D, E and X and FIG. 44(b) is a schematic diagram after time t of FIG. 44(a).

FIG. 45 is a diagram showing another example of the organization of a control unit of a disinfecting apparatus relating to the present invention.

FIG. 46 is a diagram showing another example of the form of a control unit of a disinfecting device relating to the present invention.

FIG. 47 is a flow sheet showing the state of disinfection executed by one embodiment of a drainage disinfecting apparatus having an abnormality detection mechanism relating to the present invention.

FIG. 48 is a diagram showing the procedure of processing of detecting excess or insufficient amount of addition of an agent added.

FIG. 49 is a diagram showing the procedure of processing of detecting excess or insufficient amount of addition of an agent added.

FIG. 50 is a diagram showing the procedure of processing of detecting excess amount of addition of an agent added.

FIG. 51 shows the concept of a control unit for detecting abnormal supply of a solid disinfectant to stop the supply.

FIG. 52 is a diagram explaining one embodiment of a method of operating an apparatus for disinfecting sewer stormwater overflow with a solid bromine-based disinfectant according to the present invention.

FIG. 53 is a concept diagram showing one example of the control system for a disinfecting system for sewer stormwater overflow relating to the present invention.

FIG. 54 is a diagram showing the organization of a disinfectant apparatus for sewer storm overflow used in Example 4.

FIG. 55 is a graph showing the results of Example 5.

### DETAILED DESCRIPTION OF THE INVENTION

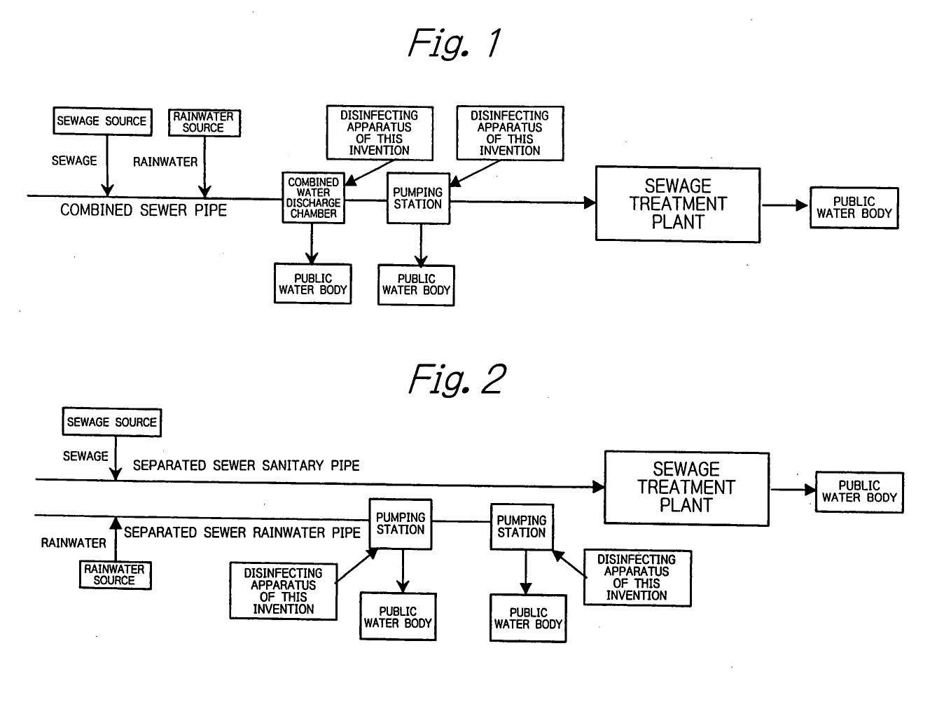

“A combined sewer” is a system for collecting household waste water, industrial drainage and rainwater into the same pipe and sending to a sewage treatment plant where the treatments such as removal of suspended solids by a primary basin, biological treatment by an aeration tank, removal of sludge by a final sedimentation tank and disinfection with a chlorine-based disinfectant are carried out. A typical example of the organization of a combined sewer system is shown in FIG. 1. The sewage discharged from a sewage discharge source such as an ordinary family and a plant is collected into a sewer pipe. Rainwater is also collected into the same sewer pipe via a rainwater channel or the like. The sewage and rainwater thus collected in the sewer pipe are sent to a sewage treatment plant and discharged via each of the treatments such as sedimentation treatment, aeration (biological reaction), final sedimentation tank treatment to public water body as advanced wastewater treatment effluent. Public water body includes, for example, rivers, lakes, ports and coastal areas. However, when there is a big rainfall, rainwater-incorporated sewage may flow into the sewage treatment plant in an amount exceeding the treatment capacity of the sewage treatment plant. For this account, stormwater drainage facilities such as a storm overflow chamber (storm outfall) and a pumping station (a stormwater pumping station) are provided in the course of the sewer pipe. In the storm overflow chamber, if necessary, a filtering screen or the like is installed to remove foreign elements, and then the overflow is discharged. Further, in the pumping station, ordinarily a sand basin is installed, and the foreign element-removed rainwater is treated by the sand basin alone and then discharged. Thus, this discharged water of the rainwater-incorporated sewage in wet weather is generally called as combined sewer overflow (CSO).

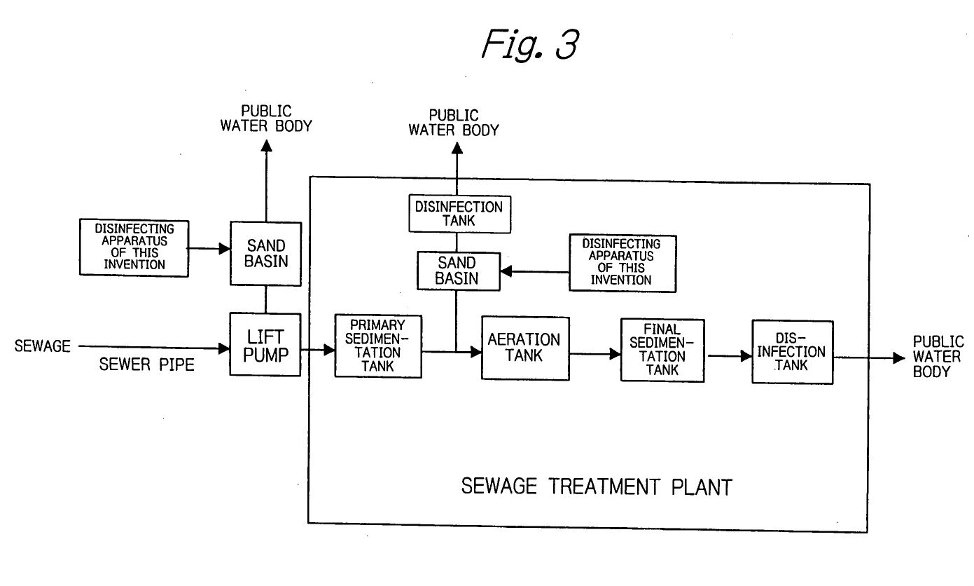

On the other hand, “separated sewer” is a system for collecting both of household waste and industrial drainage, and rainwater into different pipes and sending the household waste and industrial drainage to a sewage treatment plant while discharging the rainwater to public water body. A typical example of the organization of the separated sewer system is shown in FIG. 3. The sewage discharged from a sewage source such as an ordinary family and a plant is collected into a sewer pipe of a separated sewer, sent to the sewage treatment plant, subjected to predetermined treatments, and then discharged to public water body. On the other hand, the rainwater is collected into a rainwater pipe of a separated sewer via a rainwater channel or the like and discharged to public water body from pumping stations (stormwater pumping stations) provided at a plurality of places in the rainwater pipe. In such a separated sewer, the rainwater overflow of the separated sewer discharged from the pumping stations in the rainwater pipe should essentially comprise rainwater alone. Actually, however, when there is a big rainfall, a large amount of rainwater flows in the sewer and on this occasion, pollutants present on ground surfaces such as roads and sludge accumulated in the sewer are allowed to flow. Thus, the rainwater overflow of the separated sewer also contains E. coli ascribed to the pollutants present on ground surfaces and the sludge.

In each of the above described combine sewer overflow and the rainwater overflow in the separated sewer, the coliform organism count in the overflow may exceed the discharge control value (3,000 CFU/mL or less) and in this case, disinfection is desired. “CFU” herein used means colony forming unit.

A typical example of the organization of a sewage treatment plant is shown in FIG. 3. The sewage sent from a sewer pipe is guided into the sewage treatment plant by a lift pump, treated in a primary sedimentation tank to be removed of foreign elements and suspended solids by sedimentation. Then, the sewage is subjected to biological treatment in an aeration tank and then sedimentation in a final sedimentation tank basin to be separated from sludge, and thereafter the treated water is disinfected in a disinfecting tank (chlorine admixing tank). The water via the series of treatments is discharged as treated water to public water body. However in the combined system, rainwater and sewage flow together in a sewer pipe, and accordingly when there is a big rainfall, rainwater-incorporated sewage may flow into the sewage treatment plant in an amount exceeding the treatment capacity of the sewage treatment plant. In this case, part of the sewage may be removed in liftpumping stations and the remaining sewage is subjected to simple treatment in the sand basin, and then discharged to public water body. The treatment capacity of the primary sedimentation tank and that of the aeration tank are ordinarily different from each other and the latter is smaller. Thus, when sewage is introduced into the sewage treatment plant in an amount of less than the treatment capacity of the primary sedimentation tank but more than the treatment capacity of the aeration tank, part of the sewage may be removed before being introduced into the aeration tank and the remaining sewage is subjected to simple treatment in the sand basin and the disinfecting tank (chlorine admixing tank) and discharged to public water body. Further, some sewage treatment plant have no space for installing a disinfecting tank for disinfecting this water to be discharged. In such a case, the sewage is discharged to public water body after the treatment by the primary sedimentation tank alone. This type of the rainwater-incorporated sewage to be discharged in the sewage treatment plant is also called as “combined sewer overflow” (CSO) and its disinfection is an important problem.

Further, sewage alone should essentially flow in the separated sewer pipe of a separated sewer system and the amount of the sewage flowing in the sewer pipe does not increase even during or after a big rainfall. Actually, however, a considerable amount of miscellaneous water enters into the sewer pipe of a separated sewer, and some water overflows from the sewer pipe and is discharged to public water body. This type of water is called as sanitary sewer overflow (SSO) of a separated sewer and its disinfection is an important problem.

One embodiment of the present invention provides a sewer system having a means (disinfecting apparatus shown in FIG. 1 to FIG. 3 according to the present invention) to quickly disinfect these combined sewer overflow, separated sewer stormwater overflow and separated sanitary sewer overflow.

That is, according to the present invention there is provided a sewer system wherein when sewage flows into a sewage treatment plant in an amount of not more than the treatment capacity of the sewage treatment plant in fine weather or wet weather with a scanty rainfall, the sewage is subjected to predetermined treatments by a primary sedimentation tank, an aeration tank, a final sedimentation tank and the like in the sewage treatment plant, and then disinfection with a chlorine-based disinfectant, and thereafter discharged to public water body, and when sewage containing rainwater in an amount more than the treatment capacity of the sewage treatment plant flows or may flow into the sewage treatment plant due to heavy rains, the amount of the rainwater-incorporated sewage of more than the treatment capacity of the sewage treatment plant is branched in sewer stormwater overflow removing facilities of a sewer, for example, a storm overflow chamber, a pumping station (a stormwater pumping station), or a lift pumping station of the sewage treatment plant, then disinfected with a bromine-based disinfectant, and thereafter discharged to public water body while the sewage in an amount within the treatment capacity of the sewage treatment plant is subjected to predetermined treatments by a primary sedimentation tank, an aeration tank, a final sedimentation tank and the like in the sewage treatment plant, then disinfected with a chlorine-based disinfectant, and thereafter discharged to public water body.

According to another embodiment of the present invention, there is provided a sewer system of a separated sewer system wherein sewage flowing in a sanitary sewer pipe of a sewer is subjected to predetermined treatments by a primary sedimentation tank, an aeration tank, a final sedimentation tank and the like in a sewage treatment plant, then disinfected with a chlorine-based disinfectant, and thereafter discharged to public water body while rainwater flowing in a rainwater pipe is discharged from rainwater removing facilities, for example, a pumping station (a drainage machine station) to public water body, and when disinfection is needed immediately after a rainfall of so-called first flush or after a big rainfall, rainwater flowing in a rainwater pipe is disinfected with a bromine-based disinfectant in the rainwater removing facilities, and then discharged to public water body.

According to still another embodiment of the present invention, there is provided a sewer system wherein when sewage in an amount of not more than the treatment capacity of an aeration tank in a sewage treatment plant flows into the sewage treatment plant in fine weather or in wet weather with a scanty rainfall, the sewage is subjected to the treatments by a primary sedimentation tank, the aeration tank and a final sedimentation tank in the sewage treatment plant, then disinfected with a chlorine-based disinfectant, and then discharged to public water body, and when rainwater-incorporated sewage containing rainwater in an amount of not more than the treating capacity of the primary sedimentation tank but more than the treatment capacity of the aeration tank flows or may flow into the sewage treatment plant by a big rainfall, the amount of the sewage of more than the treatment capacity of the aeration tank is branched after the treatment by the primary sedimentation tank in the sewage treatment plant, then disinfected with a bromine-based disinfectant, and thereafter discharged to public water body, and the amount of the rainwater-incorporated sewage within the treatment capacity of the aeration tank is subjected to the treatments by the aeration tank and the final sedimentation tank after the treatment by the primary sedimentation tank, successively disinfected with a chlorine-based disinfectant, and thereafter discharged to public water body.

According to a further embodiment, there is provided a disinfecting apparatus for combined sewer overflow, separated sewer rainwater overflow or separated sanitary sewer overflow. Such an apparatus in one embodiment has a storing/feeding device for a solid bromine-based disinfectant and a disinfectant adding/mixing device for adding and mixing the solid bromine-based disinfectant supplied from the disinfectant adding/mixing device for the solid bromine-based disinfectant to combined sewer overflow, separated sewer storm overflow or separated sanitary sewer overflow.

As explained above, the target water to be treated by the present invention includes, for example, sewage incorporated with rainwater in a combined sewer which is discharged to public water body without undergoing appropriated treatments in a sewage treatment plant by a big rainfall, that is, combined sewer overflow (CSO), pollutant-incorporated rainwater which is discharged to public water body from a sewer pipe in a separated sewer in wet weather, that is, separated sewer rainwater overflow, and sewage containing unanimous water which is discharged from a sewer pipe in a separated sewer to public water body, that is, separated sanitary sewer overflow (SSO). In the following explanation, these combined sewer overflow, separated sewer rainwater overflow or separated sanitary sewer overflow are called generically as sewer stormwater overflow.

Sewage such as sanitary sewage and drainage is ordinarily disinfected with a chlorine-based disinfectant such as sodium hypochlorite. Chlorine based disinfectant have may advantages such that the equipment used is simple and their applicability to any state of dirt is high compared to ultraviolet irradiation and ozone sterilization.

However, when the techniques applied to ordinary sewage treated are diverted to disinfection of sewer stormwater overflow, the following problems arises. First, in sewer stormwater overflow, ammonia or an amine is coexistent, and thus, a chemical reaction typified by the equation (1):
NH₄⁺+HClO→NH₂Cl+H₂O+H⁺ (1)
takes places and as result, active chlorine is converted to chloramine to decrease the antibacterial effect to one-tenth or lower. Thus, in the presence of ammonia or an amine, the amount of the chlorine-based disinfectant used needs to be increased, even if the pathogen count remains unchanged.

The disinfectant time for the use of the chlorine-based disinfectant is required to be 15 minutes or more (see “Sewer Facilities-Plan & Description”). There is need for a mixing tank in which sewer stormwater overflow and the chlorine-based disinfectant are mixed and allowed to dwell for 15 minutes or more. However, sewer stormwater overflow removal facilities have no ample space where such a mixing tank can be installed.

Thus, a disinfectant taking a short disinfection time and a method of mixing them is required of the disinfection of sewer stormwater overflow.

One characteristic feature of the present invention is to use a solid bromine-based disinfectant in the disinfection of sewer stormwater overflow. The solid bromine-based disinfectants which can be used in the present invention includes, for example, 1-bromo-3-chloro-5,5-dimethylhydantoin (BCDMH) and 1,3-dibromo-5,5-dimethylhydantoin (DBDMH).

In one aspect of the present invention, there is provided an apparatus for disinfecting sewer stormwater overflow comprising a solid fluorine-based disinfectant storing device, a disinfecting water preparation device and a disinfectant adding device for adding the disinfectant to sewer stormwater overflow containing ammonia or an amine to disinfect it.

In the present invention, the total organic carbon in the above described sewer stormwater overflow is preferably 5 mg/L or more. The ammonium ion concentration in the above described sewer stormwater overflow is preferably 1 mg/L or more.

The concentration of the disinfectant in the above described disinfecting water is 100 mg/L as Cl to 10 g/L as Cl calculated as an active chlorine concentration.

The concentration of the disinfectant added in the above described sewer stormwater overflow is 0.5 mg/L as Cl to 25 mg/L as Cl calculated as an active chlorine concentration.

The above described disinfectant adding step preferably comprises a step of introducing the disinfecting water below the water surface of the sewer stormwater overflow. Also it preferably comprises a step of discharging the disinfected sewer stormwater overflow to public water body.

According to another aspect of the present invention, there is provided an apparatus for disinfecting sewer stormwater overflow comprising a device for preparing disinfecting water from a disinfectant and part of the sewer stormwater overflow, a sand basin for removing sand from the sewer stormwater overflow and a first channel for introducing the disinfecting water to the sand basin, wherein sewer stormwater overflow is disinfected while the sewer stormwater overflow is dwelling in the sand basin.

In the present invention, the disinfecting water preparation device preferably has a disinfectant storing device, a device for adding the disinfectant to the sewer stormwater overflow and a device for mixing the disinfectant and sewer stormwater overflow. Preferably the sand basin has two or more sand settling portions, and the first channel has a distribution tank for introducing the disinfecting water to each of the sand settling portions.

The first channel is preferably connected to an adding device for introducing the disinfecting water below the water surface of the sewer stormwater overflow.

It is preferred that a reservoir for storage or a discharge waterway be further included so that the disinfected sewer stormwater overflow can be discharged to public water body.

The reservoir or the discharge waterway is preferably provided with a measuring instrument for inspecting the water quality of the disinfected sewer stormwater overflow.

It is preferred that a second channel for introducing part of the sewer stormwater overflow in the sand basin to the device for preparing disinfecting water be further included.

In the present invention, sewer stormwater overflow containing organic substances and ammonia or ammonium ions is disinfected.

For example, in the combined sewer, sewer such as sewage and drainage are mixed with rainwater and flows in the sewer pipe. And, such combined sewage, particularly, sewer stormwater overflow which is discharged without undergoing the treatments at a sewage treatment plant is disinfected by the present invention.

The separated sewer is a system in which a sewer for raw sewage (sewer pipe) and a sewer for rainwater (rainwater pipe) are separated, and the sewer stormwater overflow which flows in the rainwater pipe and is discharged to public water body is disinfected by the present invention.

As the content of organic substances in sewer stormwater overflow, for example, this sewer stormwater overflow may contains a total organic carbon content of 5 mg/L or more, 10 mg/L or more or 30 mg/L or more or 50 mg/L or more. The content of the total organic carbon either in the combined sewer or separated sewer is generally 5 mg/L or more.

The ammonium ion concentration in the target sewer stormwater overflow to be treated may be 1 mg/L or more or 10 mg/L or more. When the sewer stormwater overflow contains an ammonium ion, the active bromine changes to NH₂Br, NHBr₂ or the like. But since the bromoamine (NH₂Br) maintains the same disinfection effect as hypobromous acid, effective disinfection is possible. Further, the overflow of so-called first flush immediately after a rainfall in separated sewer often has an ammonium ion concentration of 1 mg/L or more.

In one aspect of the present invention, the main target is the sewer diluted with rainwater but rainwater by separated sewer may be a target. Furthermore, water containing ammonia or an amine such as sewer, human waste, industrial drainage and their treated water may be treated by the method of the present invention.

According to one aspect of the present invention, the water to be treated contains E. coli, because disinfection is highly necessary for such water. The combined sewer sewage generally contains E. coli, and the separated sewer rainwater often contains E. coil.

The present invention uses a solid bromine-based disinfectant. The solid bromine-based disinfectant characteristically has a short disinfection time compared to the chlorine-based disinfectant. The bromine-based disinfectant can disinfect in a few tens of seconds to a few minutes. Further, the hypobromous acid (HOBr) easily decomposes in a natural environment, and thus there is no need to provide equipment for decomposing the hypobromous acid remaining in drainage. Contrast to this, the active chlorine of the chlorine-based disinfectant reacts with ammonia in the sewer to form chloramines which reduces disinfection power and as a result, it is very difficult to disinfect sewer stormwater overflow within the dwelling time in the sewer stormwater overflow removal facilities. Due to high residual properties of chloramine, it is necessary to provide a device for decomposition treatment.

The solid bromine-based disinfectant which can be suitably used in the present invention include, for example, 1-bromo-3-chloro-5,5-dimethylhydantoin (BCDMH) and 1,3-dibromo-5,5-dimethylhydantoin (DBDMH).

According to one aspect of the present invention, a step of mixing a predetermined disinfectant with water is included. In the present invention, the disinfectant may be added to sewer stormwater overflow at the sewer stormwater overflow removal facilities. Such sewer stormwater overflow removal facilities include, for example, a storm overflow chamber and a pumping station (stormwater pumping station) as for the combined sewer, and a pumping station (stormwater pumping station) as for the separated sewer, a lift pumping station in a sewage treatment plant, and facilities for discharging sewer stormwater overflow to public water body from a channel branched from a channel between a primary sedimentation tank and an aeration tank in the sewage treatment plant. The disinfectant of the present invention may be added in the sewer pipe entering these sewer stormwater overflow removal facilities or in the rainwater removal pump well or the rainwater removal pump inflow pipe. Further, these sewer stormwater overflow removal facilities are often provided with a sand basin, and in this case the disinfectant may be added in the sand basin or the inflow portion of the sand basin. The disinfectant can be added at the above described one site or several sites.

Alternatively, the sewer stormwater overflow removal facilities may be provided with a main channel for the flow of sewer stormwater overflow and a bypass channel branched from the main channel, and in this bypass channel, a disinfection tank may be installed. In this disinfection tank, the disinfectant may be added to sewer stormwater overflow and dissolved therein.

The place of addition of the disinfectant is preferably on the entry side of the rainwater removal pump because an agitation force in the pump sufficiently mixes the disinfectant and the sewer stormwater overflow. Also, the addition of the disinfectant at the inflow portion of the sand basin is preferred because the dwell time in the sand can be utilized for the reaction time.

Since the disinfectant which can be used in the present invention is a solid at room temperature, the disinfectant can be dissolved in water to form disinfecting water which is then added to sewer stormwater overflow. The method of dissolving is not particularly restricted, and may be any of water jet agitation by an ejector, channel agitation and a dissolving tank equipped with a mixing device.

For example, there may be used disinfecting water having the disinfectant dissolved in an amount of 1% by weight or more, preferably 10% or more, more preferably 20% or more, based on the saturated solubility of the disinfectant. Needless to say, not all of the disinfectant needs to be dissolved in water and instead, the solid-form disinfectant may remain in the disinfecting water.

The concentration of the disinfecting water is preferably 100 mg/L as Cl to 10 g/L as Cl, more preferably 200 mg/L to 2 g/L calculated as an active chlorine concentration. With concentrations of the disinfecting water of less than 100 mg/L, the amount of addition only increases and sometimes the diluted water consumes the disinfectant, and thus disinfection may become insufficient. On the other hand, with concentrations of the disinfecting water of more than 10 g/L, mixing of the disinfectant with the sewer stormwater overflow is insufficient to reduce the disinfecting effect.

The amount of the disinfecting water added depends on the disinfectant concentration in the disinfecting water, the amount of rainfall, the water quality of the sewer stormwater overflow and the like, and generally increases in accordance with the increase in the amount of rainfall, that is, the amount of inflow sewer stormwater overflow and the deterioration in the water quality. However, according to one embodiment of the present invention, as rainwater increases, the degree of pollution of inflow water quality decreases. Thus, even if rainwater increases and the amount of inflow water triples, there is no need to make the amount of addition of the disinfecting water or the disinfectant three-fold. Thus, it is rational to find the optimum amount of addition for the water quality of inflow water by a beaker test or the like and multiply this value by the amount of inflow water to determine the amount of the disinfecting water or the disinfectant added.

To know the quality of inflow water, by measuring its turbidity or electrical conductivity the state of incorporation of rainwater can be grasped. This indicator makes on-time detection possible. Other indicators usable are the rainfall pattern, the properties of particles in sewer stormwater overflow, the SS content, the chemical oxygen demand (COD), the biological oxygen demand (BOD) and the like, and these indicators can be arbitrarily be combined. Further, for the amount of inflow water, various flow meters may be used but this amount may be determined by the number of the rainwater removal pumps in operation and the sate of load on these pumps.

Then, the above described disinfecting water is added to predetermined sewer stormwater overflow to disinfect it. For example, the disinfecting water in a disinfecting water tank is introduced into the main channel via the bypass channel.

When the sewer stormwater overflow is rainwater-incorporated sewer, human waste, industrial drainage or the like, the concentration of the disinfectant added in the sewer stormwater overflow is preferably 0.5 to 25 mg/L as Cl, more preferably 1 to 15 mg/L as Cl, calculated as an active chlorine concentration. The concentration of the disinfectant added can be calculated from the concentration and amount of the disinfectant in the disinfecting water and the amount of the sewer stormwater overflow. The concentration of the disinfectant added is the value before the disinfectant is consumed in the sewer stormwater overflow.

When the water to be treated is rainwater-incorporated sewage, human waste, industrial drainage or the like, this water to be treated generally contains coliform organisms in the range of 10⁴ to 10⁷ CFU/mL. However, the above described amount of the disinfectant results in the sterilization of the water to be treated securely and rapidly in about one minute.

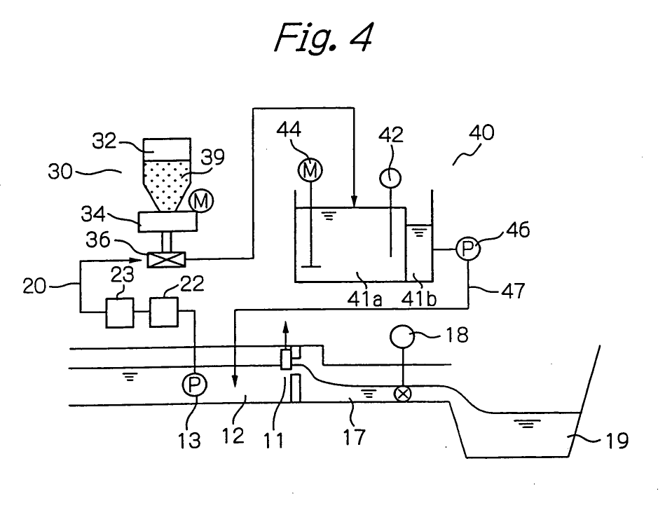

FIG. 4 is a schematic explanatory diagram for explaining one embodiment of the present invention.

Sewer stormwater overflow flows from the main sewer into a discharge channel 12. The sewer stormwater overflow in the channel 12 moves over a discharge gate 11 to a discharge waterway 17 and is discharged to public water body 19. The sewer stormwater overflow in the discharge waterway is measured by a metering instrument 18 such as a residual halogen detector, a turbidimeter and an electrical conductivity meter. The residual halogen detector determines the residual active halogen concentration such as hypobromous acid. Thus, the residual halogen detector is preferably installed behind the discharge gate and forward of a discharge port.

When the active halogen concentration detected by the residual halogen detector is not less than a LC₅₀ value [in the case of DCDMH, for example, 0.4 mg/L as active chlorine (Cl₂)], the amount of the disinfectant or the disinfecting water supplied is decreased or the supply of the disinfectant is temporarily cut off, so that the active halogen concentration will be not more than the LC₅₀, preferably not more than a half of the LC₅₀ value. By this measure, adverse effect on aquatic organisms in area can be reduced.

After the measured values and the coliform organism count of the disinfected sewer stormwater overflow have been confirmed to fulfill the predetermined discharge standards, the disinfected sewer stormwater overflow is discharged to public water body 19.

Public water body includes rivers, lakes, ports, coastal water areas, public aqueducts, irrigation waterways and other water areas or waterways for public use.

According to the embodiment of FIG. 4, a bypass channel 20 is connected to the channel 12. Part of the sewer stormwater overflow which has flowed into the channel 12 is introduced into the bypass channel 20. And, to this sewer stormwater overflow, the bromine-based disinfectant is added to convert it to disinfecting water, which is returned to the channel 12.

In the channel 12, a bucket pump 13 is arranged. Part of the sewer stormwater overflow is lifted to the bypass channel 20 by the bucket pump 13.

In the bypass channel 20, an automatic screen 22, a flow meter 23, a disinfectant adding device 30, a dissolving device 40 and a pump 46 are installed in the order named.

The disinfectant adding device 30 has a hopper 32 for storing a solid bromine-based disinfectant 39, a feeder 34 for feeding the solid bromine-based disinfectant 39 and an ejector 36 for discharging the disinfectant to the bypass channel.

The sewer storm overflow having the disinfectant added thereto within the bypass channel 20 is guided to the dissolving device 40. The dissolving device 40 dissolves the solid bromine-based disinfectant into the sewer stormwater overflow. When the disinfectant is liquid, the device 40 mixes the disinfectant with the sewer stormwater overflow. The device 40 has a dissolving tank which is divided into an agitation tank 41a and a storage tank 41b, although the tank need not be divided into two tanks.

The agitation tank 41a has a water level gauge 42 and an agitator 44 for agitating the drainage. The sewer stormwater overflow in the agitation tank 41a is agitated with the agitator 44, so that the solid disinfectant can be dissolved in the sewer stormwater overflow to form disinfecting water. The disinfecting water which has overflowed from the agitation tank 41a is transferred to the storage tank 41b.

When the solubility of the solid disinfectant is small, it is preferred to provide the dissolving device 40. On the other hand, when the solubility of the solid disinfectant is large, the dissolving device 40 is not absolutely necessary because the disinfectant rapidly dissolves in the channel.

The disinfecting water obtained in the device 40 is guided to the channel 12 for sewer stormwater overflow via a channel 47, preferably by means of a pump 46.

The channel 12 of the sewer stormwater overflow or the discharge waterway 17 may be provided with water holding portions or an agitating apparatus or baffle plates, to thereby accelerate mixing of the disinfecting water with the sewer stormwater overflow.

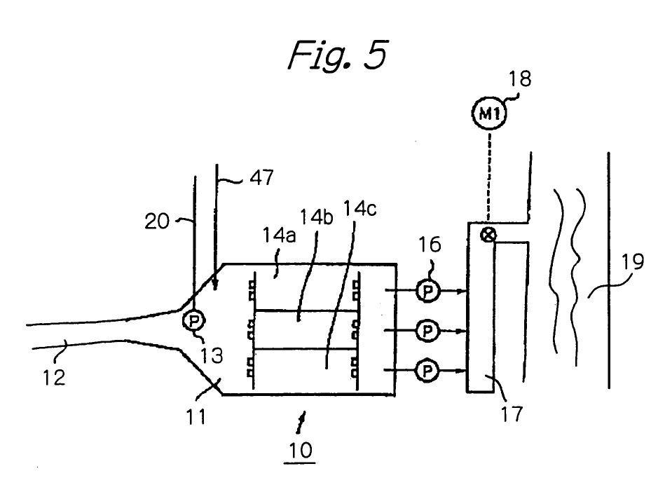

Further, when a sand basin is installed in the sewer storm overflow removing facilities, disinfecting water may be introduced into the inflow portion of the sand basin or the sand settling portions of the sand basin. A typical constitution of the sand basin is shown in FIG. 5. The sand basin 10 is divided into sand settling portions 14a, 14b, 14c.

In the inflow portion 11 of the sand basin 10, a bucket pump 13 is installed. Part of the sewer stormwater overflow introduced into the inflow portion 11 of the sand basin from the channel 20 for sewer stormwater overflow is lifted to the bypass channel 20 by the bucket pump 13. On the other hand, the other portion of the sewer stormwater overflow in the inflow portion 11 flows into the sand settling portions 14a, 14b, 14c.

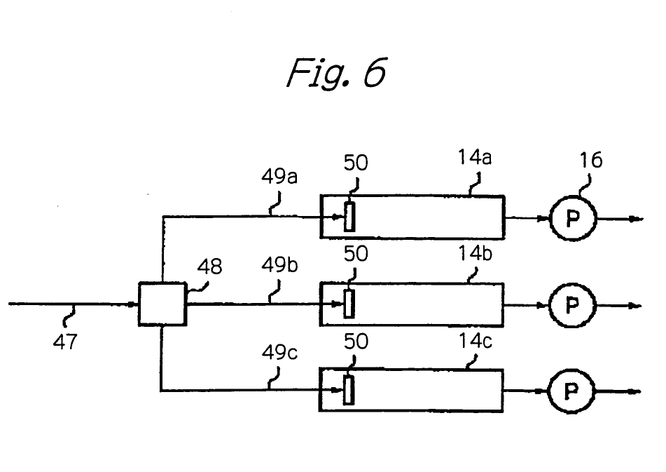

In part of the sewer stormwater overflow introduced in the bypass 20, a disinfectant is dissolved by the disinfectant feeding device and the dissolving device as shown in FIG. 4 to form disinfecting water, and this disinfecting water is guided to the sand basin 10 via a channel 47. The disinfecting water may be directly guided to the sand basin 10 or may be guided to the sand basin via the distribution tank 48 as shown in FIG. 6.

Namely, in FIG. 6, the distribution tank 48 is provided in the channel 47. In FIG. 6, the sand settling portions 14a, 14b, 14c of the sand basin 10 are illustrated and the inflow portion 11 is omitted for convenience of explanation.

The disinfecting water may be guided to the inflow portion 11 of the sand basin 10 or may be introduced upstream of each of the sand settling portions 14a, 14b, 14c of the sand basin 10 as shown in FIG. 6.

As shown in FIG. 6, when the disinfecting water is introduced upstream of each of the sand settling portions 14a, 14b, 14c of the sand basin 10, the disinfecting water to be guided to each of the sand settling portions 14a, 14b, 14c is preferably distributed at the distribution tank 48 beforehand.

In the sand settling portions 14a, 14b, 14c, sand included in sewer stormwater overflow is sedimented and removed. Simultaneously, the sewer stormwater overflow and the disinfecting water mix to disinfect the sewer stormwater overflow. Disinfected sewer stormwater overflow is guided to the discharge waterway 17 by pump 16, and discharged to public water body 19. In the sand settling portions 14a, 14b, 14c, the sewer stormwater overflow and the disinfecting water dwell preferably for one second to 30 minutes, more preferably for one second to 15 minutes, and most preferably for one second to 10 minutes.

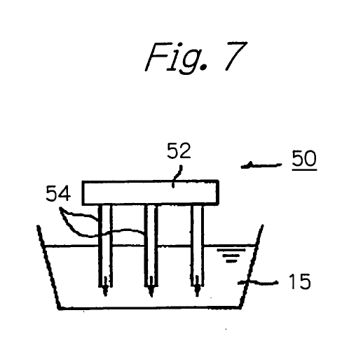

FIG. 7 shows an embodiment of an adding device for adding the disinfecting water to sewer stormwater overflow. An adding device 50 has a pipe 52 extending in the horizontal direction and an introducing portion communicating with this pipe 52 for introducing the disinfecting water into sewer stormwater overflow. The pipe 52 is connected to a disinfecting water feeding channel and supported by a support member (not shown). One embodiment of the introduction portion is, for example, a plurality of hoses 54 suspending from the pipe 52. An open end 56 of the hose is preferably located below the water surface of sewer stormwater overflow. The disinfecting water distributed from the distribution tank 48 flows in the disinfecting water feeding channel, the pipe 52 and the hose 54 in this order, and added to sewer stormwater overflow 15.

When the open end 56 of the hose 54 is located above the water surface of the sewer stormwater overflow 15, splashes of the disinfecting water may form a mist with wind or the like, corroding neighboring instruments, particularly electrical instruments. Thus, the open end 56 of the hose is preferably located below the water surface of sewer stormwater overflow 15.

The pipe 52 is preferably made of a material which is not corroded with the disinfecting water. For example, metallic materials such as inconel and plastic materials such as polytetrafluoroethylene and polyvinyl chloride can be used. The pipe 52 preferably has sufficient strength to support the hoses. Preferably it is rigid but may be flexible.

From each pipe 52, for example, 2 to 20 hoses, preferably 2 to 10 hoses, more preferably 2 to 6 hoses may be suspended. The distance between the two adjacent hoses is preferably constant because the disinfecting water can be efficiently mixed with the drainage. However, the distance between the two adjacent hoses may be different. The hose 54 is preferably flexible but may be rigid.

Further, in the above, an example of using part of branched sewer stormwater overflow as water for dissolving the disinfectant is shown but tap water, miscellaneous water or the like can be used as the water for dissolving the disinfectant.

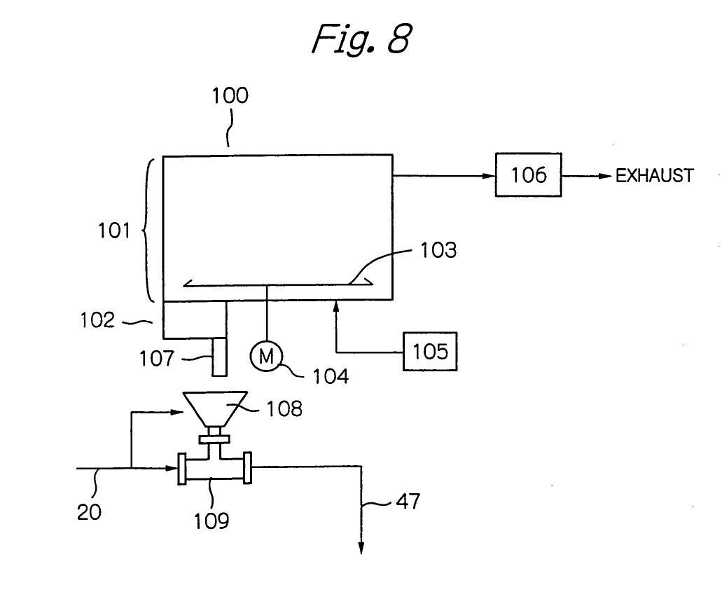

Another embodiment of the disinfectant/feeding device which can be employed in the present invention is shown in FIG. 8. A solid bromine-based disinfectant storing/feeding tank 100 is divided into a barrel-shaped, for example, cylindrical storing section 101 and a feeding section 102. At the bottom of the storing section 101, an agitating device such as an agitating blade for agitating the solid disinfectant in the tank is rotatably connected to a motor 104. Further, air is supplied to the storing section 101 from air source equipment 105. A predetermined amount of the solid disinfectant is discharged from the feeding section 102, passes through a guide pipe 107 and falls into an agent dissolving cone 108 of the agent dissolving section 109.

According to the disinfectant storing device as shown in FIG. 8, the shape of the storing section is made barrel-like, for example, cylindrical, and powder compaction and bridge formation of a powder are inhibited by mechanical agitation with an agitating blade and air agitation. When the storing section is an inverted cone as the conventional hopper, a bridge of a solid disinfectant is formed to easily cause failure of feeding. Particularly, the present invention has an object to disinfect a large amount of sewer stormwater overflow during heavy rains, and a solid bromine-based disinfectant is rapidly added to a large amount of sewer stormwater overflow to execute disinfection during heavy rains ten-odd times to several tens of times a year. Further, such a disinfectant adding device is installed, for example, in a storm overflow chamber or a pumping station in sewer and driven in an unmanned manner by remote control, and accordingly the disinfectant has to be stored and fed without compaction or bridge formation for a long term. Furthermore, the solid bromine-based disinfectant has properties to easily cause compaction and bridge formation compared to other solid powders, and prevention of consolidation and bridge formation is essential for smoothly feeding the solid bromine-based disinfectant. In the disinfectant storing device 100 as shown in FIG. 8, a solid disinfectant is mechanically agitated by an agitating blade 103 and, simultaneously, agitated by injecting air from an air source 105 via air holes provided at a plurality of sites at the bottom of the tank 100. It is preferred that on an air introducing line from the air source 105, a dehumidifier is provided to supply dry air into the storing section 101. The humidity of the agitating air is preferably, for example, below the dew point of 5° C. at a pressure of 0.5 MPa. Dehumidification with the agitating air can inhibit the deterioration of the solid bromine-based disinfectant by hydrolysis. The agitating air can be intermittently supplied. The amount of the agitating air supplied is preferably about 80 NL/min per m³ of the storing section. As the air source 105, equipment which can always secure a pressure of at least 0.5 MPa can be preferably used. Further, by continuously supplying dry air into the storing section 101 to form a pressurized state in the inside, the solid disinfectant can be smoothly discharged from the feeding section 102 without clogging. The air inside the storing section 101 is discharged via a dust collector 106.

As the dust collector 106, a bag filter, a water washing column, a cyclone or the like can be used.

The shape of the solid disinfectant storing section 101 is preferably cylindrical but may be conical or rectangular if the storing section 101 has a powder fluidizing mechanism by an agitator or air-purging. As a solid disinfectant agitating means in the storing section, a technique of vibrating the container as such can be employed in addition to the above described mechanical agitation and agitation by air blowing.

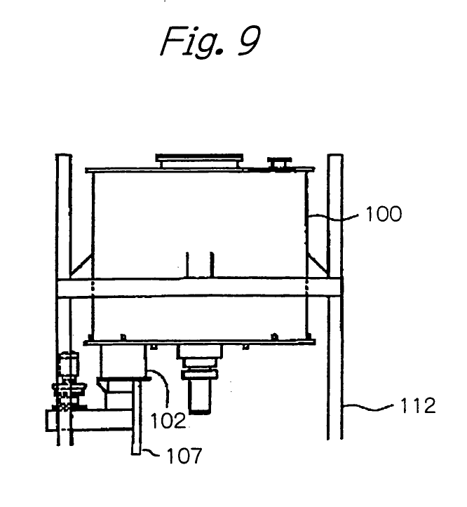

A specific constituting example of the solid disinfectant storing section 101 will be explained by referring to FIG. 9.

As will be explained by referring to FIG. 9, the solid disinfectant storing section has a solid disinfectant storage tank 100 and a metering feeder 102 for metering a predetermined amount of a powder in the tank 100 to discharge the metered powder to a place to be supplied. The tank 100 is fixed to a support frame 112, and the metering feeder 102 is fixed to the undersurface of the storage tank 100.

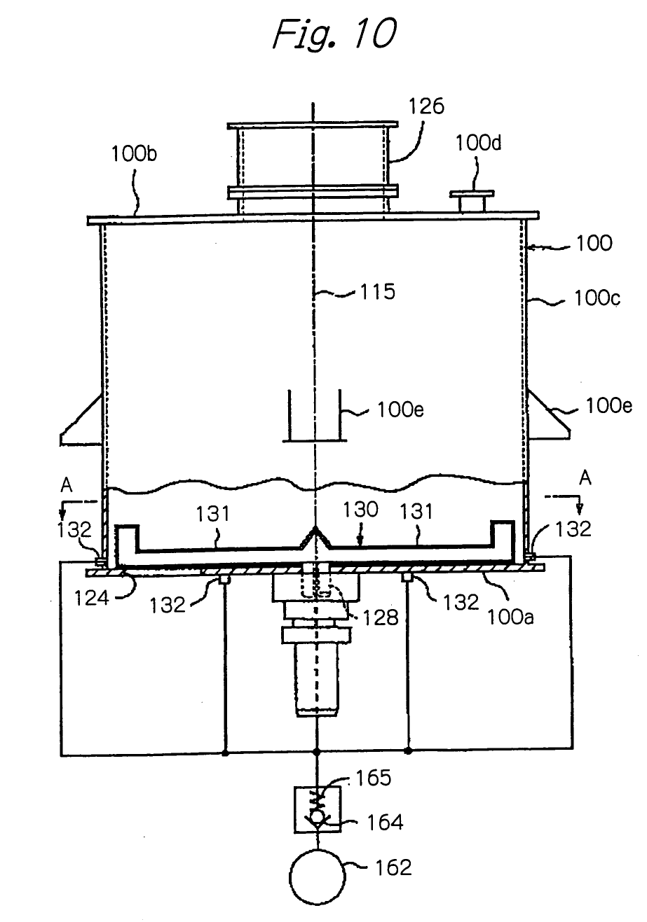

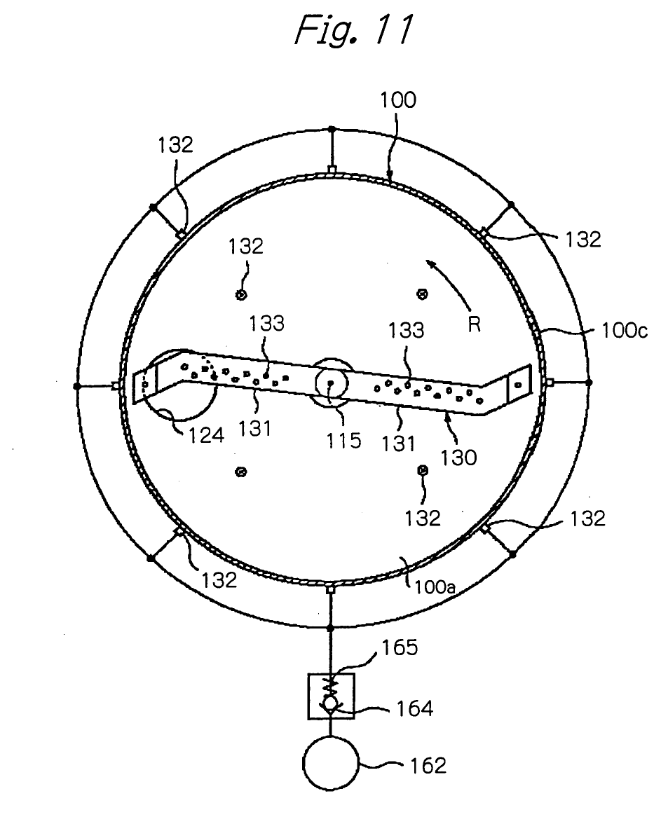

The storage tank 100 will be explained by referring to FIG. 10 to FIG. 11. The storage tank 100 is formed into a cylindrical container, and a bottom plate 100a having a discharge port 124, a ceiling plate 100b having a solid disinfectant inlet 126, and a cylindrical container body 100. The solid disinfectant is introduced into the container from the inlet 126. The bottom plate 100a has an agitating blade 130 of a powder agitating means having a driving shaft penetrating the bottom plate 100a which rotates in a predetermined direction R centering an axis 115 extending in a vertical direction.

The container body 100c has eight injection nozzles of compressed air injecting openings near agitating blade 130 which are provided at circumferentially equally spaced intervals at the periphery.

The bottom plate 100a has four injection nozzles 132 which are provided around the axis 115 at equally spaced intervals and opened toward the agitating blade 130. Dry compressed air from a compressed air source 162 is supplied via a check valve 164 into each of the injection nozzles 132. The compressed air is supplied by freely controlling its amount injected, the intervals of injection and the like.

The check valve 164 may be the well-known one and, for example, a poppet valve whose valve body moves perpendicularly with respect to the valve seat, a swing catch valve whose valve plate is oscillatorily openable centering a hinge with respect to the valve seat and the like can be used. And, in order to securely stop the backward flow of the powder in the direction of the compressed air source, it is preferred to press the valve body or the valve plate with a spring 165 of a well-known means to open the valve only when compressed air is allowed to flow.

To the inlet 126 for introducing a solid disinfectant, a cover material to close its opening or a freely openable butterfly valve is fixed. The ceiling plate 100b has a dust collecting opening 100d which communicates with dust collection equipment. The peripheral portion of the container body 100c has four blankets 100e which place the storage tank 100 on the support frame 112 (FIG. 9).

The agitating blade 130 has a pair of radial blades 131, 131 radially extending in the opposite directions up to the inner peripheral part of the container body 100c centering the axis 115. Each of the radial blades 131 has a communicating upwardly protruded hollow triangular cross-section and its radially directed end portion is bent to the side of the rotary direction R in an upwardly protruded manner. To the radial blades 131, pressurized air is supplied to their hollow portions from the compressed air source 162 through the inside of the driving shaft 128 via the above described check valve, and a plurality of injection holes 133 are formed on the ridgeline of the upper end of the triangular cross-section and on the side of the rotary direction R.

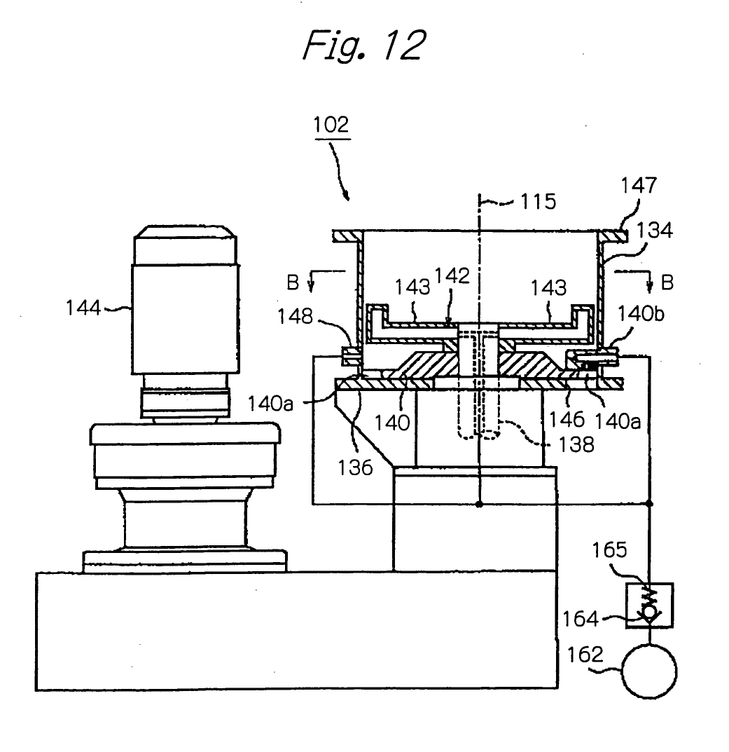

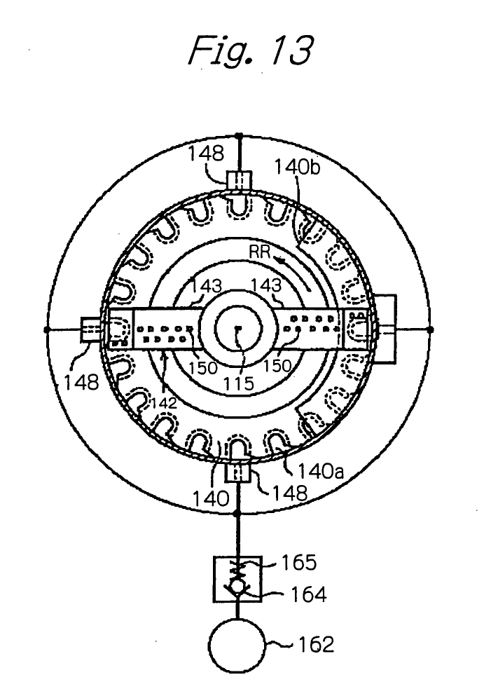

A metering feeder 102 will be explained by reference to FIG. 12 and FIG. 13. The metering feeder 102 is arranged on a bottom plate 136 of a container body 134 and has a cylindrical container 134, a rotary table 140a which is placed on the bottom plate 136 of the container 134, and has a driving shaft 138 penetrating the bottom plate 136 and rotates in a specified rotary direction RR centering an axis 115 extending in the vertical direction and an agitating blade 142 of an agitating means which is integrally fixed on to the rotary table 140. The metering feeder 102 has a driving source 144 which rotates and actuates the driving shaft 138.

The container body 134 is of a cylinder having substantially the same size of the inner diameter as a discharge port 124 of the storage tank 100 and has a supply port 146 in the bottom plate 136 and a mounting flange 147 at the upper end of the cylinder which is opened, and is fixed to the discharge port 124 of the bottom plate 100a of the storage tank 100.

The rotary table 140 has a plurality of metering chambers 140a as metering means which are opened vertically and radially outside in the circumferential direction of the periphery. The outer and lower openings of the metering chambers 140a are substantially closed by the circumferential wall of the container body 134 and the bottom plate 136. By rotating the rotary table 140 in a predetermined direction RR, the powder inside the container body 134 is successively introduced into the metering chambers 140a from their upper openings and these upper openings are closed at the center of a scraping plate 140 while the lower openings are opened to release the powder in the metering chambers 140a. Thus, by regulating the volume of the metering chambers 140a and the number of revolution of the rotary table 140, a predetermined amount of the powder is metered and discharged to a supply port 146.

The cylindrical container body 134 has three injection nozzles 148 of injection holes for compressed air at the periphery which are opened downwardly of the neighborhood of the agitating blade 142. Dry compressed air from the compressed air source 162 is supplied to these nozzles 148 in a controlled amount of injection at controlled intervals of injection.

The agitating blade 142 has a pair of radial blades 143, 143 extending to the inner periphery of the container body 134 centering the axis 115 radially in the opposite directions. Each of the radial blades 143 has a communicating upwardly protruded hollow triangular cross-section and the end portion of the radial direction protrudes upward. Pressurized air from the compressed air source 162 is supplied to the radial blades 143 in the hollow portions through the driving shaft 138 via the above described check valve 164, and a plurality of injection holes 150 are formed on the ridgeline of the upper end of the triangular cross-section of the radial blades 143 and on the side of the rotary direction RR.

The supply port 146 of the metering feeder 102 is connected to a tubular member 107. The solid disinfectant supplied from the metering feeder 102 falls into a dissolving cone 108 of a dissolving means to dissolve the discharged powder which is arranged below the tubular member 107. The disinfectant-dissolved water from the dissolving cone 108 is allowed to flow into an ejector 109 of a channel 20 to which a stream of water is pumped, and is aspirated by the suction of the ejector 109 and sent to an objective place by a transport channel 47.

In the dissolving cone 108, water is discharged from a plurality of nozzles provided at the periphery of the upper end of the upwardly broadening funnel-shaped body, and the discharged water flows in whirls downward along the inner surface of the funnel-shaped body. And, into this stream, the powder is introduced from the tubular member 107 and is dissolved.

The solid disinfectant storing/mixing apparatus as explained above is constituted by providing a dissolving cone between an agent feeding section and an agent dissolving section and scraping the agent in the feeding section to fall into the dissolving cone. According to this constitution, the agent dissolving section can be separated from the feeding section, and the backward flow of disinfecting water to the solid agent storing section can be inhibited.

As the agent feeding section, a feeding device of a screw feeder system or a rotary valve system can be employed in addition to the above described feeding device of a table feeder system. Further, as the agent feeder section, a circular or square sliding water system, a system of combining a simple tank with an agitator, a line mixer or the like can be employed in addition to the above described system of combining the whirlpool type dissolving cone with an ejector.

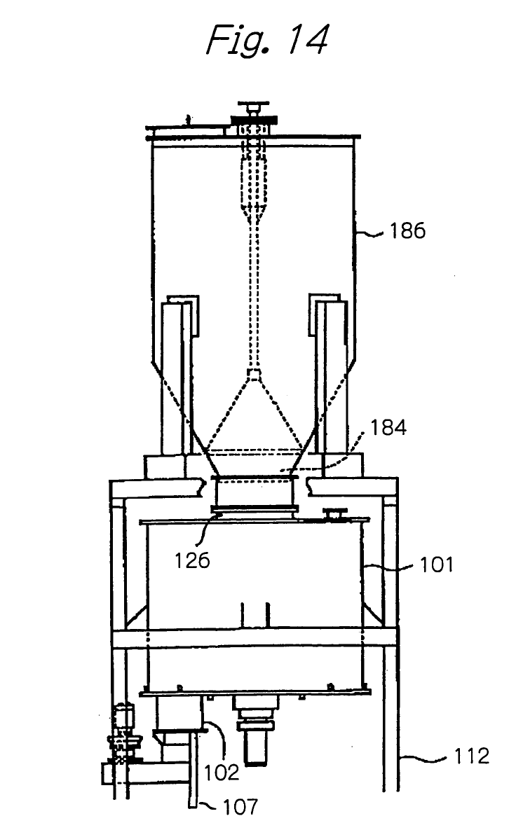

Further, the form of connecting a solid disinfectant container to a disinfectant inlet 126 of a storage section 101 is possible. According to FIG. 14, a storage tank 101 for a solid disinfectant is connected to a container 186 (one container being shown in the Figure) of a plurality of containers, each having a freely openable discharge port 184 and holding the solid disinfectant, at a disinfectant inlet 126 through a discharge port 184 (this state shown in FIG. 14).

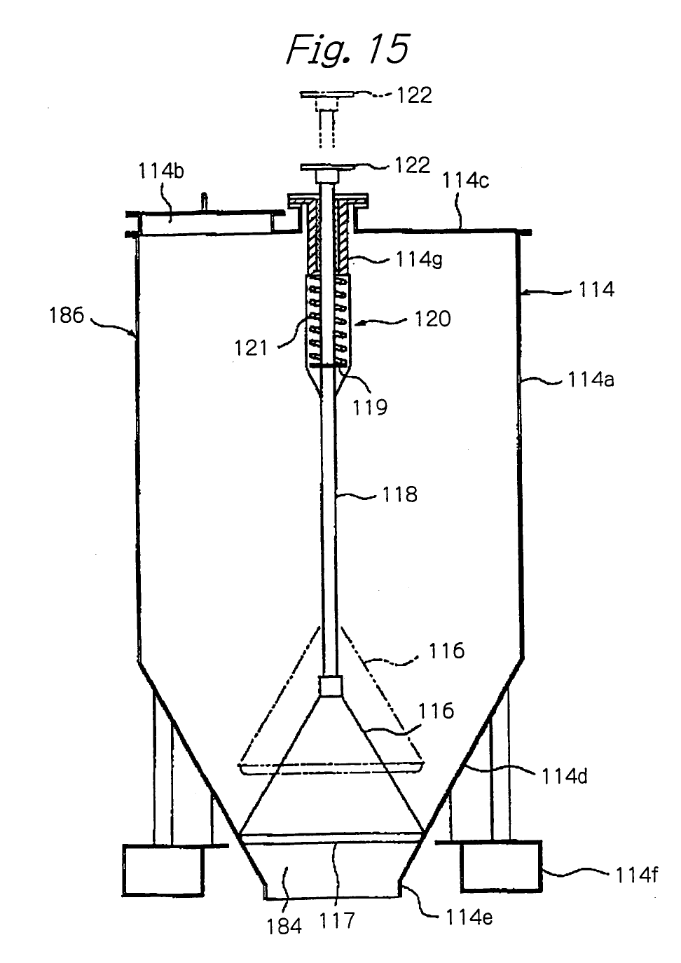

Referring to FIG. 15, a container 186 will be explained. The container has a container body 114 having a discharge port 184 formed at its lower end, a cone 116 of a valve body ordinarily closing the discharge port 184 and a cone rod 118 of a shaft member whose one end is connected to the cone 116 and upwardly extends in the container body 114 and other end outwardly protrudes. The discharge port 184 is openable by holding the protruding end of the cone rod 118 to operate the cone 116. The cone rod 118 is energized by as energizing means 120 having a spring provided in the container body 114 which energizes the cone 116 in the direction of closing the discharge port 184.

The container 114 has a cylindrical vertical body 114a, an upper cover 114c having an inlet 114b for a powder, a funnel-shaped bottom 114d which the cone 114 contacts to form the discharge port 184 and a cylindrical guide 114e freely insertably connected to a storage tank 101 formed at the end of the bottom 114d. At the lower periphery of the body 114a, a frame 114f for storage, moving, placement on the storage tank 101 and the like is provided.

The cone 116 is hollow and conical and the outer periphery of the bottom is fixed to a cone seal 117 of a sealing member which contacts the discharge port 184 and its top is connected to the cone rod 118.

The cone rod 118 is slidably vertically guided by a shaft guide 114g. The energizing means 120 has a compressed spring 121 between the shaft guide 114g and a pin 119 of the coin rod 118. The cone rod 118 is allowed to pass through the compressed spring 121. The protruding upper end of the cone rod 118 has a disk flange 122 which can be freely held by a valve opening and closing means (valve opening and closing means being explained later).

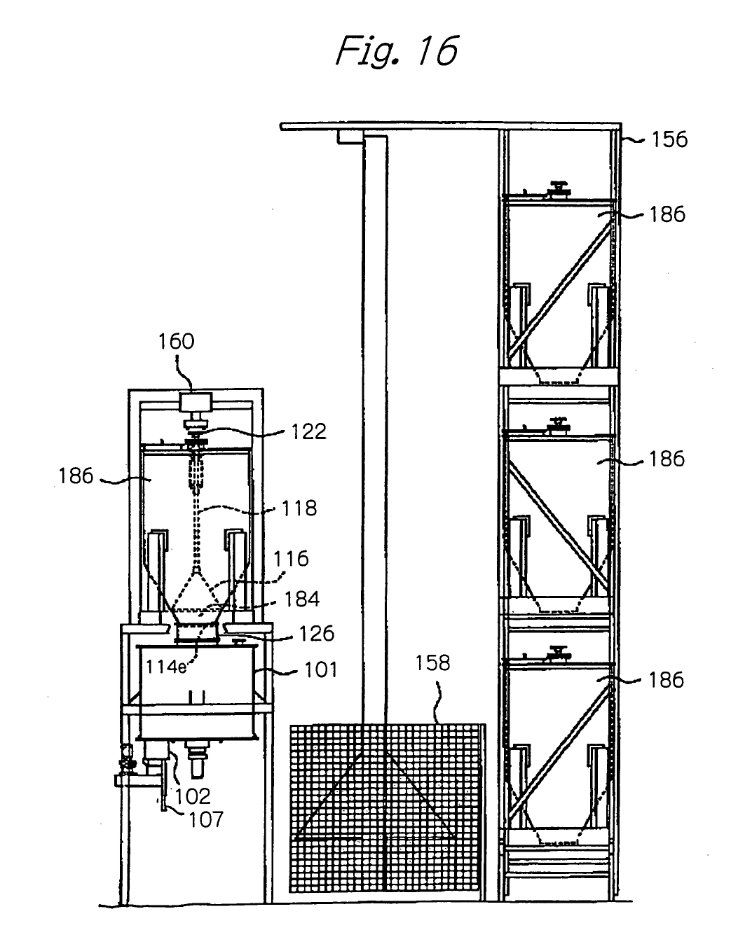

Referring to FIG. 16, one example of the form of placement of solid disinfectant supply equipment as described above will be explained. By and apart from a solid disinfectant storage tank 101 and a metering feeder 102, a plurality of containers 186 holding a solid disinfectant which are housed in a three-tier shelf 156 with a plurality of rows in a direction perpendicular to the face of paper of FIG. 15. Between the storage tank 101, the metering feeder 102 and the shelf 156, a stacker crane 156 is provided and the containers 186 in the shelf 156 can be suitably taken out, if necessary, and the container 186 taken out is placed on the storage tank 101 so as to insert the guide 114e of the discharge port 184 into an inlet 126 of the storage tank.

The upper part of the placed container 186 has a valve opening and closing means 160. This valve opening and closing means 160 is opened and closed in the horizontal direction by an air cylinder to freely hold the flange 122 of the cone rod 118 of the container 186 and simultaneously, has an air cylinder which vertically move the cone rod 118 to open or close the cone 116 of a vale body of the container 186.

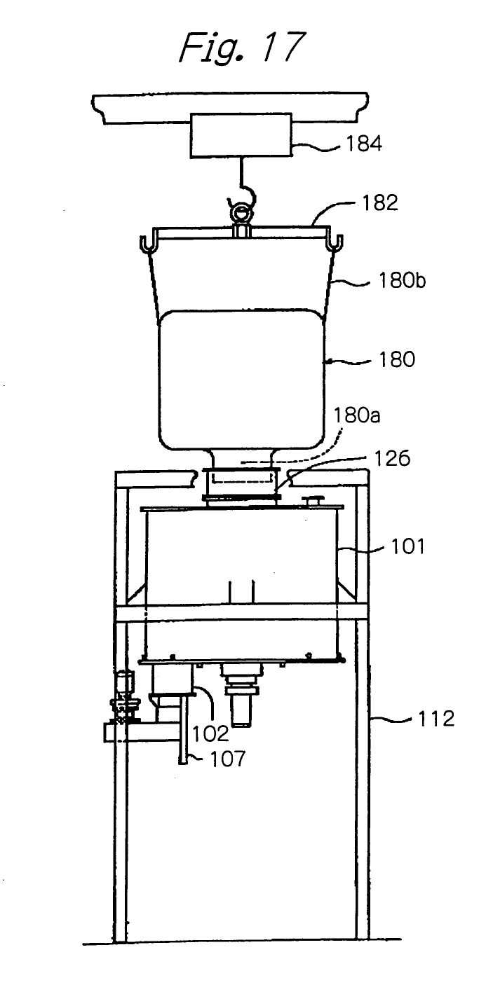

Referring to FIG. 17, a working embodiment using a flecon bag 180 which is anther form of the container holding a solid disinfectant will be explained. It is well known that the flecon bag 180 is formed of a flexible bag and is used for holding a powder or the like. The lower part of the flecon bag 180 has a discharge port 180a which is freely openably tied up with a tape, a rope or the like, and the upper part has a rope 180b for hanging. The flecon bag holding a powder is hung by hanging fitment 182 with the use of an electrically driven chain block 184 in the housing place and is moved to position on the storage tank 101 so as to insert the discharge port 180a into the solid disinfectant inlet 126. And, the discharge port 180a is untied and opened to fill the solid disinfectant into the storage tank 101.

The actions of the solid disinfectant supply equipment as described above will be explained.

(1) Necessary amount of solid disinfectant can be supplied when necessary:

The solid disinfectant is dividedly held in the container 186 or the flecon bag 180 of a plurality of containers, and the container or the flecon bag is successively connected to the storage tank 101 in accordance with the necessary amount for the recipient to fill the solid disinfectant in the storage tank 101, and a predetermined amount of the filled powder is metered by a metering feeder 102 and supplied to the recipient, and accordingly the amount of the powder to be held in the container and the storage tank can be reduced to inhibit solidification of the powder due to compaction. Further, the storage tank 101 has the agitating means 130 and the metering feeder 102 has the agitating means 142, and compressed air is regularly injected into the storage tank 101 and/or the metering feeder 102 from the surrounding wall, the agitating means and the like, and accordingly solidification of the powder can be inhibited. Thus, when necessary, a necessary amount of the powder can be supplied.

(2) Operator or the like does not contact powder:

Since the discharge port of the container 186 or the flecon bag 180 of a container holding the solid disinfectant is connected to the storage tank 101 through the inlet 126 to place the container on the storage tank 101 and the solid disinfectant is filled into the storage tank, it is unnecessary to open the bag of the powder enclosed to fill the powder into the storage tank 101, and thus it is inhibited that the operator or the like contacts the powder.

(3) Check valve:

Since compressed air is injected into the storage tank 101 and the metering feeder 102 through a check valve 164, the insides of the storage tank 101 and the metering feeder 102 can be maintained in a pressurized state, the powder can be smoothly discharged from the supply port 146.

(4) Flexible tubular member connected to metering feeder:

By forming the tubular member 107 connected to the powder supply port 146 of the metering feeder 102 of a synthetic vinyl chloride resin, when the metering chamber 140a of the rotary table 140 in the pressurized metering feeder 102 is intermittently connected to the solid disinfectant supply port 146 by the rotation of the rotary table 140, the solid disinfectant is intermittently discharged to the tubular member 107 and by this action, the tubular member 107 stretches and vibrates. Thus, clogging of the solid disinfectant in the tubular member 107 is inhibited. Striking of the tubular member to inhibit clogging of the solid disinfectant in the tubular member 107, which is performed in the case of using a steel pipe as the tubular member 107, also becomes unnecessary. A transparent tubular member 107 advantageously enables confirmation of the powder state therein.

(5) Dissolving means:

Furthermore, when the solid disinfectant metered and discharged by the metering feeder 103 is rendered dissolved water through the dissolving cone 108 of a dissolving means and transported, efficient and effective transportation is possible compared to mere addition of the powder into a transportation pipe to which a stream of water is pumped and sent to the recipient.

Further, in the apparatus as explained above, various changes and modifications within the scope of the present invention can be made as will be explained below.

(1) Installation Position of Metering Feeder

In the present working embodiment, the metering feeder 102 is installed outside of the storage tank 101 but it may be arranged in the storage tank 101, for example, so as to be driven on the same axis 115 of the agitating means 130.

(2) Installation Position of Check Valve

In the present working embodiment, the compressed air from the compressed air source is supplied to a plurality of nozzles, 132, 148, injection holes 133, 150 and the like of the storage tank 101 and the metering feeder 102 through the common check valve 164 but in accordance with the size and the shape of the storage tank 101, the metering feeder 102 and the like and the type of the solid disinfectant used, supply intervals of compressed air and the like, a check valve may be provided at the section of the injection nozzles and/or injection holes, respectively.

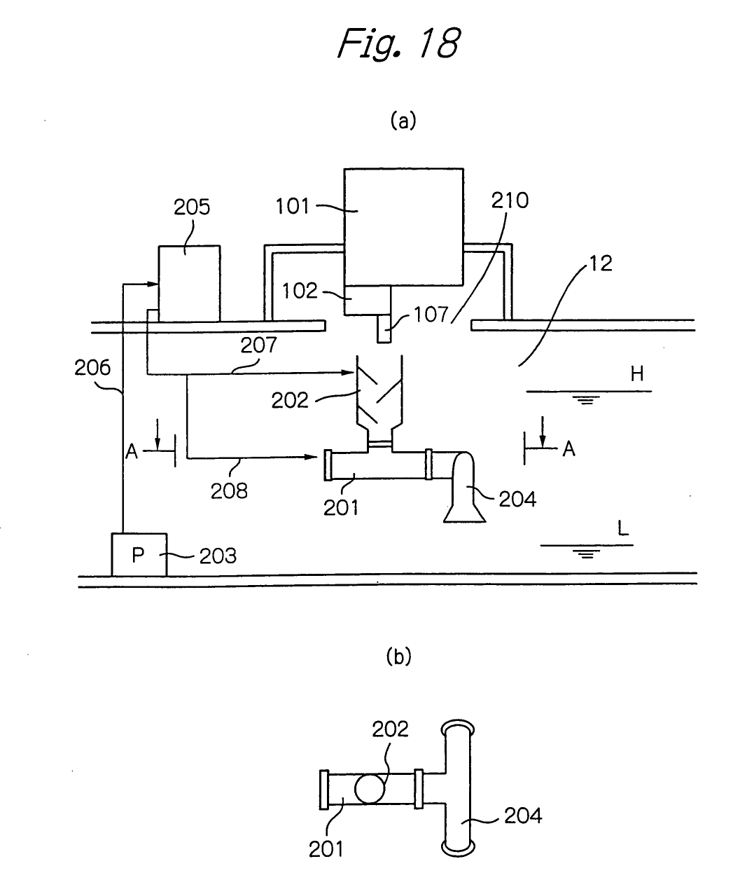

Another constitution example of the dissolving section which dissolves a solid disinfectant in water to form disinfecting water is shown in FIG. 18. The storage tank 101 for the solid disinfectant as explained in FIG. 8 and the like is arranged above a pit 210 provided in a channel 12 for sewer stormwater overflow. A disinfectant guiding tube 107 connected to a metering feeder 102 is arranged toward the pit 210. In the channel 12, an underwater ejector 201 equipped with an underwater mixer 202 is installed. Part of the sewer stormwater overflow is pumped up by a pump 203 and foreign elements are removed by a strainer 205, and the sewer stormwater overflow thus treated is supplied to the underwater mixer 202 and the underwater ejector 201 via piping 207, 208. The solid disinfectant falling from the disinfectant guiding tube 107 is added to the underwater mixer 202 to form disinfecting water, and then this disinfecting water is discharged from a discharge port 204 to water to be treated, that is, sewer stormwater overflow. Further, FIG. 18(b) is a view taken from above along the line A-A of FIG. 18(a), and in this manner the discharge outlet 204 may be arranged branchlike.

This constitution lowers the height of the apparatus. In the conventional solid disinfectant storing/feeding device, the mixer is arranged below the feeding device, and accordingly, the height of the device has to be increased. The above constitution arranges the mixer in the sewer channel, and thus lowers its height. Actually, the conventional solid disinfectant storing/feeding device has a height of about 5.5 m but the constitution as shown in FIG. 18 can reduce the height of the device to 2 to 3 m. The restrictions for installing the device are freed by lowering the height of the device. Since the installation height of the solid disinfectant storage tank can be lowered, power can be reduced in supplying the disinfectant to the storage tank in the line or the like. Further, the water pumping distance to the mixer can be shortened to reduce the power for water supply. Furthermore, according the conventional solid disinfectant storing/feeding device, the disinfectant mixer and the disinfecting water introducing device are arranged on the ground above the sewer stormwater overflow channel, and when disinfecting water overflows the mixer, the disinfecting water is dispersed in the neighborhood but according to the constitution as shown FIG. 18, even if the disinfecting water overflows from the mixer due to clogging of the disinfecting water discharge pipe, the disinfecting water merely flows into the target sewer stormwater overflow to be treated, and no pollution of the neighborhood is caused.

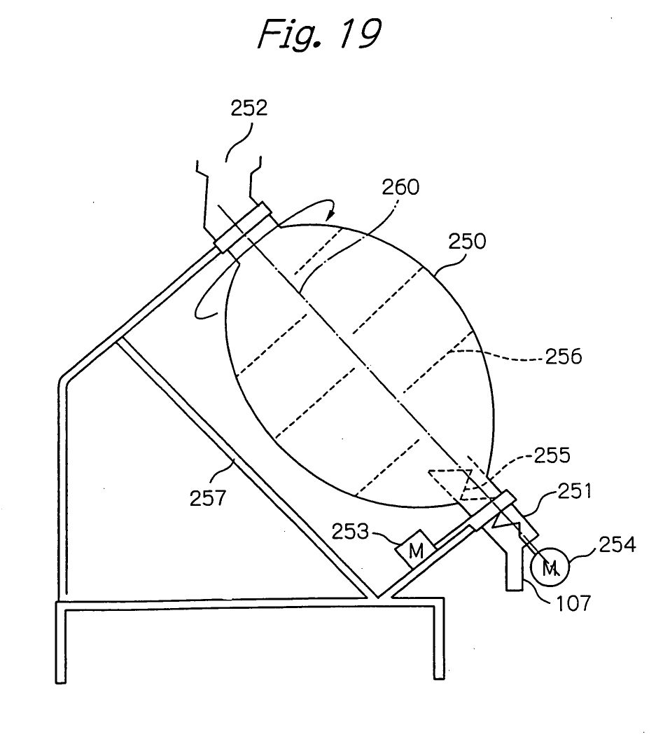

Another embodiment of the solid bromine-based disinfectant storing/feeding device which can be used in the present invention is shown in FIG. 19. The solid disinfectant storing/feeding device as shown in FIG. 19 is constituted by a storage tank 250 having a solid bromine-based disinfectant introducing port 252 at its upper part and a solid bromine-based disinfectant metering device 251 fixed to an opening (solid bromine-based disinfectant discharge port) at the lower part of the storage tank 250. The storage tank 250 is, for example, of a barrel shape whose central section is broadened and is installed by a frame 257 so as to incline the central axis 260 and is rotated by a motor 253 centering the axis 260. It is preferred that a plurality of baffle plates 256 for agitation are arranged on the inner wall of the storage tank 250. To the opening (solid bromine-based disinfectant discharge port) at the lower part of the storage tank 250, a screw feeder 255 is fixed, and the solid bromine-based disinfectant held in the storage tank 250 is supplied in a predetermined amount through a guiding tube 107 by rotating the feeder 255 by a motor 254. Below the guiding tube, a solid disinfectant dissolving device such as the underwater mixer 202 as shown in FIG. 18 can be arranged. According to the storage tank of this system, by rotating the storage tank to mix a powder such as the solid bromine-based disinfectant which easily causes compaction, its bridge formation can be inhibited. Further, the machine height of the storage tank can be lowered and air for agitating the solid disinfectant advantageously becomes unnecessary.

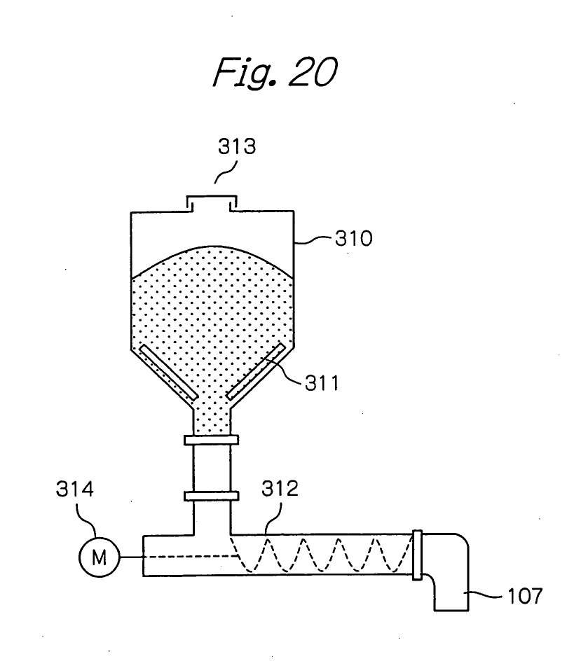

FIG. 20 is a diagram showing another example of the solid bromine-based disinfectant storing/feeding device which can be employed in the present invention. In FIG. 20, a fluid/powder transfer single screw pump 312 is connected to a discharge port of the bottom of a solid bromine-based storing/feeding device 310. By rotating the screw by a motor 313, the solid bromine-based disinfectant can be forcibly sucked and transferred in the horizontal direction. To the end portion of the single screw pump 312, a guiding tube 107 for the solid bromine-based disinfectant is connected. Below the guiding tube, a solid disinfectant dissolving device such as a dissolving cone 108 as shown in FIG. 8 and an underwater mixer 202 as shown in FIG. 18 is arranged. According to this method, it is unnecessary to install a dissolving device for the solid bromine-based disinfectant just under a chemical storage tank, and thus the height of the facilities can be render lower. Since it is unnecessary to arrange/guide a large amount of dissolving water for dissolving the solid bromine-based disinfectant around chemical feeding equipment, construction costs as the whole plant can be reduced and installing conditions can be eased. As the fluid/powder transfer single screw pump which can be used for this purpose, a mono-pump of Mono Pump Ltd., England can be used. Further, such a feeding device can be used as a transfer means to supplement the solid bromine-based disinfectant to the solid bromine-based disinfectant storage tank used as the solid bromine-based disinfectant storing/feeding device. The solid bromine-based disinfectant storage tank 310 as shown in FIG. 20 is of a so-called hopper type and has a compaction/bridge formation inhibiting mechanism 311 such as a mechanical agitator and an air-purging means, and by this mechanism bridge formation is inhibited. Naturally, for example, storage tanks as show in FIG. 8, FIG. 10, FIG. 19 and the like can be used.

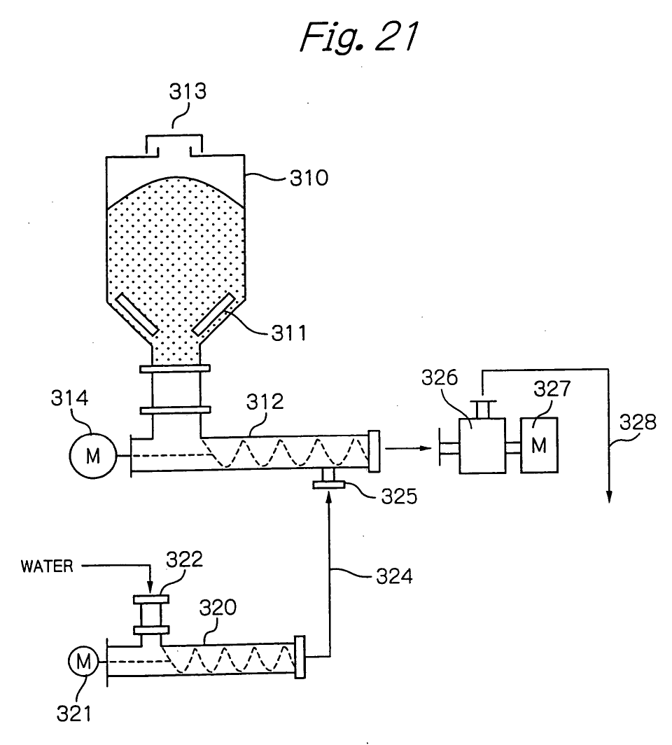

FIG. 21 shows another example of the solid bromine-based disinfectant storing/feeding device using a single screw pump for fluid/powder transfer. The constitutions of a solid bromine-based disinfectant storage tank 310 and a single screw pump are the same as shown in FIG. 20. In the system as shown in FIG. 21, another single screw pump 320 is further installed to introduce dissolving water for dissolving the solid bromine-based disinfectant into its introducing port 322. The dissolving water is transferred by rotating the screw portion of the single screw pump 320 by motor 321 and introduced via piping 324 into the single screw pump 312 from its introducing port 325, in which the solid bromine-based disinfectant is transferred. Preferably, the dissolving water and the solid bromine-based disinfectant which are mixed in the single screw pump 312 are successively introduced into an emulsifier 326 and form a slurry of the solid bromine-based disinfectant by actuating the emulsifier 326 by a motor 327, and this slurry is transferred via a guiding pipe 328. The slurry of the solid bromine-based disinfectant as such can be introduced in the target sewer stormwater overflow to be treated. As the emulsifier 326, for example, an emulsifying pump having a grinder-like shape and the like can be used. Thus, by dispersing the solid bromine-based disinfectant into water to form a slurry and introducing the slurry into the target sewer stormwater overflow to be treated, it is possible that the solid bromine-based disinfectant hardly soluble in water is transferred in the form of an aqueous slurry having some concentration of the disinfectant to the point of introduction, quickly dispersed and dissolved in the target sewer stormwater overflow to be treated.

Thus, by combining two single screw pumps, for example, it is possible that the capacity of the single screw pump 312 for transferring the solid bromine-based disinfectant is made greater than that of the single screw pump 320 for supplying water to forcibly suck the chemical in the storage tank 310 into the single screw pump 312. Accordingly, the amount of the agent supplied can be finely controlled by adjusting the capacities of the single screw pump for transferring the solid bromine-based disinfectant and that for supplying water.

The apparatus for disinfecting sewer stormwater overflow as explained above first mixes and dissolve the solid bromine-based disinfectant in water, for example, the water partially collected from the target sewer stormwater overflow to be treated to form disinfecting water, and introduces this disinfecting water to the sewer stormwater overflow to disinfect it. However, in another embodiment of the present invention, it is possible to disinfect the target sewer stormwater to be treated by introducing and dissolving the solid bromine-based disinfectant as such thereinto.

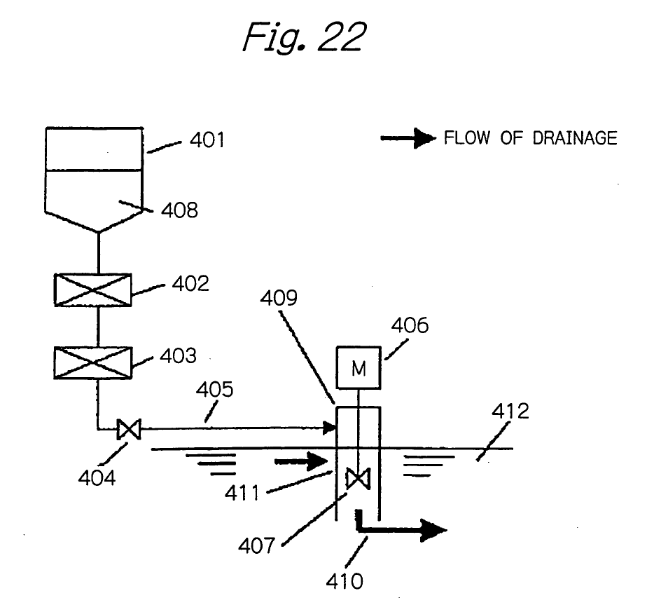

FIG. 22 shows one specific example of the disinfecting device relating to one embodiment of the present invention which introduces and dissolves the solid bromine-based disinfectant as such into the target sewer stormwater overflow to be treated. A powdered or granular solid bromine-based disinfectant 408 is held in a disinfectant storage tank 401. By opening a valve 404, the disinfectant 408 is sent to disinfectant transfer piping 405 via a disinfectant discharging device 402 and a measuring instrument 403. The end portion of the disinfectant transfer piping 405 is connected to a disinfectant introducing device 409, and here the disinfectant 408 is added to the target sewer stormwater overflow 412 to be treated. In the disinfecting device as shown in FIG. 22, an agitating blade 407 connected to a motor 406 is fixed to the disinfectant introducing device 409, and by the action of this agitating blade 407, the powdered or granular solid bromine-based disinfectant is dissolved in the target water to be treated.

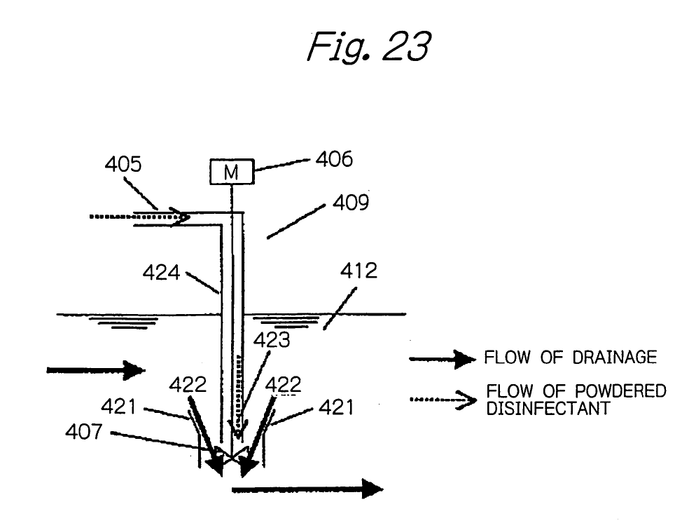

The disinfectant introducing device 409 preferably has a mean to cause a jet stream of the target water to be treated and is constituted by rendering the inside of the disinfectant introducing device in a reduced pressure state by the action of the jet stream caused and transferring the powdered or granular solid bromine-based disinfectant by the suction generated by this reduced pressure. Several specific examples having such a structure are shown in FIG. 23 to FIG. 25.

The disinfectant introducing device 409 as shown in FIG. 23 is constituted of a fine pipe 424 surrounding a shaft which connects a motor 406 to an agitating blade 407 and a cover 421 surrounding the neighborhood of the end portion of the fine pipe 424, and disinfectant transfer piping 405 is connected to the upper part of the fine pipe 424. The end portion of the fine pipe 424 is placed in the water to be treated 412, and disinfectant transferring pipe 405 is connected to the upper portion of the fine pipe. By rotating the agitating blade 407 by a motor 406, a stream of water is caused within the cover to generate a jet stream 422 in the neighborhood of the end portion of the fine pipe, and by this jet stream, the inside of the fine pipe 424 becomes in a reduced pressure state and by the suction generated by this reduced pressure state, the powdered or granular solid bromine-based disinfectant 423 is air-transferred toward the end portion of the fine pipe 424. The transferred disinfectant 423 is added to a stream of water 422 and mixed with the target sewer stormwater overflow to be disinfected by an agitating blade 407.

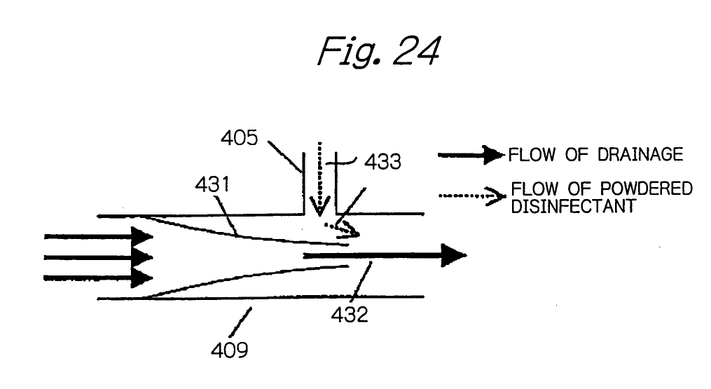

Further, the disinfectant introducing device 409 as shown in FIG. 24 has plate members 431 forming an orifice arranged in a channel in which sewer stormwater overflow is allowed to flow. And, in the neighborhood of the orifice, disinfectant transfer piping 405 is connected to the channel. When a stream of drainage is passing through the orifice, a jet streamed is generated and by this stream, the neighborhood of the end of the disinfectant transfer piping 405 becomes in a reduced pressure state, and by the suction generated by this reduced pressure state, the powdered or granular disinfectant 433 is transferred toward the jet stream and mixed with drainage by the action of agitation by the jet stream.

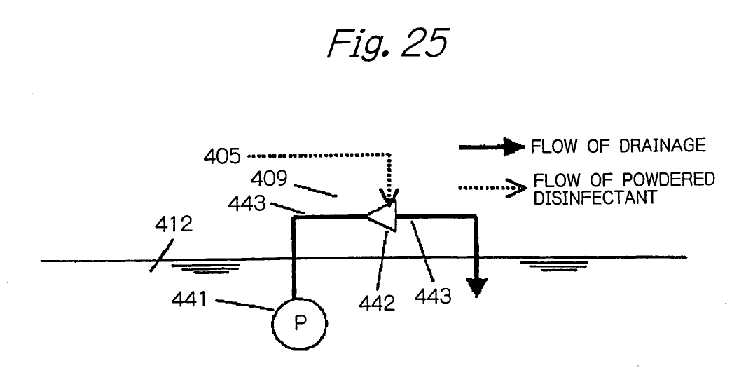

Furthermore, the disinfectant introducing device 409 as shown in FIG. 25 has a pump 441 arranged in a stream 412 of sewer stormwater overflow, and from this stream of water, the drainage is introduced into piping 443 and returned to the stream of water 412 via an ejector 442. And, disinfectant transfer piping 405 is connected to an ejector 442. By the ejector 442, a jet stream is generated to render the neighborhood of the end of the disinfectant transfer piping 405 in a reduced pressure state and by the suction generated by this reduced pressure state, the powdered or granular disinfectant is transferred toward the piping 443 and mixed with drainage by the action of agitation of the jet stream. As the means to render the inside of the disinfectant introducing device in a reduced state, an aspirator may be installed in the neighborhood of the disinfectant introducing device 409 in addition to the above described constitution.

Thus, direct introduction of a solid bromine-based disinfectant as such into the target sewer stormwater overflow to mix therewith has the following advantages.

First, the cost of equipment is reduced because equipment for dissolving a disinfectant required in the method of dissolving or suspending the disinfectant in water beforehand and introducing the resulting disinfecting water into water to be disinfected, that is a dissolving tank, an agitating device, an injector and the like become unnecessary, and thus the cost of equipment is reduced. Furthermore, equipment for pumping the disinfecting water after dissolution or suspension of the disinfectant in water, that is, a transfer pump, an injector and the like become unnecessary. Further, when the disinfecting fluid in the form of a slurry is added to the water to be disinfected, in order to inhibit ununiform distribution of the disinfectant in a dissolving tank, sufficient agitation in the dissolving tank has to be continued but this operation becomes unnecessary. Still further, the disinfectant in the form of a solution or a slurry neither accumulates in piping nor clogs it.

Particularly, in disinfecting sewer stormwater overflow by introduction of a disinfectant fluid, the necessary amount of introduction of the disinfectant fluid depends on the conditions of rainfall and greatly varies, and accordingly it is necessary to always prepare a more than the necessary amount of the disinfectant fluid. However, once the disinfectant is dissolved in water, the activity of disinfection is remarkably reduced compared to the disinfectant in a solid state and the storage of the disinfectant in a dissolved state is difficult. Thus, the solution prepared in a more than necessary amount of introduction has to be discarded to lead to an increase in operation cost and the waste of resources. However, by employing a technique of directly introducing a solid bromine-based disinfectant as such into the sewer stormwater overflow to mix them, a necessary amount of the disinfectant alone is discharged from the storage tank at necessary time and as a result, the amount of introduction of the disinfectant can be appropriately controlled, and at the time of complete introduction, no waste of the disinfectant dissolved fluid is caused. Furthermore, even in the facilities having difficulty in securing water for dissolving the disinfectant beforehand, secure disinfection can be performed. Further, the control of the amount of introduction of the disinfectant is easy and the danger of excess introduction or insufficient introduction is reduced. Still further, by employing a structure to cause a jet stream in the disinfectant introducing device, the inside of the disinfectant transfer piping is rendered in a reduced pressure state to transfer a powdered or granular disinfectant, and even when breakage occurs in the transfer piping, the disinfectant does not spout out from the broken part.

The embodiments explained above disinfect sewer stormwater overflow by introducing and mixing a solid bromine-based disinfectant as such into the target sewer stormwater overflow to be treated but in order to execute disinfection by introducing the solid bromine-based disinfectant into sewer stormwater overflow, the operation of mixing a disinfectant with the target sewer stormwater overflow is not necessarily performed at the point of introduction of the disinfectant.

A first object of the mixing operation is to dissolve a solid disinfectant in water to be treated. When the disinfectant is solid, the contact efficiency between the disinfectant and the water to be treated is reduced. By dissolving the disinfectant in water, the contact efficiency between the disinfectant and the water to be treated is improved to increase the rate of disinfection. When the time until sewer stormwater overflow is discharged to public water body is restricted, it is important to accelerate the rate of disinfection in order to obtain a satisfactory disinfection effect.

A second object of the mixing operation is to uniformly disperse the disinfectant into water to be treated. Unless the disinfectant is uniformed spread over the entire water to be treated, the disinfectant is excessively introduced in the place of a high disinfectant concentration to waste the disinfectant and there is a possibility of discharging residual halogens to public water body at a high concentration. On the other hand, at the place of a low disinfectant concentration, the disinfectant is insufficiently added and satisfactory disinfection is not executed. By uniformly diffusing the disinfectant into water to be treated to equalize the disinfectant concentration, the disinfectant in proper quantities can be added.

A third object of the mixing operation is to reduce residual halogens to a concentration of a specified value or less by dissolving and diffusing the disinfectant into water to be treated until sewer stormwater overflow arrives at public water body. If the disinfectant flows into public water body in a solid state or in an ununiform state of the dissolved disinfectant at a high concentration, residual halogens having a locally high concentration are discharged to possibly affect an ecosystem around the discharged areas. To inhibit this, until sewer stormwater overflow arrives at public water body, it needs time to completely dissolve the disinfectant and further to reduce residual halogens after dissolving the disinfectant. On account of this, it is important to dissolve and diffuse the disinfectant in water to be treated by the mixing operation.

Then, a halogen-based disinfectant disinfects by its disinfecting power (oxidative power) and the time until the oxidative power disappears after completion of oxidation reaction is very short compared to the time necessary for dissolution. For example, when disinfection is performed with the use of the 1-bromo-3-chloro-5,5-dimethylhydantoin (BCDMH) as a halogen-based disinfectant at an active halogen concentration of 2 mg/L as Cl, the reduction of the active halogen concentration to 0.5 mg/L as Cl can be used as an index of the disappearance of oxidative power. When the amount of addition of the disinfectant is 10 mg/L as Cl, the time necessary for dissolving the disinfectant is about one minute while the time necessary for reducing the active halogen concentration of 2 mg/L as Cl to that of 0.5 mg/L is about 10 to 30 seconds. This time is affected by the organic substance concentration in water to be treated, that is, sewer stormwater overflow. Accordingly, by dissolving the disinfectant little by little and securing about 30 seconds of time after completely dissolving the disinfectant, both satisfactory disinfection effect and reduction of residual halogens in discharged water can be sought.

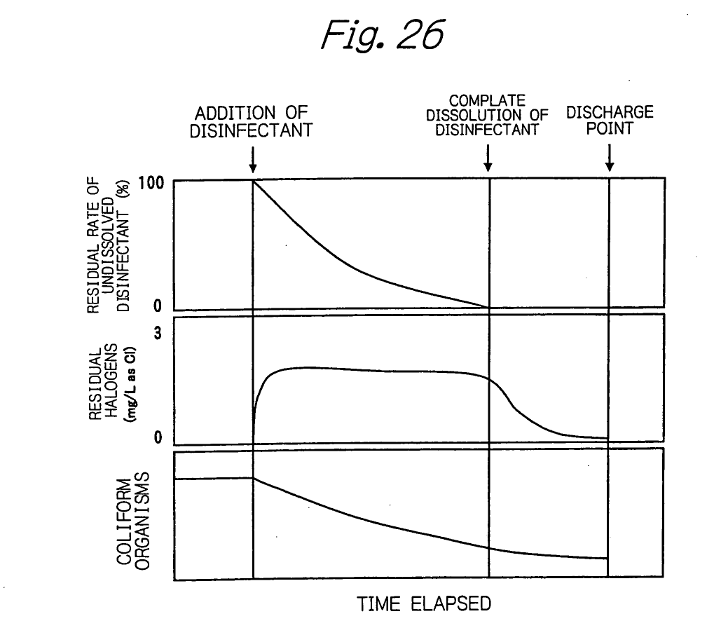

This is schematically shown in FIG. 26. FIG. 26 shows residual rate of undissolved disinfectant, residual halogen concentration and coliform organism count with time when a solid disinfectant as such is introduced into water to be treated. The disinfectant dissolves with time and the amount of undissolved disinfectant decreases while the residual halogen concentration increases. However, since halogens are consumed and reduced with oxidation reaction such as disinfection reaction, the reduced halogen concentration progresses with a certain amount of halogens present by offsetting an increment by dissolution of the disinfectant against a decrement by consumption of the disinfectant in the oxidation reaction. And, when undissolved disinfectant ceases to be present, the residual halogen concentration rapidly decreases. During this period, the coliform organisms are exposed to the oxidative power constantly supplied and continues decreasing until residual halogens are exhausted.

Thus, according to another embodiment of the present invention, sewer stormwater overflow is disinfected by introducing a solid bromine-based disinfectant as such into the target sewer stormwater overflow to be treated and completely dissolving the disinfectant until the disinfectant arrives at public water body from the place of addition of the disinfectant.

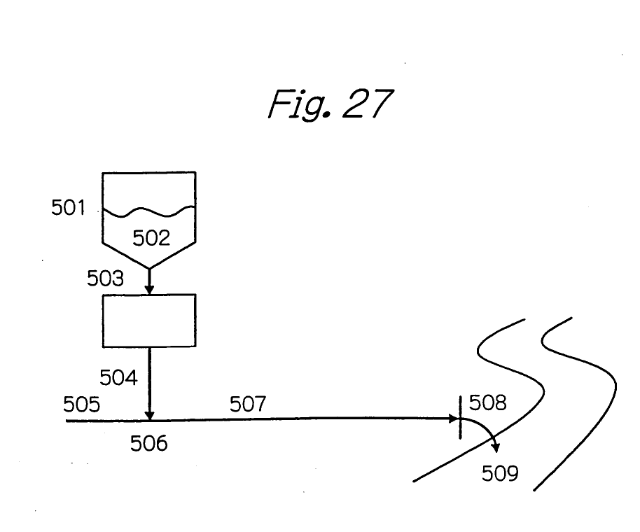

FIG. 27 shows a concept of the sewer stormwater overflow disinfecting apparatus relating to another embodiment of the present invention based on such a technical thought. In FIG. 27, numeral 501 is a disinfectant storage device in which a solid bromine-based disinfectant 502 is stored. The solid bromine-based disinfectant is metered by a device 503 for controlling the amount of introduction and transferred to a position 506 of addition of the disinfectant provided in a channel 505 for sewer stormwater overflow via disinfectant transfer piping 504, and added to the target sewer stormwater overflow 505 to be disinfected. The sewer stormwater overflow added with the disinfectant flows downstream spending a specified time in a channel 507 to a sewer stormwater discharge port 508 and discharge to public water body 509.

In a preferred embodiment, as to the time for the sewer stormwater to arrive at the discharge port 508, it is preferred to secure at least two minutes after addition of the disinfectant at the position 506 of addition of the disinfectant, and furthermore at least one minute after complete dissolution of the disinfectant. By this, disinfectant dissolves and diffuses into sewer stormwater overflow by a stream of water while flowing downstream in the channel 507. The disinfectant dissolved successively exhibits disinfection power (oxidative power) to effect disinfection reaction and loses the disinfection power by oxidation reaction. Thus, the solid bromine-based disinfectant dissolves in the sewer stormwater overflow and continues supplying disinfection power (oxidative power) little by little over a specified period of time while flowing downstream in the channel 507. Since the disinfectant power supplied is consumed by successive oxidation reaction to disappear, residual halogens do not remain at a high concentration at the discharge port 508.

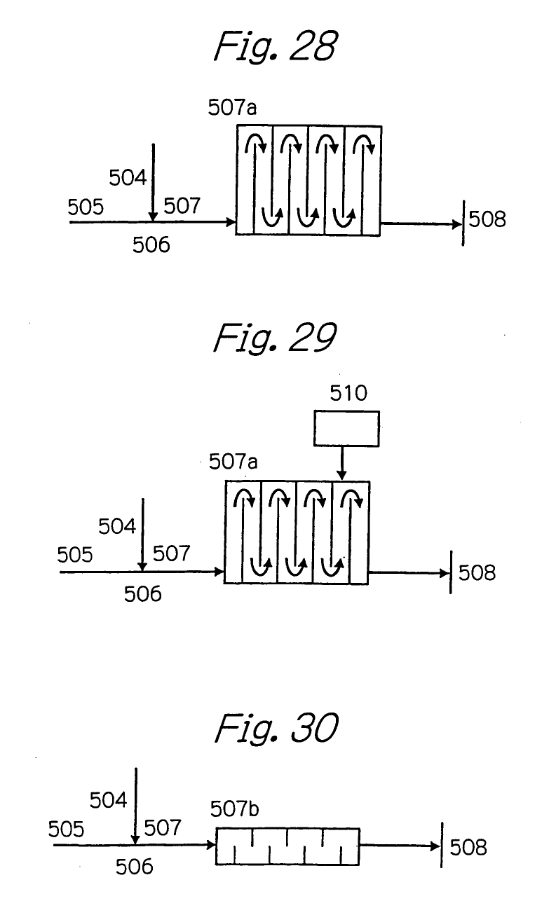

FIG. 28 shows a varied form of the shape of a channel 507 for sewer stormwater overflow after addition of a disinfectant. In order to secure time taken between the position 506 of addition of the disinfectant and the discharge port 508, the channel 507 is of an indirect flow type channel 507a. The indirect flow channel 507a can be rendered a tank having the same volume and in this case, partition plates are preferably arranged in the tank and a short-circuit flow is prevented to allow the stream of water to approximate to a “push flow”. This indirect flow type channel may be either of a horizontal indirect type or vertical indirect type.

FIG. 29 shows another example of-the form. In this example, a dehalogenating agent adding device 510 is installed in the middle of the channel. When excess amount of a disinfectant is added, residual halogens may sometimes not sufficiently be reduced. In preparation for such a case, a reducing agent such as sodium sulfite is added from the dehalogenating agent adding device 510 to neutralize residual halogens. The position of addition of the reducing agent from the dehalogenating agent adding device 510 may be in the middle of the indirect flow type channel 507a or downstream of the indirect flow type channel 507a.

FIG. 30 shows a further example of the form. In this example, the channel for sewer stormwater overflow after addition of a disinfectant is constituted of a static mixer 507b. When it is possible to secure time for the sewer stormwater overflow to arrives at a discharge port 508, dissolution/mixing can be accelerated due to the stream of water by the static mixer 507b to further increase the disinfection effect.

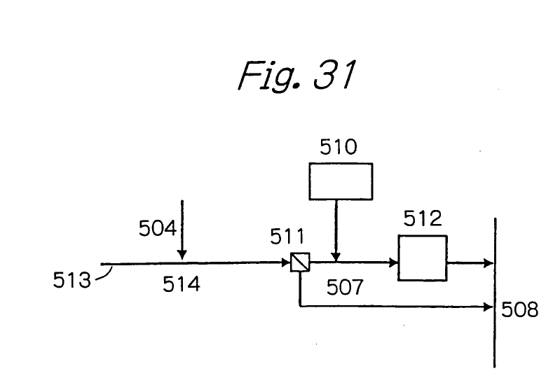

FIG. 31 shows a still further example of the form. For example, when a disinfectant is added to sewer stormwater overflow from sewer storm overflow facilities 511 such as a storm overflow chamber and a pumping station to disinfect the sewer stormwater overflow, sometimes it is impossible to secure sufficient time for the sewer stormwater overflow to arrive at a discharge port 508. In this instance, a point 514 of introduction of the disinfectant is provided in a sewer 513 upstream of the sewer stormwater overflow removal facilities 511 and at this point, the solid bromine-based disinfectant can be added to secure the time taken between the addition of the disinfectant to the water to be treated and its arrival at the discharge port, provided that in this instance, part of the sewage added with the disinfectant flows into a sewage treatment plant 512. Then, when the residual halogen concentration is not reduced until the sewage added with the disinfectant arrives at the sewage treatment plant, a dehalogenating agent adding device 510 is installed midway between the point of introduction of the disinfectant and the sewage treatment plant, and a reducing agent such as sodium sulfite is added to neutralize residual halogens.

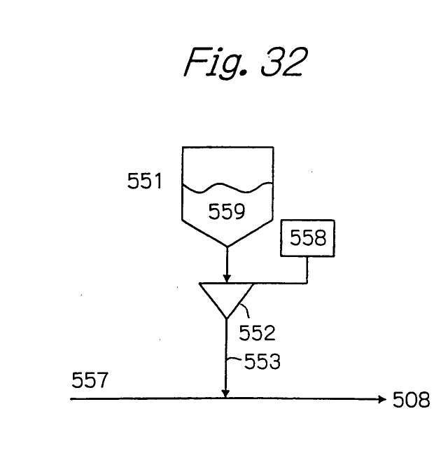

FIG. 32 show another constitution of a disinfectant adding apparatus of the disinfection system for introducing a solid bromine-based disinfectant as such into the target sewer stormwater overflow to be treated. In a disinfectant storage tank 551, a powdered or granular solid bromine-based disinfectant 559 is held. The disinfectant 559 is metered by an introduction device 552 to which a device 558 for controlling the amount of introduction of the disinfectant is connected, and introduced into sewer stormwater overflow in a channel 557 via disinfectant transfer piping 553, and the sewer stormwater overflow after disinfection is discharged to public water body form a discharge port 508.

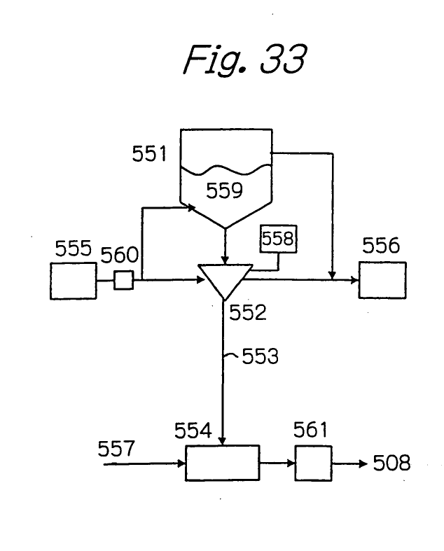

FIG. 33 shows another example of constitution. In a disinfectant storage tank 551, a powdered or granular solid bromine-based disinfectant 559 is held. The disinfectant 559 is weighed by an introducing device 552 to which a device 558 for controlling the amount of addition is connected, and sent into disinfectant transfer piping 553. The end of the disinfectant transfer piping 553 is connected to a disinfectant mixing device 554, and the disinfectant 559 supplied to the disinfectant mixing device 554 is introduced into sewer stormwater overflow flowing in a channel 557 and mixed therewith in the mixing device 554. Further, dry air is injected from a dry air supply device 555 into the storage tank 551 and the device 552 for controlling the amount of introduction. This injection of dry air can constantly maintain the insides of the storage tank 551 and the device 552 for controlling the amount of introduction in a dry state or in a pressurized state. Furthermore, in order to maintain the pressure in the insides of the storage tank 551 and the device 552 for controlling the amount of introduction in a constant pressurized state, a pressure control device 560 can be installed between the dry air supply device 555 and the storage tank 551 and the device 552 for controlling the amount introduction. The exhaust from the storage tank 551 and the device 552 for controlling the amount of introduction after removal of the disinfectant in the exhaust by a duct collector 556 is discharged to atmosphere. It is also possible that a reducing agent is added to the disinfection treated water discharged from the disinfectant adding device 554 by a reducing agent adding/mixing device 561 to neutralize residual halogens, and then the water thus treated is discharged from the discharge port 508. As the disinfectant mixing device 554, any device having a function to mix the disinfectant with the target sewer stormwater overflow to be disinfected to a disinfecting state may be used. For example, a channel, a pipe or a tank which has a wall for forming an indirect flow, a diffuser connected to an air supply machine, an ultrasonic generator, an agitating device having a rotor blade, a reducer and a pump can be used.

Next, a method of controlling the amount of introduction of a solid bromine-based disinfectant in the present invention will be explained. It is needless to say that smaller amounts of a halogen-based disinfectant such a solid bromine-based disinfectant reduce adverse affect on the environment and human beings and are desirable. However, such are the facts that in order to achieve/maintain a satisfactory disinfection effect on pathogens from the standpoint of a safety precaution, the disinfectant has been used in an amount exceeding the properly necessary concentration of its active ingredient.

However, as the adverse effect of too high residual halogen concentrations in the drainage discharged to public water body after disinfection treatment on an ecosystem of aquatic organisms, plants and animals which grow or inhabit in public water body and the environs becomes clarified, the necessity of the addition of an appropriate disinfectant concentration to drainage has been recognized.

Then, the water quality of the target sewer stormwater overflow to be treated by the present invention violently varies in a short time, and thus it is very difficult to determine an appropriate disinfectant concentration. In other words, the water quality of the sewer stormwater overflow instantly varies to a great extent depending on the conditions of rainfall, and accordingly there is a problem such that due to a large variation in the necessary amount of the disinfectant between high concentrations of reductive organic substances and/or inorganic substances as well as polluted water and their reduced concentrations of by the progression of dilution with rainwater, it is difficult to find an appropriate amount of the disinfectant which exhibits an appropriate disinfecting effect without causing residual halogens to add the minimum necessary amount of the disinfectant against the water to be treated.

Then, in the present invention, it is possible to find an appropriate amount of the disinfectant which exhibits an appropriate disinfecting effect without forming residual halogens to add the minimum necessary amount of the disinfectant to the water to be treated in accordance with the change in the water quality of the drainage.

The technical thought of one method of controlling the amount of a disinfectant introduced in the present invention will be explained based on a specific example. The following explanation is to explain one specific example and the present invention is not restricted thereto. First, in the existing sewage treatment facility, combined sewer overflow at various points of time during a rain is collected in a beaker and BCDMH is added to the beaker as a disinfectant in an amount of 3 ppm (=mg/L) to perform disinfection for 90 seconds. The relationship between the elapsed time after beginning of a rain and the coliform organism count in the water to be treated after disinfection is found. The result is shown in Table 34.

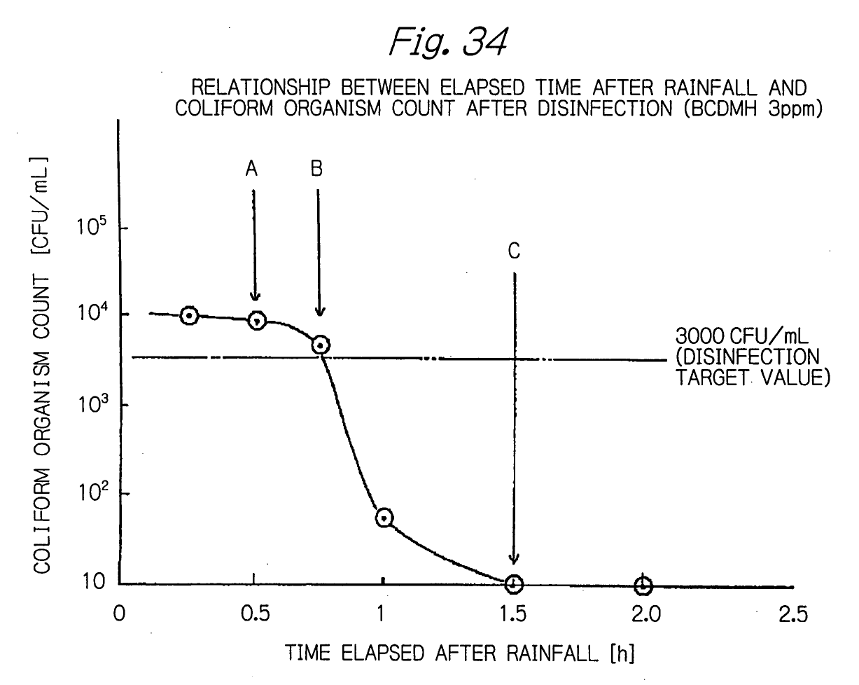

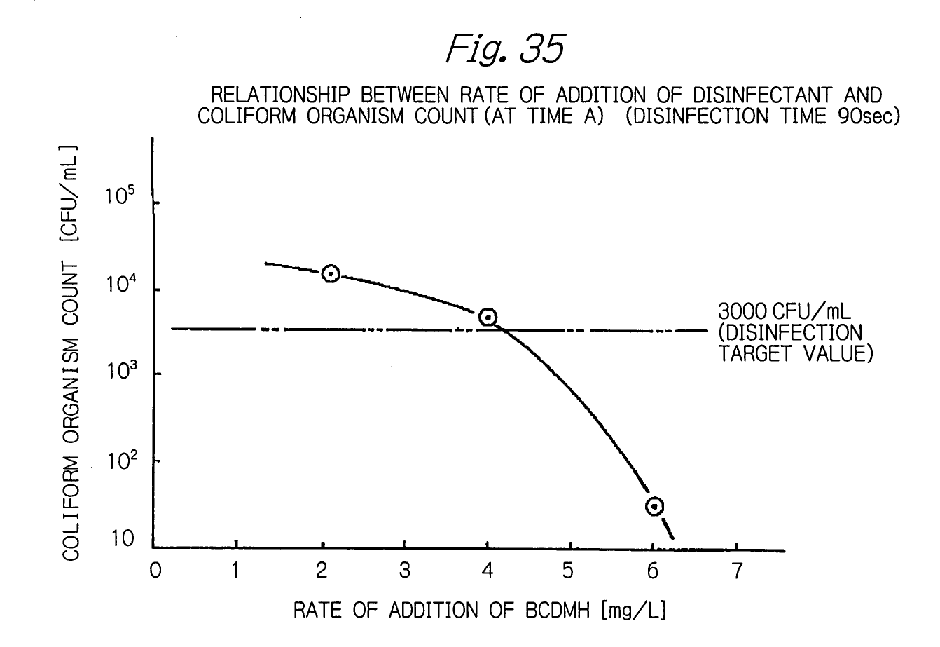

It could be understood from FIG. 34 that 30 minutes after a rain (point A) the coliform organism count after disinfection was 9,000 CFU/mL and 45 minutes after the rain (point B) the coliform organism count after disinfection was 4,700 CFU/mL, and both does not meet the target disinfection value (the discharge standard value regulated by the Water Pollution Control Law: not more than 3,000 CFU/mL), and 1.5 hours after the rain (point C) the coliform organism count after disinfection was less than 10 CFU/mL which was lower than the target disinfection value. This shows that the effect of disinfection in the same amount (3 ppm) of the disinfectant varies in accordance with change of properties of the wet-weather sewer depending on the continuance of the rain to cause the state of excess or insufficient disinfectant. In other words, since immediately after beginning of a rain, a high concentration of coliform organisms in sewage flows out, a large amount of an disinfectant is needed for sufficient disinfection, and at the point of time after some time elapsed since the beginning of the rain, sewage is diluted with rainwater to decrease the coliform organism count in the sewage, and thus the amount of a disinfectant needed for disinfectant is decreased.

Then, the combined sewer overflow after 0.5 hour elapsed since the beginning of the rain is collected in a beaker and added with BCDMH at a varied rate of addition and subjected to disinfection for 90 seconds to count the coliform organism count in the treated water. The results is shown in FIG. 35. The rate of addition of BCDMH is 2 ppm and the coliform organism count is 104 CFU/mL or more, which does not meet the target disinfection value of 3,000 CFU/mL. The coliform organism count in the treated water after disinfection becomes slightly higher than 3,000 CFU/mL at a rate of addition of BCDMH of 6 ppm, which much lower than the target disinfection value. From this fact it can be understood that the addition of BCDMH at a rate of addition of about 4.2 to 4.3 ppm is necessary.

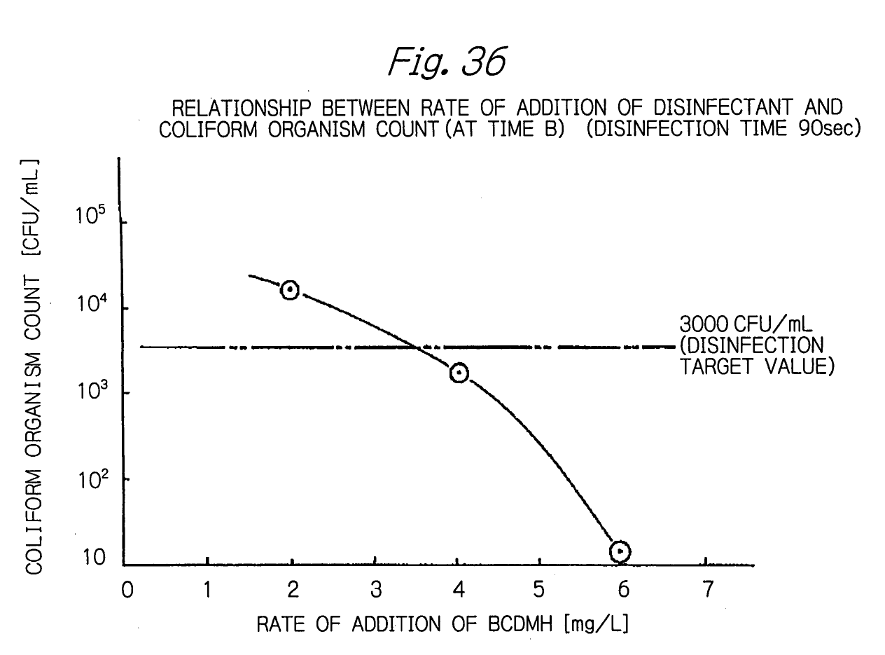

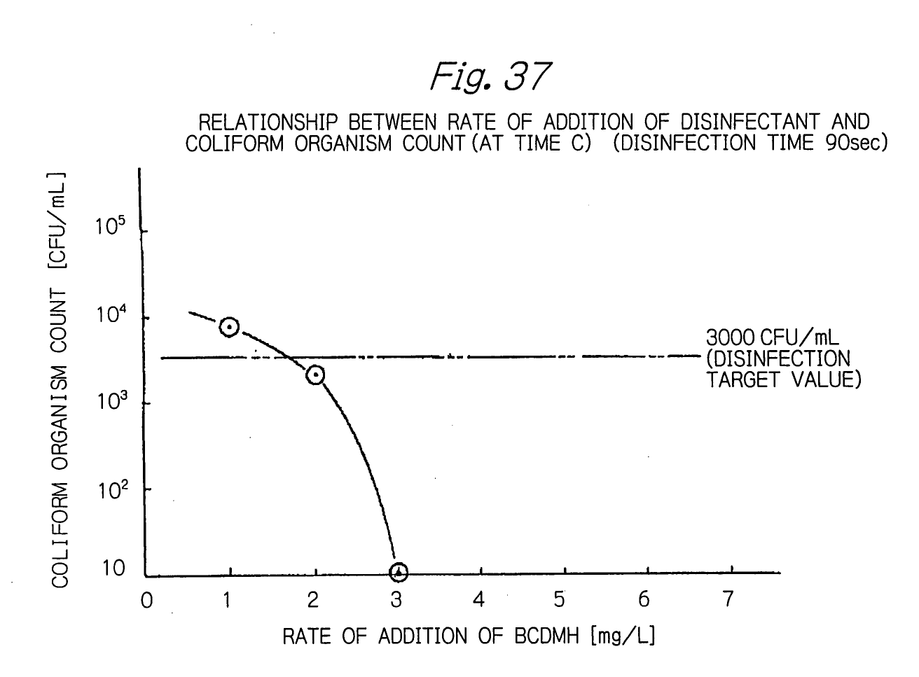

With respect to an elapse of time of 45 minutes (Point B in FIG. 34) and 1.5 hours (Pont C in FIG. 34) after starting rainfall, the relationship between the rate of addition of BCDMH and the coliform organism count 10 seconds after disinfection was examined and the results were shown in FIG. 36 and FIG. 37. From these Figures it can be understood that at Point B (45 minutes elapsed after starting rainfall) the rate of addition of BCDMH necessary for the disinfection of sewer stormwater overflow is about 3.5 to 3.6 and at Point C (1.5 hours elapsed after starting rainfall) the rate of addition of BCDMH necessary for the disinfection of sewer stormwater overflow is about 1.6 to 1.7.

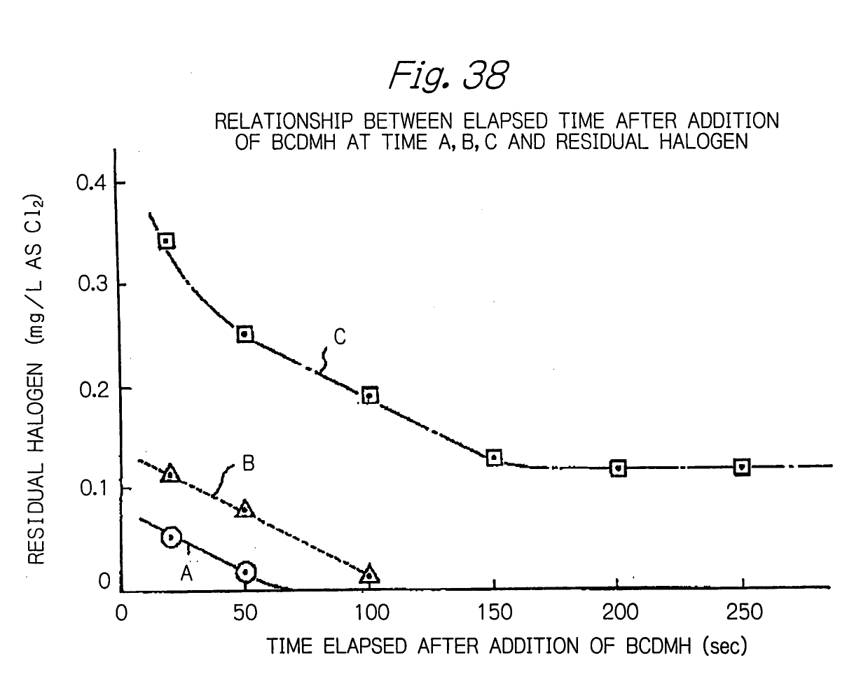

Next, combined sewer stormwater overflow at Point A (30 minutes elapsed after starting rainfall), Point B (45 minutes elapsed after starting rainfall) and at Point C 1.5 hours elapsed after starting rainfall) was collected in beaker, added with BCDMH at the same rate of addition of 3 ppm as in the experiment of FIG. 34, and the relationship between the time elapsed after addition of BCDMH and the residual halogen concentration in the water to be treated was examined. The results are shown in FIG. 38. At Point A (30 minutes elapsed after starting rainfall) the residual halogen concentration is already less than 0.1 mg/L as Cl₂ immediately after addition of the disinfectant and by combining this value with the results of FIG. 34, it can be said that with the rate of addition of BCDMH of 3 ppm, the disinfecting effect on the water to be treated is not enough. It can be said that at Point B (45 minutes elapsed after starting rainfall) the residual halogen concentration about 20 seconds after addition of the disinfectant is about 0.1 mg/L as Cl₂ to closely approximate to zero in 100 seconds. By combining this value with the results (4,700 CFU/mL of the coliform count in 90 seconds) of FIG. 34, it can be said that the rate of addition of the disinfectant of 3 ppm at Point B is still slightly less than the necessary amount. Further, at Point C the residual halogen concentration about 20 seconds elapsed after addition of the disinfectant is as high as a little over 0.3 mg/L as Cl₂ in about 20 seconds and slowly decreases until about 150 seconds but in and after 150 seconds, the residual halogen concentration is a little over about 0.1 mg/L as Cl₂ and is stabilized (saturation of disinfecting effect). Thus, it can be said that after this time the amount of addition of the disinfectant of 3 ppm at Point C (1.5 hours elapsed after starting rainfall) is in excess, and the residual halogens has remained after disinfection.

On the basis of these results, in the treatment of sewer stormwater in said sewage treatment facility, the residual halogen concentration after disinfection may be set at the point nearly midway between line B and line C in FIG. 38 by allowing a little margin in order to securely attain the target value of disinfection. That is, from FIG. 38, the residual halogen concentration at the point of time 20 seconds after addition of BCDMH may be set at 0.2 mg/L as Cl₂. On actual disinfection, samples of drainage are regularly collected and added with an disinfectant having a predetermined concentration to determine the level of decrease in the residual halogen concentration. When this value is higher than the set value (in the above case the residual halogen concentration 20 seconds after addition of the disinfectant is 0.2 mg/Las Cl₂), the amount of introduction of the disinfectant to drainage is adjusted to a value lower than the concentration introduced to the samples of the drainage while the level of decrease in the residual halogen concentration is lower than the set value, the amount of introduction is set at a value higher than the concentration introduced to the sampled drainage. By regularly repeating this operation to control the amount of introduction of the disinfectant to drainage with time, it is possible to maintain the amount of introduction of the disinfectant at an optimum value with a satisfactory disinfecting effect and without causing residual halogens. Further, the concentration of the disinfectant to be introduced to samples may be preferably taken as the concentration to be actually introduced at that point of time. By doing this, huge variation of the concentration of introduction of the disinfectant can be prohibited and more precise control is possible. Further, from the difference between the level of decrease in the residual halogen concentration measured in the sample and the set value, a person with ordinary skill in the art can empirically determine to what extent the concentration of introduction of the disinfectant to drainage is increased or decreased.

Further, the curves of FIG. 34 and FIG. 38 show nearly the same tendency although with some variations when the sewage treatment facility for treating drainage is the same. Thus, when similar graphs of the level of decrease in the residual halogen concentration as in FIG. 34 and FIG. 38 are prepared in the sewage treatment facility for treating the drainage, on and after a rainfall, the amount of addition of a disinfectant to sewer stormwater overflow can be controlled based on this set value.

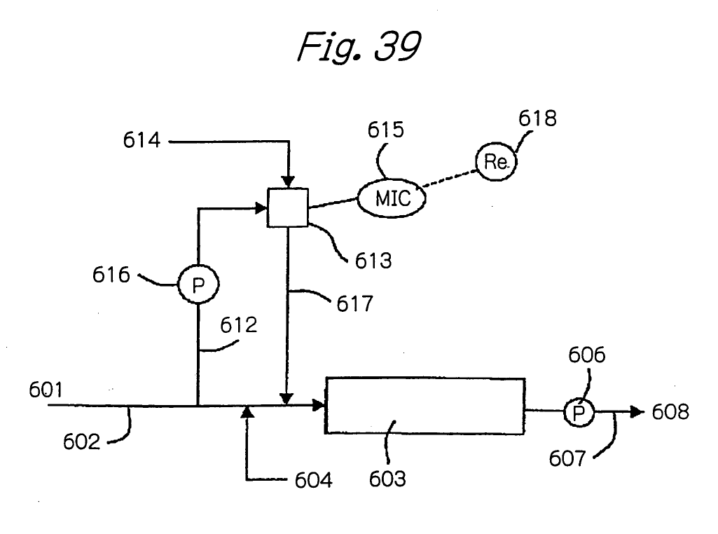

The organization of a disinfecting apparatus for sewer stormwater overflow relating to one embodiment of the present invention is shown in FIG. 39.

The disinfecting apparatus as shown in FIG. 39 has an introducing line 602 for the water to be treated (sewer stormwater to be treated) 601, a disinfecting tank (sand basin) 603 and a disinfectant introducing means 604 to introduce a disinfectant to the water to be treated. As the disinfectant introducing means, various forms of disinfectant feeding devices as described above can be used. The disinfectant introducing means 604 may be arranged on a line 602 upstream of the disinfecting tank or the disinfectant may be directly added to the disinfecting tank 603. As explained above, the disinfectant may be introduced in a channel for sewer stormwater overflow without providing the disinfecting tank (sand basin) 603. Further, a branched line 612 for collecting samples of the water to be treated for a test is connected in the middle of the line 602 for introducing the water to be treated. A bucket pump 616 is connected to the branched line 612.

In order to carry out the disinfecting method of the present invention, first, in a preparatory stage, in sewer stormwater overflow removal facilities for treating the overflow, a plurality of overflow samples various times elapsed after starting rainfall are collected, added with an appropriated amount of a disinfectant to measure the coliform organism count after disinfection, and the relationship (graph of FIG. 34) between the time elapsed after a rainfall and the coliform organism count after disinfection and the relationship (graph of FIG. 38) between the time elapsed after addition of the disinfectant and the residual halogen concentration in the water to be treated are prepared. Then, from these results, a target value of the level of decrease in the residual halogen concentration is set beforehand. For example, when the relationships as shown in FIG. 34 and FIG. 38 could be obtained, the target value of the residual halogen concentration of 0.2 mg/L as Cl₂ 20 seconds after addition of the disinfectant is set as explained above.

The disinfection of sewer stormwater overflow is executed by introducing an appropriate amount of the disinfectant from the disinfectant introducing means 604 and treating the sewer stormwater overflow in the disinfecting tank 603, and in the method of the present invention, the water to be treated before addition of the disinfectant is periodically sampled from a line 612. The sampled water to be treated is housed in a monitoring tank 613, added here with the disinfectant 614 having a predetermined concentration, mixed and agitated by an agitator (not shown the figure). In order to enable precise control of concentration, the concentration of the disinfectant added to the monitoring tank is preferably set at the concentration actually supplied to the water to be treated by the disinfectant introducing means 604 at that point of time. The monitoring tank 613 is connected to a measuring instrument for measuring the numerical value of the residual halogen concentration of the water to be treated after addition of the disinfectant with time. The residual halogen concentration measuring instruments used for this purpose include, for example, a free-chlorine meter by the polarographic system (for example, trade name “CLM-37” or “CLM-22”, manufactured TOA D.D.K. Co., Ltd.). The residual halogen concentration measured is recorded by a recorder 618. And, for the sewer stormwater overflow removal facilities, the target value set beforehand is compared with the value measured by the monitoring tank 613. For example, when the sewer stormwater removal facilities have already obtained the graphs of FIG. 34 and FIG. 38, the set value is the residual halogen concentration 20 seconds after addition of the disinfectant of 0.2 mg/L as Cl₂, and thus the residual halogen concentration, 20 seconds after addition of the disinfectant of the sampled water to be treated added with the disinfectant in the monitoring tank 613, is measured. And, when this value is higher than 0.2 mg/L as Cl₂, the concentration of the disinfectant to be introduced from the disinfectant introducing means 604 is decreased while the value is lower than 0.2 mg/L as Cl₂, the concentration of the disinfectant to be introduced is increased. The control of this introduction of the disinfectant concentration can be automatically executed by inputting the target value of the level of decrease in the residual halogen concentration set beforehand to a computer (not shown in the Figure) to control the amount of introduction of the disinfectant in accordance with the result of comparison between the set value and the measured value. The sample of the water to be treated after completion of the measurement on the level of decrease in the residual halogen concentration is returned via a return line 617 and introduced to the disinfecting tank 603 together with the water to be treated. In the disinfecting tank 603, the water to be treated added with the disinfectant is allowed to dwell one minute in shorter time and 10 minutes in a longer time to advance the reaction with the disinfectant. The water to be treated after disinfection is pumped by a pump 606 and discharged to public water body 608 via a discharge waterway 607.

Further, it is preferred to collect a sample of water to be treated upstream of the disinfectant introducing position. When the sample is collected downstream of the disinfectant introducing position, that is, when the water to be treated added with disinfectant is collected as a sample, the residual halogen concentration is measured at a certain point during disinfection and as shown in FIG. 38, the residual halogen concentration after addition of the disinfectant very sensitively varies depending on the progression of time, and it is impossible to appropriately control the concentration.

According to this embodiment, the above described monitoring operation is regularly performed, for example, every 1 t 60 minutes, preferably every 5 to 20 minutes, and the concentration of addition of the disinfectant is adjusted in accordance with the results. This enables giving a satisfactory disinfection effect and maintenance of an appropriate disinfectant concentration without discharging residual halogens to public water body particularly in disinfecting sewer stormwater overflow whose properties vary with the progression of time.

Further, in disinfection of sewer stormwater overflow, although the amount of the disinfectant added varies depending on the type of the disinfectant used, the properties of the overflow and the like, the amount is typically 1 to 10 mg/L (ppm), preferably 2 to 6 mg/L and it is preferred in the present invention as well to control the amount of the disinfectant added in this range.

As described above, the disinfecting tank 603 may neither be a specific reaction tank and may be the form of the channel of the sewer stormwater overflow as long as a necessary contact time for disinfection by a solid bromine-based disinfectant may be taken. Herein, the contact time necessary for disinfection by the solid bromine-based disinfectant may be set at at least 20 seconds, if possible, 30 second, more preferably 60 seconds by setting a maximum overflow rate of the sewer stormwater overflow to be treated. Further, it is rational to set the maximum overflow rate of the sewer stormwater overflow to be treated as follows. Sewer stormwater overflow in a sewer is formed at a large amount of the rainwater in the rain-wet weather in the case of combined sewer, or when a large amount of unidentified water or rainwater from manholes is introduced in separated sewer. The inflow of rainwater into sewer greatly varies dependent on the circumstances of rainfall. In other words, in the case of a typhoon, a concentrated heavy rain or the like, even flooded damage and flood of river are sometimes caused. The present invention does not assume this extremely large amount of rainfall because the water quality of the sewer stormwater overflow in this case comes to nearly the same clear water as rainwater to cease to require disinfection. Through various investigations, it is desirable to set the maximum overflow rate of the target sewer stormwater overflow to be treated to 20 to 10 times the fine-weather sewer amount. Thus, by clearing the amount of the target sewer stormwater overflow to be treated to set the contact time of the solid bromine-based disinfectant, the size of a disinfecting tank or a sewer stormwater overflow channel can be decided.

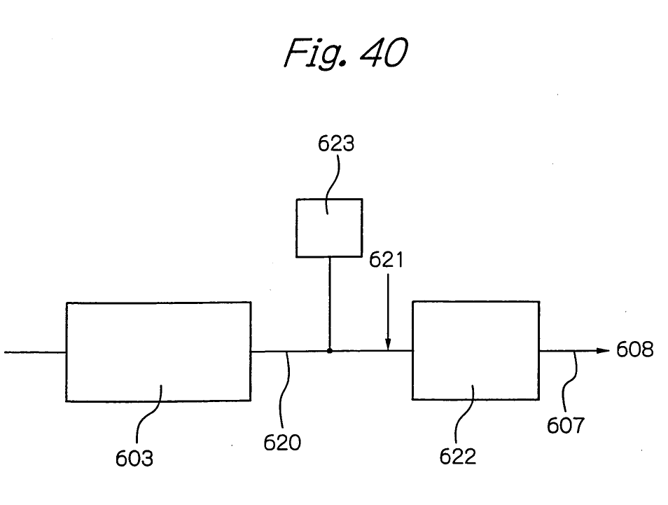

Further, it is preferred that the residual halogen concentration of the treated water added with a disinfectant by a sewer stormwater overflow disinfecting apparatus as shown in FIG. 39 is measured and, if the residual halogen concentration is high, the treated water is neutralized by the addition of a reducing agent and then discharged. The system as shown in FIG. 40 is a method of treating sewer stormwater overflow added with a disinfectant downstream of the disinfection tank 603 in FIG. 39. The sewer stormwater overflow added with a disinfectant is guided from the disinfecting tank 603 to a discharge channel. Here, the residual halogen concentration of the treated water is measured by a residual halogen concentration detector 623, and when the residual halogen concentration is high, a reducing agent 621 is introduced to neutralize residual halogens in a reducing tank 622, and then the treated water is discharged to public water body 608 via a discharge channel 607. The reducing agent 621 may be directly added to the discharge channel 620 or may be added to the reducing tank 622. Further, the treated water may be neutralized in the discharge channel 607 without installing the reducing tank 622. The reducing agent added may be sufficient in an amount chemically equivalent to the set value of the residual halogen concentration (0.2 mg/L in the former example) because the residual halogen concentration after actual disinfection is lower than the set value. Furthermore, the disinfectant introducing means a shown in FIG. 39 can be interlocked to halogen detector 623, so that when the residual halogen concentration in the water to be treated in the discharge channel 620 is high, the amount of the disinfectant introduced may be controlled. Thus, the amount of the solid bromine-based disinfectant added can be made minimal to render halogens harmless without excessively adding the reducing agent.

Further, in the disinfecting system of sewer stormwater overflow of the present invention, the time for beginning of rainfall, the amount of rainfall and the duration of rainfall are estimated from the rainfall information at the region to be treated and the amount of the disinfectant can be controlled based on the estimated values.

Heretofore, as the method of controlling a sewer disinfecting apparatus, the inflow amount of drainage, the inflow pollution load, the amount of rainfall and the intensity of rainfall are measured by measuring instruments installed in a treatment facility having a drainage disinfecting device to estimate the coliform organism count in the drainage flowing into the drainage disinfecting device from measured values by these measurements, and the amount of the chemical added has been estimated and controlled.

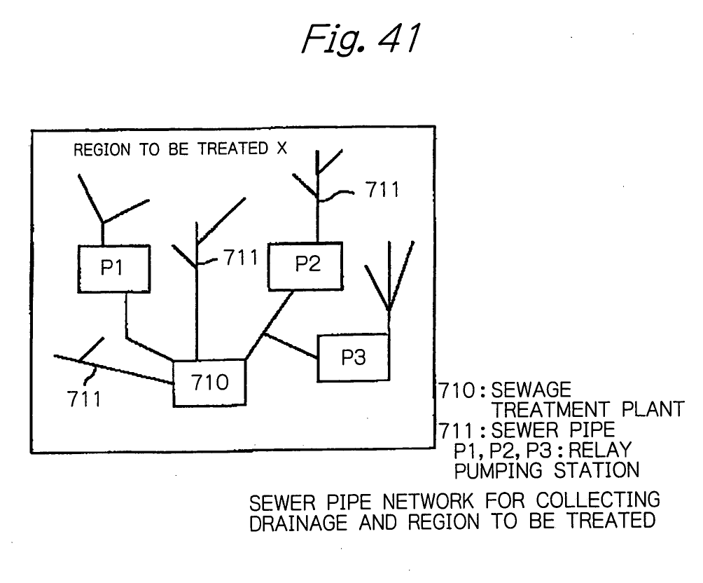

FIG. 41 is a diagram showing a sewer network system for collecting household waste water, industrial drainage and the like, and a region to be treated. Sewage, rainwater-containing sewage and drainage such as rainwater flowing on the surface of earth flow into a sewer 711 provided in region to be treated X. The drainage flowing into each sewer 711 joins and directly flows into a sewer disinfecting apparatus installed in a sewage treatment plant (sewage treatment facility) 710 or is pumped into the sewage treatment plant by each of relay pumps P1, P2, P3.

In one embodiment of the present invention, in such a sewer system, in the method of controlling a disinfecting apparatus for disinfecting the sewage, rainwater containing sewage, drainage containing rainwater or the like flowing on the surface of the earth, particularly sewer stormwater overflow in region to be treated X with an agent, rainfall information is collected from the measuring point provided in the region to be treated or the measuring points provided in the region to be treated and the adjacent region to be treated, and from this rainfall information, the time for the beginning of rainfall, the amount of rainfall and the duration of rainfall are estimated and from the estimated time for the beginning of rainfall, amount of rainfall and duration of rainfall, the amount of the agent added, the consumption of the agent and the time to start the operation of a drainage disinfecting apparatus are estimated to control the drainage disinfecting apparatus.

When such a method of controlling the disinfecting apparatus is employed, from the rainfall information collected from the measuring point provided in the region to be treated or the measuring points provided in the region to be treated and the adjacent region, the time for the beginning of rainfall, the amount of the rainfall and the duration of the rainfall in the region to be treated are estimated, and accordingly the amount of the agent added, the consumption of the agent and the time to start the operation of the drainage disinfecting apparatus can be estimated in real time.

Further, according to another embodiment, the control system for a disinfecting apparatus for disinfecting sewage, rainwater-containing sewage and drainage-containing water and the like flowing on the surface of the earth in the region to be treated with an agent has a rainfall determining means to determine the rainfall information for a region to be treated or the region to be treated and the adjacent region to be treated, a rainfall information estimation processing means to estimate the time for the beginning of rainfall, the amount of rainfall and the duration of rainfall in the region to be treated from the rainfall information determined by the rainfall information determining means, and a coliform organism count estimation means to estimate the amount of an agent added, the consumption of the agent and the time to start the operation of the drainage disinfecting apparatus, and accordingly the amount of the agent added, the consumption of the agent and the time to start the operation of the drainage disinfecting apparatus can be estimated in real time.

According to another embodiment, the above described control system of a disinfecting apparatus can have a regionality simulation means to estimate the amount of inflow water and an inflow pollution load of drainage which flows in a drainage disinfecting apparatus from the rainfall information determined by the rainfall information determining means and an estimated value compensation processing means to compensate the amount of the agent added, consumption of the agent and time to start the operation of the drainage disinfecting apparatus from the estimated amount of inflow water, and inflow pollution load by the regionality simulation means.

Thus, since the control system for the disinfecting apparatus has the estimated value compensation processing means to compensate the amount of the agent added, consumption of the agent and time to start the operation of the disinfecting apparatus by the amount of inflow water and the inflow pollution load estimated by the regionality simulation means, the amount of the agent added, the consumption of the agent and the time to start the operation of the disinfection apparatus can be further precisely estimated.

According to a still further embodiment, by providing a turbidity measuring means to measure the turbidity of inflow water of water to be treated which flows into the disinfecting apparatus in the above described control system of the disinfecting apparatus, the amount of the agent added, the consumption of the agent and the time to start operation of the disinfecting apparatus can be estimated from the time for the beginning of rainfall, the amount of rainfall and the duration of the rainfall estimated by the rainfall information estimation means and the turbidity of inflow water measured by the turbidity measuring means.

Thus, by estimating the amount of the agent added, the consumption of the agent and the time to start the operation of the disinfecting apparatus from the time for the beginning of rainfall, the amount of rainfall and the duration of rainfall estimated by the rainfall information estimation processing means and the turbidity of inflow water measured by the turbidity measuring means, the amount of the agent added, the consumption of the agent and the time for starting the operation of the drainage disinfection apparatus can be further precisely estimated.

According to a still another embodiment, the control system of the disinfecting apparatus for disinfecting sewage, rainwater-containing sewage and drainage-containing rainwater which flow on the surface of the earth and the like, particularly sewer stormwater overflow with an agent can have a rainfall information determining means to determine the rainfall information in the region to be treated or the region to be treated and the adjacent region to be treated, a regionality simulation means to estimate the amount of the inflow water and the inflow pollution load of drainage which flows into a drainage disinfecting apparatus from the rainfall information determined by the rainfall information determining means, an agent addition rate setting means to set the rate of addition of an agent based on drainage beforehand, and an agent addition amount calculation processing means to estimate the amount of the agent added and the consumption of the agent from the amount of inflow water and the inflow pollution load estimated by the regionality simulation means and the rate of addition of the agent set by the agent addition rate setting means.

Since the control system for the disinfecting apparatus has the rainfall information determining means to determine the rainfall information in the region to be treated or the region to be treated and the adjacent region to be treated, the regionality simulation means to estimate the amount of inflow water and the inflow pollution load of drainage which flow into a drainage disinfecting apparatus from the rainfall information, an agent addition rate setting means to set the rate of addition of the agent based on the water to be treated beforehand and an agent addition amount calculation processing means to estimate the amount of the agent added and the consumption of the agent from the amount of inflow water and the inflow pollution load and the rate of addition of the agent, the amount of the agent added and the consumption of the agent can be estimated in real time by a simple constitution.

According to another embodiment, any of the above described control systems for the disinfecting apparatus can have a measured value determining means to determine the amount of rainfall and the intensity of rainfall in a sewage treatment facility in which a disinfecting apparatus is installed, the amount of inflow water of the water to be treated which flows into the disinfecting apparatus, the amount of the agent supplied to the disinfecting apparatus and the residual agent concentration in discharged water which is discharged from the disinfecting apparatus and a measured value compensation processing means to compensate the estimation of the amount of the agent added, the consumption of the agent and the time to start the operation of the disinfection apparatus with the measured values by the measured value determining means.

Thus, since the control system for the disinfecting apparatus has the measured value compensation processing means to compensate the estimation of the amount of the agent added, the consumption of the agent and the time to start to the operation of the disinfecting apparatus with the measured values determined by the measured value determining means, the amount of the agent added, the consumption of the agent and the time to start the operation of the disinfection apparatus can be further precisely estimated.

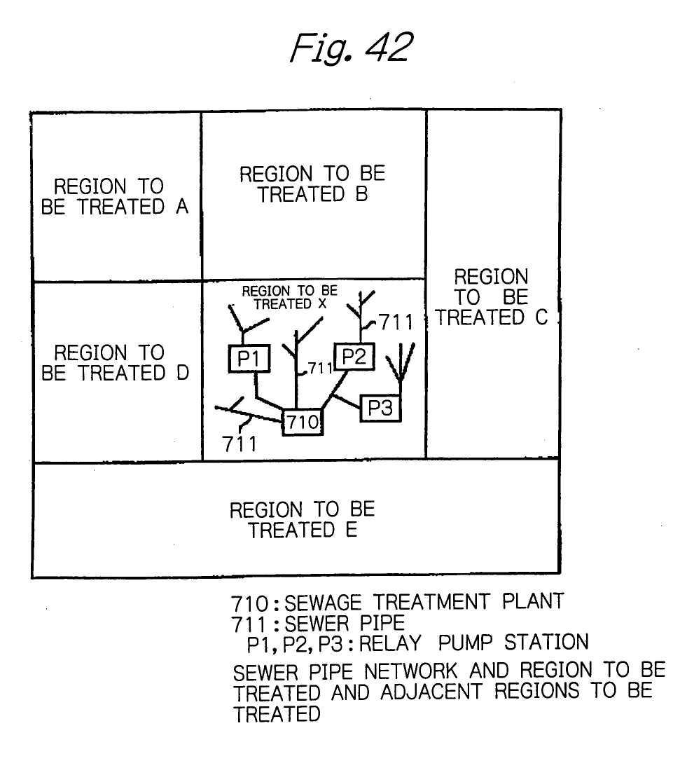

FIG. 42 shows a sewer network for collecting drainage to be disinfected by the disinfecting apparatus in the embodiments as explained above and the region to be treated or the region to be treated and the adjacent regions to be treated. As shown in FIG. 42, around region to be treated X of a sewage treatment plant (sewage treatment facility) 710 in which an apparatus for disinfecting sewer stormwater overflow is installed, regions A, B, C, D and E having the same sewage treatment plant exist adjoining region to be treated X. Further, the basic constitution of a sewer network in the present working embodiment is the same as in FIG. 41, and accordingly its explanation will be omitted.

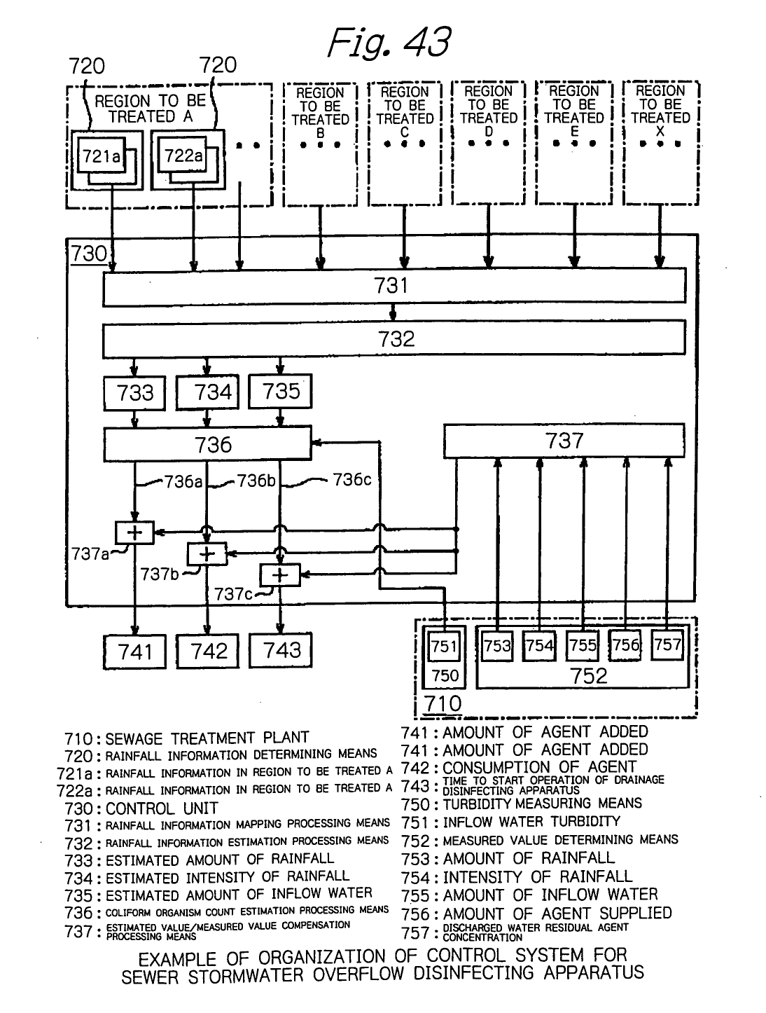

FIG. 43 is a diagram showing a constitution example of the control system for a drainage disinfecting apparatus relating to the present invention. As shown in the same Figure, a plurality of rainfall information determining means 720, 720, . . . are provided in region to be treated A and by the rainfall information determining means 720, 720, . . . , rain information 721a, 722a, . . . in region to be treated A can be determined. Further, each rainfall information determining means 720 is provided in facilities having a pumping station with a relay pump in region to be treated A, a stormwater pumping station, a sewage treatment plant and measuring equipment not shown in the Figure. With other regions to be treated B, C, D, E and X, by the same rainfall information determining means as in region to be treated A, the amount of rainfall and the intensity of rainfall in respective regions to be treated can be determined. The rainfall information determined in each of regions to be treated A, B, C, D, E and X is continuously or regularly transmitted to a control unit 730 by utilizing data transmission equipment using a commercially available telephone circuit, AMEDAS (automated meteorological data acquisition system) or the like.

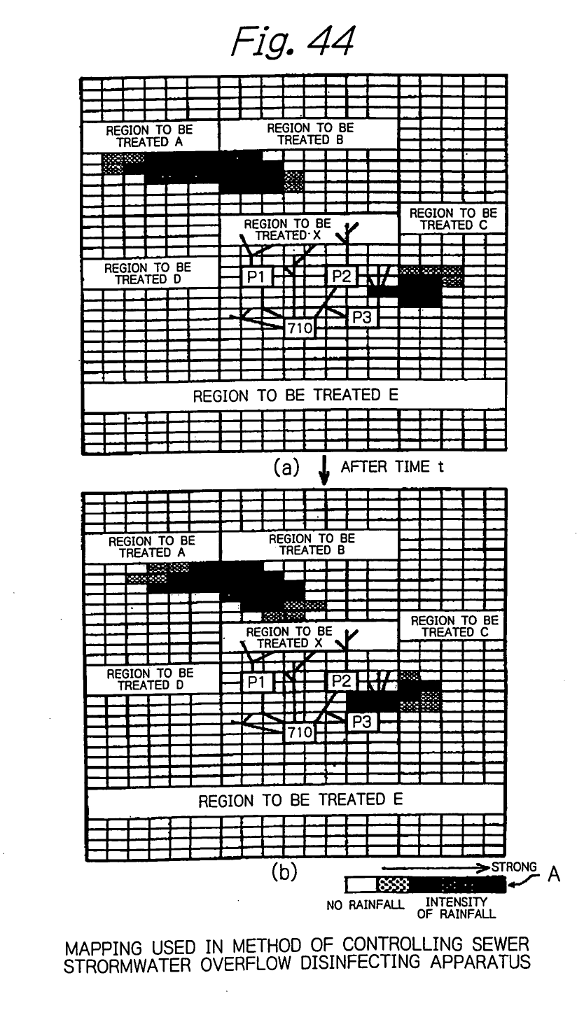

FIG. 44 is a diagram showing a mapping processing used in the method of controlling a sewer stormwater overflow disinfecting apparatus, and FIG. 44(a) is a schematic diagram for mapping rainfall information determined by each of regions to be treated A, B, C, D, E and X and FIG. 44(b) is a schematic diagram after an elapse of time t. The rainfall information from regions to be treated A, B, C, D, E and X inputted to the control unit 300 is subjected to mapping processing by a rainfall information mapping processing means 731 to make a schematic diagram as shown in FIG. 44(a). Since the rainfall information determined in each of region to be treated A, B, C, D, E and X is continuously or regularly transmitted to the control unit 730, the schematic diagram as shown in FIG. 44(a) comes to the schematic diagram as shown in FIG. 44(b) after an elapse of time t. The above mapping processed rainfall information is shown by strength or weakness of the intensity of rainfall as shown in A.

Then, from the time-series transition (see FIG. 44) of the rainfall information which has been continuously or regularly transmitted and subjected to mapping process, the time for the beginning of rainfall, the amount of rainfall and the duration of rainfall in region to be treated X are estimated by a rainfall estimation processing means 732. Further, the rainfall information estimation processing means 732 finds an estimated amount 733 of rainfall, an estimated intensity 734 of rainfall and an estimated inflow amount 735 of water to be treated which falls into the disinfecting apparatus in the sewage treatment plant (sewage treatment facility) 710 in region to be treated X from the estimated time for the beginning of rainfall, amount of rainfall and duration of rainfall. The estimated amount 733 of rainfall, estimated intensity 734 of rainfall and estimated inflow amount of 735 thus found are inputted to a known coliform organism count estimation processing means 736. In the coliform organism count estimation processing means 736, the turbidity 751 of inflow water of water to be treated flowing into the disinfecting apparatus which is measured by a turbidity measuring means 750 installed in the sewage treatment plant 710 is inputted.

The coliform organism count estimation processing means 736 estimates a coliform organism count from the above described estimated amount 734 of rainfall, estimated amount 735 of inflow water and the turbidity 751 of inflow water, and estimates the amount 736a of the agent added, the consumption 736b of the agent and the time 736c to start the operation of the drainage disinfecting apparatus which are necessary for the estimated coliform organism count.

Next, by a measured value determining means 753 installed in the sewage treatment plant 710 of region to be treated X, the amount 753 of rainfall, the intensity 754, the amount 755 of inflow water of the drainage flowing into the drainage disinfecting apparatus, the amount 756 of the agent of a halogen-based agent supplied to the drainage disinfecting apparatus and the residual agent concentration 757 in discharged water of drainage from the drainage disinfecting apparatus in the sewage treatment facility are measured. The measured amount 753 of rainfall, the intensity 754 of rainfall, the amount 755 of inflow water, the amount 756 of the agent supplied and the residual agent concentration 757 in the discharge water are inputted to an estimated value/measured value compensation processing means 737.

The estimated value/measure value compensation processing means 737 finds compensated values of each of the estimated value of the amount 736a of the agent, the compensation 736b of the agent and the time 736c to start the operation of the drainage disinfecting apparatus from the above inputted amount 753 of rainfall, the intensity 754 of rainfall, the amount 755 of inflow water, the amount 756 of the agent supplied and the residual agent concentration 7578 in the discharge water. Each compensated value thus found is summation-processed by compensation summation processing means 737a, 737b, 737c to be added to the amount 736a of the agent, the consumption 736c and the time 736c to start the operation of the drainage disinfection apparatus to find the amount 741 of the agent added, the consumption 742 of the agent and the time 743 to start the operation of the drainage disinfecting apparatus.

The control unit 730 controls the operation of the drainage disinfecting apparatus, the amount of the agent added and the consumption of the agent by each of the estimated values of the amount 741 of the agent added, the consumption 742 of the agent and the time 743 to start the operation of the drainage disinfecting apparatus which are found by the summation processing of above described each value. The amount 741 of the agent added is used as an actual set value of the amount of the agent added to the drainage disinfecting apparatus in the real time control of the addition of the agent. The consumption 742 of the agent is used for demanding of an operator the correction of the amount of the agent by sounding an alarm or the like for insufficiency of the agent added to the drainage disinfecting apparatus by comparing the amount of the agent held in stock by the sewage treatment plant 710.

As described above, the rainfall information estimation processing means 732 estimates the time for the beginning of rainfall, the amount of rainfall and the duration of rainfall based on the rainfall information determined by each rainfall determining means 720 in each of region to be treated A, B, C, D, E and X and, simultaneously, finds an estimated amount 733 of rainfall, an estimated intensity 734 of rainfall and an estimated inflow amount 735 in the sewage treatment plant 710 of region to be treated X, and from the estimated amount 733 of rainfall, the estimated intensity of rainfall 734 and the estimated inflow amount 735, the coliform organism count estimation processing means 736 estimates a coliform organism count and estimates the amount 736a of the agent added, the consumption 736b of the agent and the time 736c for starting the operation of the drainage disinfecting apparatus which are necessary for the control of the drainage disinfecting apparatus with respect to this estimated coliform organism count, and accordingly each estimated value can be obtained in real time.

The coliform organism estimation processing means 736 estimates the amount 736a of the agent added, the consumption 736b of the agent and the time 736c to start the operation of the drainage disinfecting apparatus from the estimated amount 733 of rainfall, the estimated intensity 734 of rainfall, the estimated inflow amount 735 and the turbidity 751 of the inflow water, and accordingly each estimated value can be precisely obtained.

Moreover, the estimated value/measured value compensation process means 737 finds compensated values from the amount 753 of rainfall, the intensity 754 of rainfall, the amount 755 of inflow water, the amount 756 of the agent supplied and the residual agent concentration 757 in the discharged water, and each compensated value is summation-processed to the amount 736a of the agent added, the consumption 736b of the agent and the time 763c to start operation of the drainage disinfecting apparatus by compensated value summation processing means 737a, 737b, 737c to find the amount 741 of the agent added, the consumption 742 of the agent and the time 743 to start the operation of the drainage disinfecting apparatus, and accordingly each estimated value can be further precisely obtained.

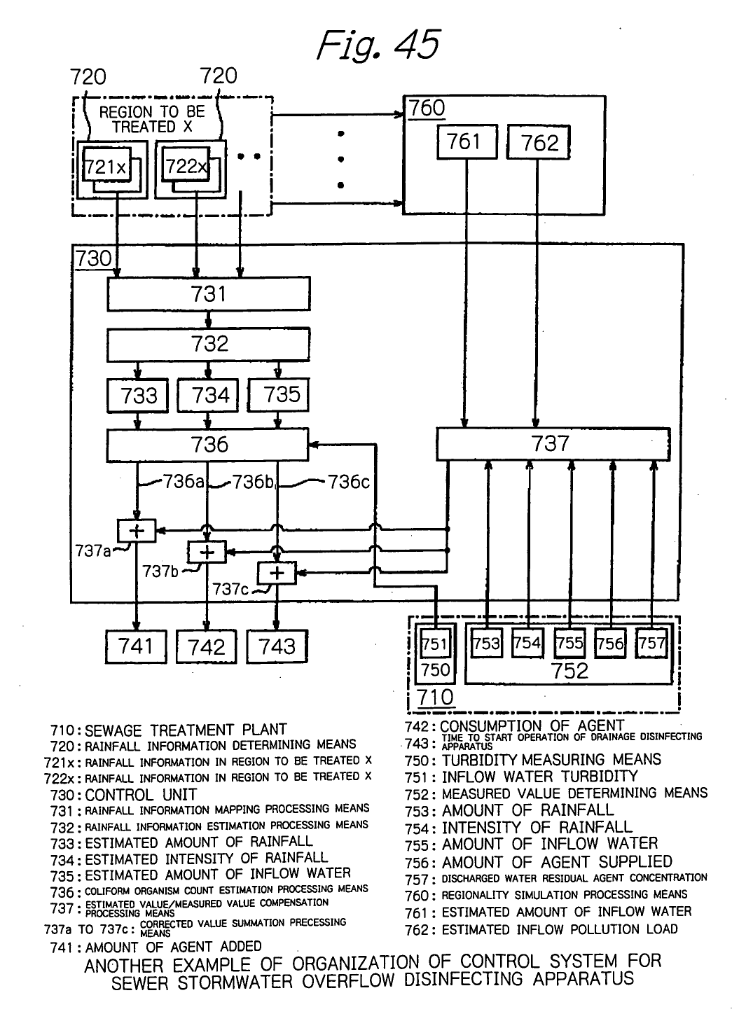

FIG. 45 is a diagram showing another constituting example of the control system for the drainage disinfecting apparatus. The basic constitution of the control unit of the disinfecting apparatus as shown in FIG. 45 is nearly equal to the control unit of the drainage disinfecting apparatus as shown in FIG. 43 and its explanation will be omitted. The present control system for the disinfecting apparatus has a regionality simulation means 760 as a different point from the control system or drainage disinfecting apparatus as shown in FIG. 43.

The rainfall information 721x, 722x . . . such as the amount of rainfall and the intensity of rainfall determined by each rainfall determining means 720 in region to be treated X is inputted to the rainfall information mapping processing means 731 in the control unit 730 and, simultaneously, to the regionality simulation means 760. The regionality simulation means 760 is a commercially available regionality simulation software program which performs hydraulic/water quality analysis by inputting geological information, a rainwater collection route, a sewer network, a sewage discharge port and sewage discharge species such as initial conditions and then inputting the above described rainfall information 721x, 722x . . . as the set initial conditions.

The regionality simulation means 760 finds an estimated amount 761 of inflow water of drainage and an estimated inflow pollution load 762 which flows into the drainage disinfecting apparatus from the rainfall information in region to be treated X. The estimated amount 761 of inflow water and the estimated inflow pollution load 762 thus found are inputted to an estimated value/measured value compensation processing means 737 together with the amount 753 of rainfall, the intensity 754 of rainfall, the amount 755 of inflow water, the amount 756 of the agent supplied and the residual agent concentration 757 in the discharged water measured by a measured value determining means 752.

The estimated value/measured value compensation processing means 737 finds compensated values for the amount 736a of the agent added, the consumption 736b of the agent and the time 736c to start the operation of the disinfecting apparatus from the amount 735 of rainfall, the intensity 754 of rainfall, the amount 755 of inflow water, the amount 756 of the agent supplied, the residual agent concentration 757 in the discharged water inputted. Each of the compensated values is summation-processed by compensated value summation processing means 737q, 737b, 737c to be added to each of the estimated values of the amount 736a of the agent added, the consumption 736b of the agent and the time 736c to start the operation of the drainage disinfecting apparatus from the coliform organism count estimation summation processing means 736, and each of the estimated values of the amount 741 of the agent added, the consumption 742 of the agent and the time 743 for starting the operation of the drainage disinfecting apparatus are found. The control unit 730 controls the operation of the drainage disinfecting apparatus, the amount of the agent added and the consumption of the agent by each of the estimated values.

As described above, the estimated value/measured value compensation processing means 737 finds compensated values for compensating the amount 736a of the agent added, the consumption of the agent and the time 736a to start the operation of the drainage disinfecting apparatus from the estimated amount 761 of inflow water and the estimated inflow pollution load 762 obtained by the regionality simulator means 760, and each compensated value is subjected to summation processing to be added to the amount 736a of the agent added, the consumption of the agent, and the timer 736c to start the operation of the disinfecting apparatus from the coliform organism count estimation means 736 by compensated value summation processing means 737a, 737b, 737c, and thus each estimated value can be more precisely obtained.

Further, in the above explained form example, only the rainfall information 721x, 722x, . . . determined by each rainfall information means 720 in region to be treated X is inputted to the regionality simulation means 760 but the present invention is not limited to this example, and each rainfall information of region to be treated X and the adjacent regions to be treated A, B, C, D and E may be inputted to the regionality simulation means 760.

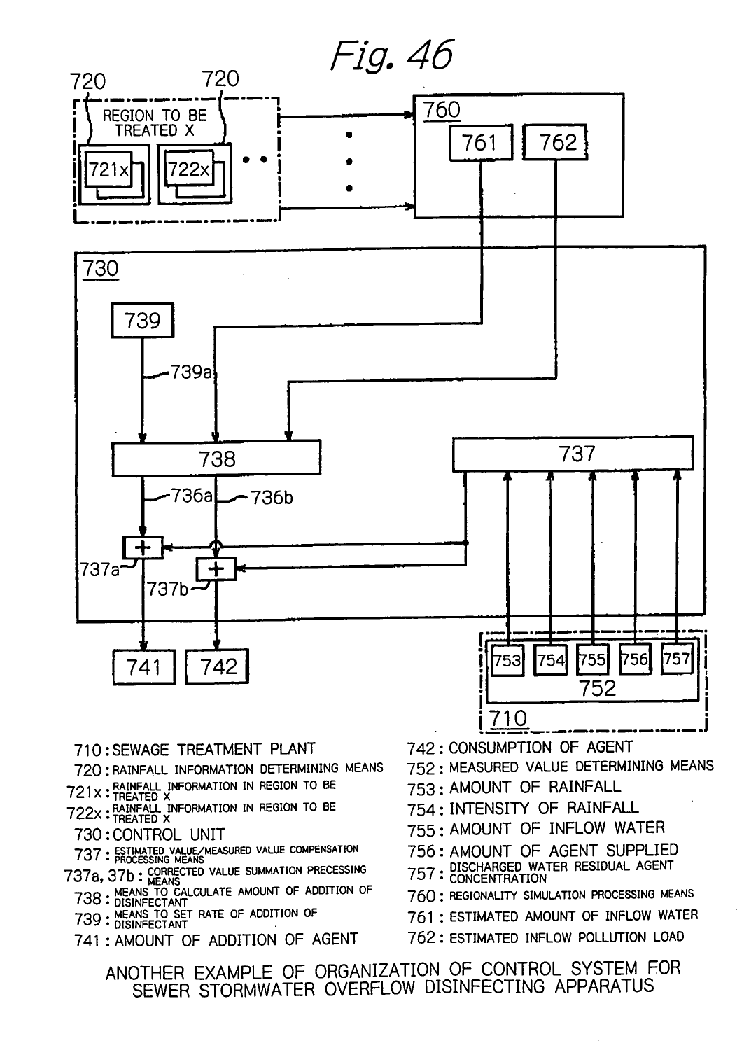

FIG. 46 is a diagram showing another constitution of the control unit for the disinfecting apparatus. First, rainfall information 721x, 721x, . . . such as the amount of rainfall and the intensity of rainfall determined by each rainfall information determining means 720 in region to be treated X is inputted to a regionality simulation means 760.

The regionality simulation means 760 finds an estimated amount 761 of inflow water of water to be treated and its estimated inflow pollution load 762. The estimated amount 761 of inflow water and the estimated inflow load 762 thus found are inputted to an agent addition amount calculation processing means 738.

Further, to the agent addition amount calculation processing means 738, the rate of addition 739a of the agent set by an agent addition rate setting means 739 to set the rate of addition of the agent based on the drainage flowing into a disinfecting apparatus beforehand. The agent addition amount calculation processing means 738 estimates the amount 736a of the addition of the agent and the consumption 736b of the agent from the rate of addition 739a of the agent, the estimated amount 761 of inflow water and the estimated inflow pollution load 762 thus inputted.

By a measured value determining means 752 provided in a sewage treatment plant (sewage treatment facility) 710 in region to be treated X, the amount 753 of rainfall, the intensity 754 of rainfall, the amount 755 of inflow water, the amount of supply 756 of an agent and the residual agent concentration 757 in the discharged water are determined. The amount 753 of rainfall, the intensity 754 of rainfall, the amount 755 of inflow water, the amount of supply 756 of the agent and the residual agent concentration 757 in the discharged water thus determined are inputted to an estimated value/measured value compensation processing means 737 of a control unit 730.

The estimated value/measured value compensation processing means 737 finds compensated values to compensate each of the estimated values of the amount of addition 736a of the agent and the consumption 736b of the agent from the agent addition amount calculation processing means 738 from the above inputted amount 753 of the rainfall, intensity 754 of rainfall, amount 755 of inflow water, amount of supply 756 of the agent and residual agent concentration 757 in the discharged water. Each of the compensated values is summation-processed and added to each of the estimated values of the amount 736a of addition of the agent and the consumption 7236b of the agent from the agent addition amount calculation means 738 by compensated value summation processing means 737a, 737b to find an amount of addition 741 of the agent and a consumption 742 of the agent. The control unit 723 controls a drainage disinfecting apparatus by the amount of addition 741 of the agent and the consumption 742 of the agent.

As described above, from the rainfall information 721x, 722x, . . . determined by each rainfall information determining means 720 in region to be treated X, the estimated amount 761 of inflow water and the estimated inflow pollution load 762 are found by the regionality simulation means 760, and the agent addition amount calculation means 738 estimates the amount of addition 741 of the agent and the consumption 742 of the agent from the estimated amount 761 of inflow water, the estimated inflow pollution load 762 and the rate of addition 739a of the agent set by the agent addition rate setting means 739, and accordingly each estimated value can be obtained in real time.

In the above explained form example, only each rainfall information determining means 720 in region to be treated X is inputted to the regionality simulation means 760 but the present invention is not limited to this case, and each rainfall information in region to be treated X and the adjacent regions to be treated A, B, C, D and E may be inputted to the regionality simulation means 760.

Furthermore, the apparatus for disinfecting sewer stormwater overflow of the present invention can have an abnormality detection mechanism (solid bromine-based disinfectant addition amount detection means) which can detect excess or insufficient amount of addition of a solid bromine-based disinfectant.

The solid bromine-based disinfectant addition amount detection means which can be used in the present invention is a means to detect excess and/or insufficient amount of addition of a halogen-based disinfectant by determining that the residual halogen concentration in water to be treated measured immediately after addition of the solid disinfectant and that measured in a discharge waterway to which the water to be treated after addition of the disinfectant is discharged exceed a predetermined threshold or by comparing both residual halogen concentrations to each other. In the other words, when the residual halogen concentration measured with the water to be treated immediately after addition of the disinfectant and that measured in the discharge waterway exceed respective predetermined thresholds, the amount of addition of the halogen-based agent is detected being in excess or insufficient. Further, when the residual halogen concentration measured with the water to be treated immediately after addition of the halogen-based agent is compared to that measured in the discharge water way, if the difference between these concentrations which is taken as the consumption of the disinfectant is lower than the lower level threshold of the consumption of the disinfectant set beforehand, a more than necessary amount of the disinfectant is added without being consumed, and the amount of addition of the halogen-based agent is detected being in excess.

Further, the solid bromine-based disinfectant addition amount detection means is a means to detect excel and/or insufficient amount of addition of the solid bromine-based disinfectant by comparing the amount of the solid bromine-based disinfectant held in stock (consumption found from the amount held in stock) to the amount of discharge. That is, when the ratio of an error between the actual consumption found from a difference in the amount of the solid bromine-based disinfectant held in stock and the amount of discharge measured by measuring instruments such as the number of revolution and the flow meter exceeds the higher level threshold and the lower level threshold (ratio) of the agent discharge/addition amount set beforehand, the amount of the agent is detected being in excess.

Further, the solid bromine-based disinfectant addition amount detection means is a means to detect excess amount of addition of the solid bromine-based disinfectant by image-monitoring living fishes. That is, when the image-monitored population of fishes inhabiting in the discharge waterway which is judged floating dead or weakened exceeds the higher level threshold of the population of floating fishes set beforehand, the addition of the agent is judged in excess and detected.

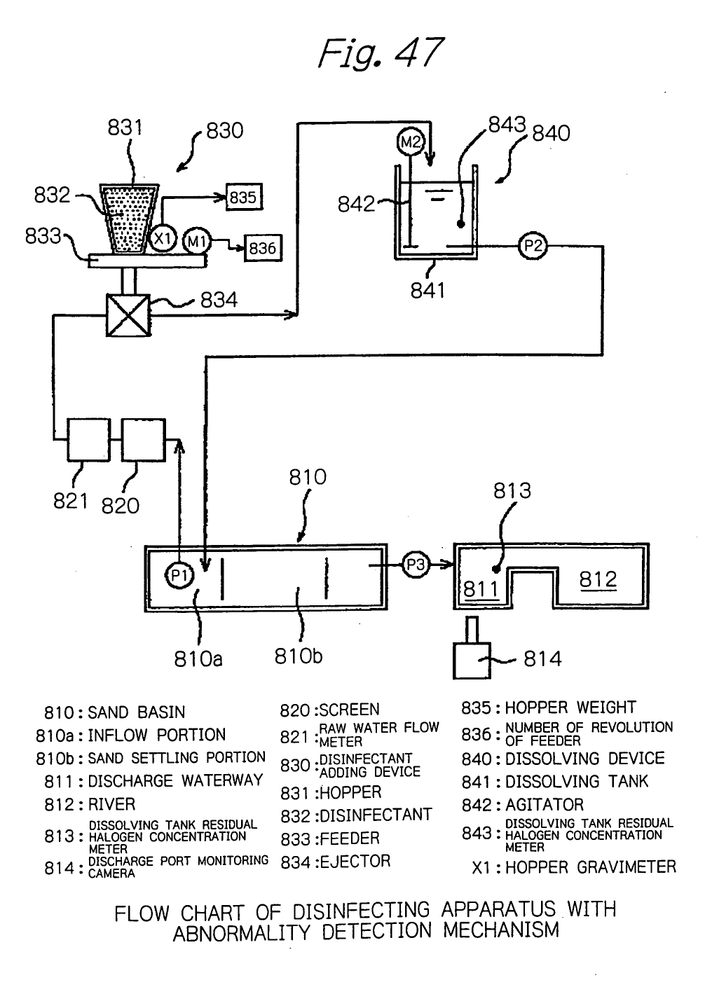

FIG. 47 is a flow sheet showing the state of disinfecting water to be treated by one working embodiment of the disinfecting apparatus having an abnormality detection mechanism which can be used in the present invention and illustrates, as one example, a system of dissolving a powdered or granular solid bromine-based disinfectant in water to form disinfecting water and adding this disinfecting water to water to be treated. The following constitution of the apparatus can be applied to disinfectant storing/feeding devices of various forms as explained above and the disinfecting apparatus of a system of introducing the solid bromine-based disinfectant as such to water to be treated. In the following explanation, the form of disinfecting sewer stormwater overflow in a sand basin but the constitution can be applied to various forms of disinfecting sewer stormwater overflow in the channel as explained above.

In FIG. 47, numeral 810 is a sand basin into or from which sewer stormwater overflow to be disinfected by a disinfecting apparatus flows. And, the sewer stormwater overflow flowing into an inflow portion 810a of the sand basin 810 is partially pumped up by a pump P1, and foreign substances are removed by a screen 820, and the flow rate is measured by a raw water flow meter 821, and thereafter the water thus treated is sent to a disinfectant adding device 830.

In the disinfectant adding device 830, a solid bromine-based disinfectant 832 introduced into a hopper 831 is supplied in predetermined amounts from a feeder 833 to an ejector 834 by actuating a motor M1, and added to drainage. The water added with the disinfectant is sent to a dissolving tank 841 of a dissolving device 840, agitated by an agitator 842 driven by a motor M2 to securely dissolve the disinfectant in water, and returned to the inflow portion 810a of the sand basin 810 by a pump P2 to disinfect the water to be treated, and thereafter the water thus treated is discharged from a discharge waterway 811 via a sand settling portion 810b to public water body 812 such as rivers.

In the apparatus as will be explained below, three types of abnormality detection means are provided in order to secure inhibition of excess disinfection or failure of disinfection of water to be treated for carrying out the above described disinfection. That is, the apparatus has a means to detect excess or insufficient amount of addition of an agent, a means to monitor secure execution of addition of the agent and a means to compensate the judgment on excess addition of the agent. Explanation will be made below.

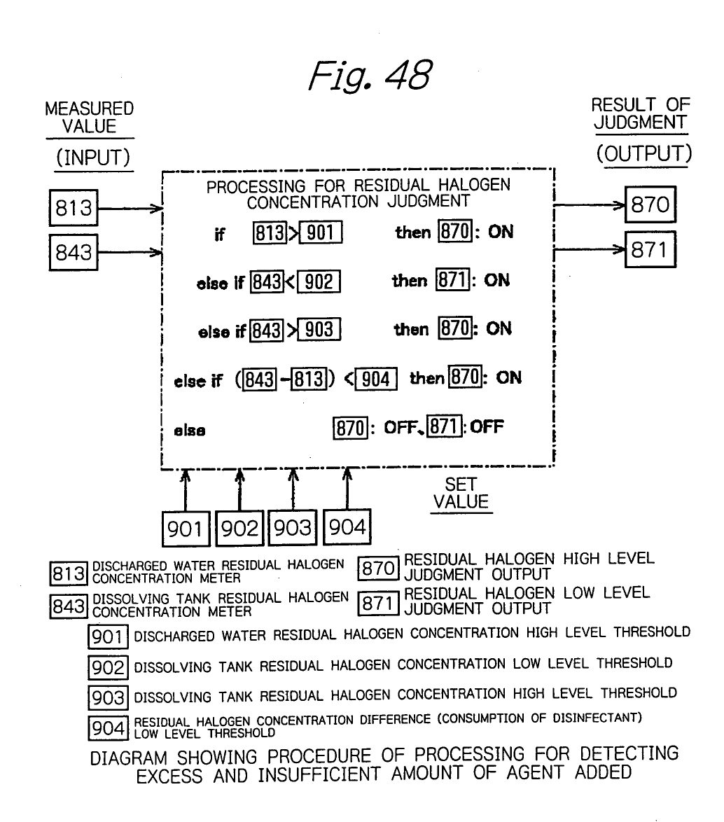

In order to execute disinfection, it is necessary to detect excess or insufficient amount of addition of the agent to inhibit excess disinfection or failure of disinfection of water to be treated. Then, residual halogen concentration meters 813, 843 are installed in the discharge waterway 811 and the dissolving device 840, respectively, and both measured values are inputted to a computer (electrical circuit) not shown in the Figure to detect excess or insufficient amount of addition of the agent in accordance with procedure of processing as shown in FIG. 48.

Namely, in FIG. 48, first, the residual halogen concentration measured in the discharge waterway 811 by the residual halogen concentration meter 813 and that measured in the dissolving device 840 by a residual halogen concentration meter 843 are inputted. And, in the residual halogen concentration judgment process flow in FIG. 48, first, the residual halogen concentration measured in the discharge waterway 811 by the residual halogen concentration meter 813 is compared to the higher level threshold 901 of the residual halogen concentration in discharged water set beforehand, and if the former concentration is higher than the latter concentration, the addition of the agent is judged in excess and a residual halogen higher level judgment output 870 is outputted.

Next, the residual halogen concentration measured in the dissolving device 840 by the halogen concentration meter 843 is compared to the lower level threshold 902 of the residual halogen concentration in the dissolving device set beforehand, and if the former concentration is lower than the latter concentration, the addition of the agent is judged insufficient, and a residual halogen lower level judgment output 871 is outputted. Then, the residual halogen concentration in the dissolving device 840 is compared to the higher level threshold 903 of the residual halogen concentration in the dissolving device set beforehand, and if the former concentration is not lower than the latter concentration, the addition of the agent is judged in excess and a residual halogen higher level judgment output 870 is outputted.

Furthermore, the difference between the residual halogen concentration measured in the dissolving device 840 by the residual halogen concentration meter 843 and that measured in the discharge waterway 811 by the residual halogen concentration meter 813 is taken as a consumption of the disinfectant, and if this consumption is less than the lower level threshold 904 of the residual halogen concentration difference set beforehand, the addition of the agent is judged in excess, and a residual halogen higher level judgment output 870 is outputted. In other words, since the consumption of the disinfectant increases with increased amounts of substances to be treated, reduced consumptions of the disinfectant mean a more than necessary amount of the disinfectant added (in spite of not much amount of substances to be disinfected). Thus, even if each of the residual halogen concentration in the dissolving device 840 and that in the discharge waterway 811 is independently in a predetermined acceptable numerical value range, the amount of addition of the disinfectant is judged in a more than necessary amount of addition.

According to the above described detection means, since excess or insufficient amount of addition of the agent can be judged by comparing the residual halogen concentration measured in the dissolving tank 841 (that is, the residual halogen concentration in the drainage immediately after the addition of the halogen-based disinfectant) and that measured in the discharge waterway 811 downstream of the dissolving tank to the residual halogen concentration threshold set beforehand, excess or insufficient amount of addition of the agent can be judged more quickly and more surely without retarding the time taken between the addition of the agent and the point of measurement than in the conventional case of measuring the residual halogen concentration in the discharge waterway 811 alone. Furthermore, by comparing the residual halogen concentrations measured at two points to each other to judge excess addition of the agent, the difference in these concentrations is taken as a consumption of the disinfectant to judge excess addition of the agent, and thus from this viewpoint, excess addition of the agent can be judged.

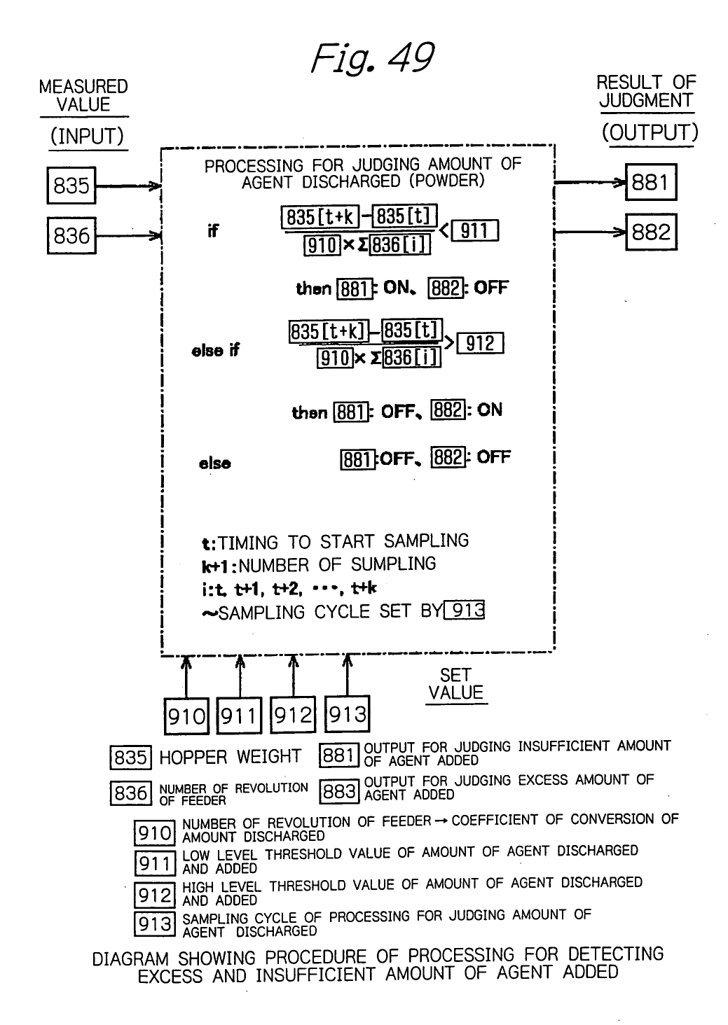

For executing disinfection, it is necessary to monitor secure execution of addition of an agent. Then, the weight 835 of the hopper is metered by a hopper gravimeter X1 provided on a hopper 831 of a disinfectant adding device 830 and the number of revolution of a motor M1 is measured and both measured values are inputted to a computer (or a electrical circuit) not shown in the Figure to monitor secure execution of addition of the agent in accordance with the procedure of processing shown in FIG. 49.

Namely, in the agent discharge amount judgment processing flow of FIG. 49, first, if the ratio of the amount of a powdered or granular agent discharged found by multiplying the number of revolution 836 of the feeder which has performed (k+1) times of sampling on an agent discharge judgment processing sampling cycle 913 starting at time t set beforehand by (number of revolution of feeder minus discharge amount conversion coefficient) 910 to the amount of a powdered agent consumed found from the difference in the hopper weight 835 at time t and time t+k is less than the agent discharge/addition amount lower level threshold 911 set beforehand, the addition of the agent is judged in excess to output an agent insufficient addition amount judgment output 881. That is, the consumption of the powdered agent obtained from the difference in the hopper weight 835 ought to agree with the amount of the powdered disinfectant discharged found by the number of revolution 836 of the feeder but a larger amount of the powdered agent discharged found from the number of revolution 836 of the feeder than the amount of the powdered agent discharged found from the difference in the hopper weight 835 means that the amount of the powdered agent discharged found from the number of revolution 836 of the feeder is seemingly larger than the actual amount of discharge, and a predetermined amount of the powdered agent discharged cannot be obtained by the number of revolution 836 of the feeder decided to obtain the predetermined amount of the powdered agent discharged, and as a result, the number of revolution has to be increased or that due to the mechanical failure of the feeder 833, the predetermined amount of the powdered agent cannot be obtained, that is the addition of the agent becomes insufficient.

On the other hand, if the ratio of the amount of the powdered agent discharged to the amount of powdered agent consumed is not lower than the agent discharge/addition amount higher level threshold 912 set beforehand, the amount of addition of the agent is judged in excess to output an agent excess addition amount judgment output 882. Unless either condition is met, no output is issued.

Thus, by comparing the amount of the powdered agent discharged to that of the powdered agent consumed, it is possible to monitor whether or not the addition of the agent is surely executed.

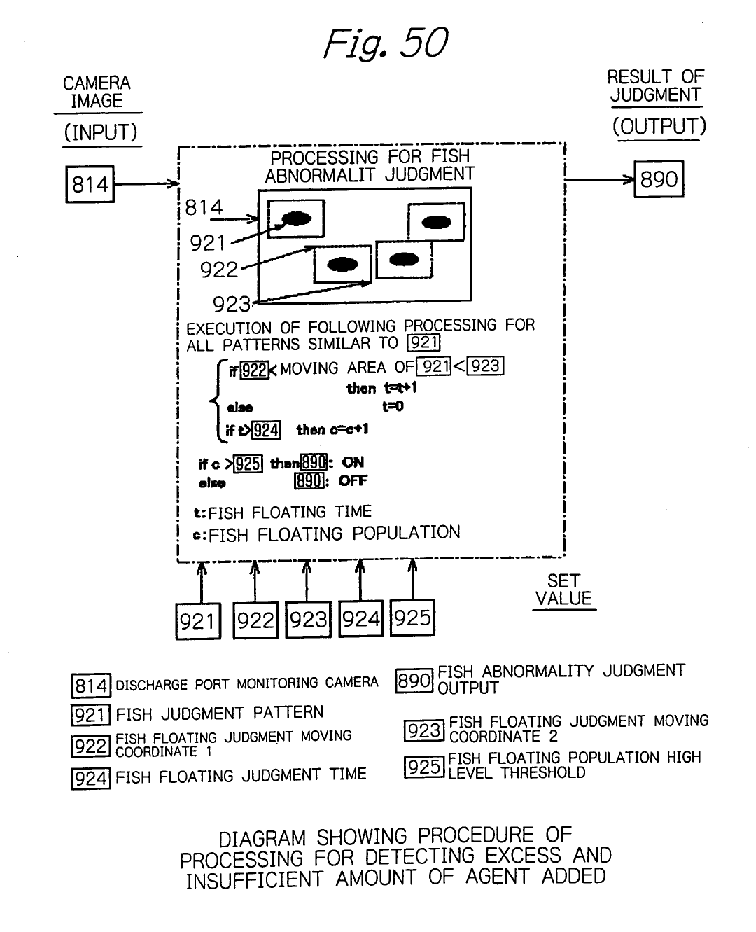

Even when the judgment of excess or insufficient addition of the agent becomes impossible due to the measurement abnormality of the residual halogen concentration meters in the disinfecting apparatus, in order to compensate this measurement abnormality by the residual halogen concentration meters for executing disinfection, a fish inhabitable state judgment processing in the discharge waterway by using an image processing technique as shown in FIG. 50 can be executed.

Namely, a discharge port monitoring camera 814 is installed at a discharge port of the discharge waterway 811 and in the fish abnormality judgment processing flow shown in FIG. 50, image data of the discharge port monitoring camera 814 are compared in pattern to the fish judgment pattern 921 set beforehand to judge a similar image pattern as fishes inhabiting in the discharge waterway. And, two moving area coordinates 922, 923 for floating fish judgment showing the surrounding area, that is, fish moving area are defined by the coordinates first detected for each image pattern judged as fishes, and when the image pattern judged as fishes stays in the coordinate area (surrounded by a dotted line) in more than the time set beforehand defined by the floating fish judgment time 924, the fishes are judged as fishes dead or weakened. The above described judgment processing is performed for all image patterns judged as fishes, and if the population of floating fish is higher than the floating fish population higher level threshold 925, the addition of the agent is judged in excess to output a fish abnormality judgment output 890.

As described above, the outputs 870, 871, 881, 882, 890 relating to the judged excess or insufficient amount of the agent added are used for informing an operator of the disinfecting apparatus of occurrence of abnormality as an alarm, for running automatic control of increase or decrease in the amount of the agent introduced in accordance with excess or insufficient of addition of the agent, and furthermore for executing automatic stopping of introduction of the agent or automatic introduction of a neutralizing agent, if the agent is excessively added.

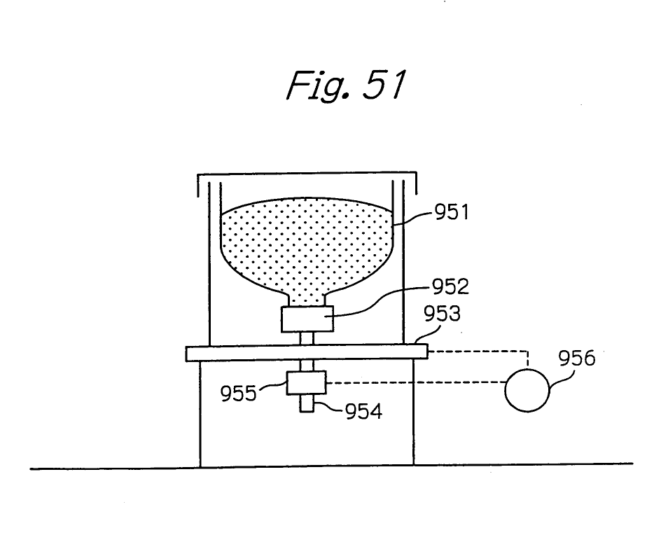

As shown in FIG. 51, a solid bromine-based disinfectant storage tank 951 may be installed on a weighing machine (load cell) 953, and when the rate of supply of the disinfectant is abnormally increased due to the failure of a scraping device 952, a detector 956 detects the abnormal supply to actuate a shut-down device 955 for abnormal supply and by stopping the supply of the solid bromine-based disinfectant from a feeding pipe 954, the environmental deterioration around the discharge port by residual halogens caused by a large amount of the solid disinfectant supplied can be prevented.

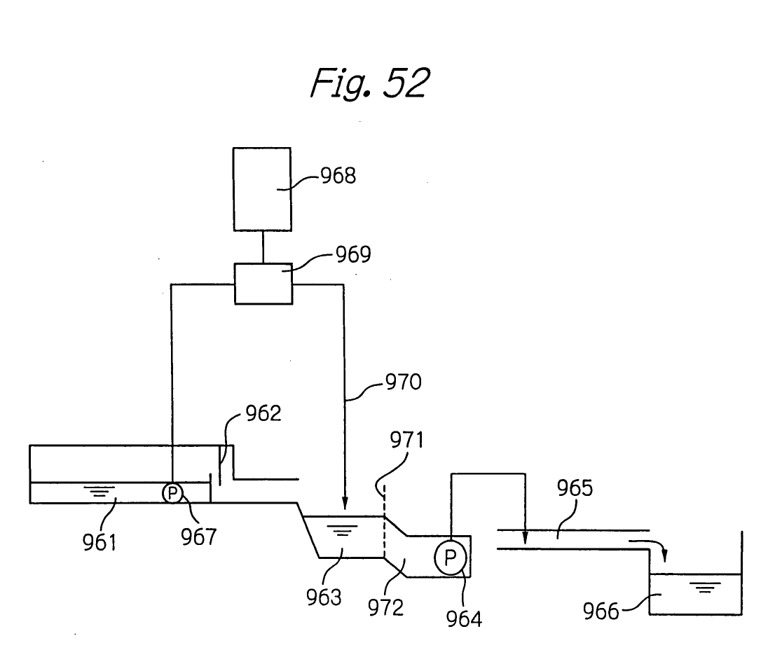

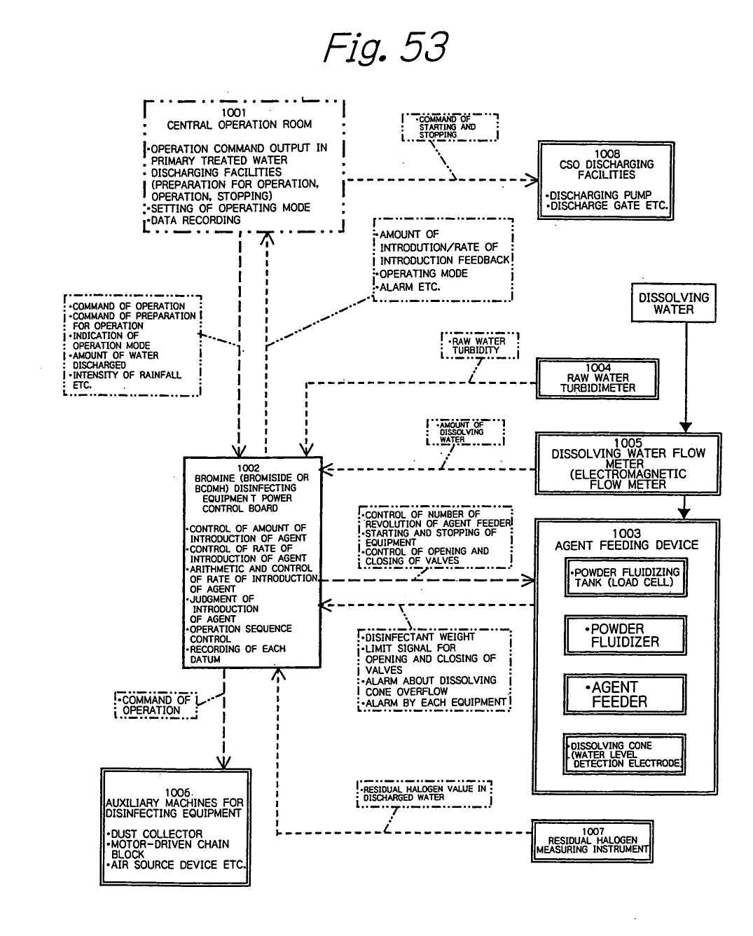

As the method of operating the apparatus for disinfecting sewer stormwater overflow with a solid bromine-based disinfectant according to the present invention, for example, the following method is illustrated. When sewer stormwater overflow to be treated overflow from a pumping station (stormwater pumping station) of a combine or separated sewer, discharge of the overflow is often conducted as follows. In the pumping station, a sand basin or rainwater storing facilities are arranged. In FIG. 52, when the amount of sewage flowing into a sewer 961 is increased by mixing with rainwater, a movable gate 962 is opened and the rainwater-containing sewage overflows (sewer stormwater overflow). This overflow is held in the sand basin or the rainwater storage facilities 963 and flow into a pump well facilities 972 through a screen. A rainwater pump 964 is installed in the pump well facilities 963 and actuated after an elapse of a predetermined time since the movable gated 962 has been opened, and the sewer stormwater overflow in the sand basin or the rainwater storage facilities 963 is guided to a discharge waterway 965 and discharged from the discharge waterway 965 to public water body such as rivers. A plurality of rainfall pumps 964 are arranged and by the water level in the pump well 972, the number of the rainwater pumps 964 to be operated is controlled. In this case, when the movable gate 962 is actuated and sewer stormwater overflow flows into the sand basin or the rainwater storage facilities 963, first, the pump 967 is actuated and part of the sewer stormwater overflow is withdrawn and mixed with the solid bromine-based disinfectant 968 in a mixing device 969 to prepare disinfecting water, and this disinfecting water can be introduced into the sand basin or the rainwater storage facilities 963. In this instance, a predetermined amount of the solid bromine-based disinfectant calculated from the volume of the sand basin or the rainwater storage facilities 963 can be added to the sand basin or the rainwater storage facilities 963 beforehand to sterilize the sewer stormwater overflow dwelling therein. Thereafter, once discharge of sewer stormwater overflow to public water body is started by operating the rainwater pump 964, the amount of the disinfectant supplied can be controlled by introducing an appropriate amount of the solid bromine-abased disinfectant in accordance with the flow amount of the overflow. In FIG. 52, a system of dissolving the solid bromine-based disinfectant into water to form disinfecting water and introducing this disinfectant water to sewer stormwater overflow is taken but system of introducing the solid bromine-based disinfectant as such into sewer stormwater overflow in the sand basin may be employed. Such control is preferably remotely performed in control facilities by transmitting monitored values of the amount of water in a sewer stormwater overflow removable facilities, a sewer, a sewage treatment plant and the like, the residual halogen concentration, a signal for opening the discharge gate (movable gate), a signal for operating the rainwater pump and the like to remote control facilities such as the central control room. That is, it is preferred to control introduction a disinfectant in an unmanned manner at the site of sewer stormwater overflow removal facilities. The concept of such a control system is shown in FIG. 53.

According to the control system as shown in FIG. 53, the control of a bromine-based disinfecting apparatus is automatically performed by a control unit such as a sequencer incorporated in an annexed power control board 1002.

A chemical feeding device 1003 is constituted of a powder fluidizing tank (including a load cell), a chemical feeder, a dissolving cone and annexed valves.

A raw water turbidimeter 1004 continuously out puts the amount of water supply for dissolving a chemical.

A dissolving water flow meter 1005 continuously outputs the amount of supply water for dissolving the agent.

A residual halogen measuring instrument 1007 continuously outputs the residual halogen concentration in discharged water.

A power control board 1002 performs the following controls.

Control of the amount of introduction of the chemical:

Appropriate introduction of the chemical is controlled by incorporating the data on “the amount of water discharged” from the central control board and the data on “the number of revolution” from the feeding device 1002, converting these data to “the amount of the powder supplied” and rendering the rate of introduction constant against the variation in the amount of water.

Control of the rate of introduction of the chemical: The prevention of excess introduction of the chemical is controlled by incorporating the data on “operation time of the feeder” and “the amount of water discharge” and reducing the rate of introduction of the chemical in stages on the assumption that the coliform organism count will be decreased with time.

Arithmetic and control of the rate of introduction of the chemical: Introduction of the chemical is controlled by incorporating the data on “turbidity” from a raw water turbidimeter 1004 and the data on “the amount of water discharged”, “the intensity of rainfall” and “the amount of rainfall” from the central operation room 1001 and calculating the coliform organism count present in the raw water to decide the amount (rate) of introduction of the chemical.

Management of operation sequence: Interlocking operations relating to annexed equipment such as “interlocking operation command” of an auxiliary machines including, for example, a dust collector and “opening and closing” of the gate in CSO discharging facilities 1008 are managed.

Judgment on introduction of the chemical: The amount of a powder in the chemical feeding device 1003 is calculated from the number of revolution of the feeder but this alone cannot detect that the feeder runs dry due to bridge formation of the powder. Thus, a varied weight of the powder is weighed by a load cell in the powder fluidizing section where the chemical is stored to judge the consistency by comparing to the calculated value from the number of revolution.

Recording of each datum: Measured values, failure history and the like from instrumentation are recorded in a recorder in the board.

Further, if necessary, by transmitting operating mode, indication of the state and various types of data are to the central operation room 1001, operation and monitoring can be performed from the central operation room.

After starting discharging water, namely, the amount of introduction of a disinfectant after starting actuating rainwater pumps is gradually reduced in several stages by a timer. For example, in four stages of 0 to 1 hours, 1 to 3 hours, 3 to 5 hours and on and after 5 hours after starting actuating the pumps, the rate of introduction of the disinfectant can be gradually reduced to come to 10 mg/L, 7 mg/L, 5 mg/L and 3 mg/L, respectively. The number of stages of addition of the disinfectant, the duration of each stage, the rate of introduction of the disinfectant in each stage and the like can be suitably varied depending on the information such as the amount of rainfall, the type of rainfall and the forecast of rainfall. For example, addition programs of several patterns are set beforehand and can be selected based on the information such as the amount of rainfall and the type of rainfall. Even in this instance, it is preferred to install a halogen concentration meter downstream of the site of introduction of the disinfectant in the waterway of sewer stormwater overflow to control stopping of introduction of the disinfectant or giving warning when the residual halogen concentration is abnormally high. As safety measures for control equipment, it is preferred to perform control by providing a mechanism of detecting excess introduction of the disinfectant by a residual halogen measuring instrument on the discharging side to stop supply of the disinfectant on detecting excess introduction of the disinfectant, a mechanism of giving warning in the case of no change in weight of the disinfectant storage tank for a specified period of time on the assumption that supply of the disinfectant is stopped due to bridge formation of the disinfectant, a mechanism of detecting a backflow of the disinfectant dissolving water from the dissolving cone above the injector to stop supplying and an a mechanism of detecting an insufficient amount of supplying the disinfectant dissolving water, that is, a lower limit detecting mechanism of an electromagnetic flow meter for abnormality detection to prevent the backflow by closing a valve for supplying the dissolving water.

Examples of the present invention will now be described but the invention is not restricted thereby. In the following examples 1 to 3, drainage was treated by the system shown in FIGS. 4 to 6.

### EXAMPLE 1

Treated sewage containing coliform organisms as water to be treated was subjected to a sterilization test. As a disinfectant, each of 1-bromo-3-chloro-5,5-dimethyl-hydantoin (BCDMH) and sodium hypochlorite was used. The water quality of the water to be treated is shown in Table 1 and the test results are shown in Table 2.

TABLE 1

| Item Analyzed | Measured Value | |
|---|---|---|
| Turbidity | 14 | mg/L |
| SS | 9 | mg/L |
| COD | 17 | mg/L |
| Chromaticity | 22 | mg/L |
| NH₄—N | 22 | mg/L |
| Coliform Organism Count | 12600 | CFU/mL |
| TOC | 9 | mg/L |

TABLE 2

| | Concentration of | Coliform Organism |
|---|---|---|
| Disinfectant | Disinfectant Added | Count |
| Used | (mg/L as Cl) | (CFU/mL) |
| None | 0 | 12600 |
| BCDMH | 0.5 | 10800 |
| | 1.0 | 2300 |
| | 1.5 | 70 |
| | 2.0 | Not detected |
| Sodium | 2.0 | 11800 |
| hypochlorite | 2.5 | 2800 |
| | 3.0 | 300 |
| | 3.5 | Not detected |

BCDMH exhibited a germicidal effect at a concentration of a half or less of the concentration of sodium hypochlorite and decreased the coliform organism count to 3,000 CFU/mL or less when added in a concentration of 1 mg/L or less.

Further, the proportion of the disinfectant added is expressed as active chlorine for each of the bromine-based disinfectant and the chlorine-based disinfectant, and expressed as “mg/mL as Cl” calculated as the active chlorine concentration. For example, when 1 g of BCDMH is added to 1 liter of drainage, its concentration is 540 mg/L as Cl.

As for the reaction time, BCDMH showed a sufficient effect in 1 minute while sodium hypochlorite required a reaction time of 5 minutes or more to show its effect.

### EXAMPLE 2

Drainage from a marine product processing industry was subjected to coagulation, pressurization, floating and separation. Then, the drainage was further treated by an activated sludge process. The resulting drainage was used as water to be treated. A sterilization test of this water was conducted with a varied concentration of a disinfectant. The water quality to be treated is shown in Table 3, and the test results are shown in Table 4.

TABLE 3

| Item Analyzed | Measured Value | |
|---|---|---|
| SS | 42 | mg/L |
| COD | 230 | mg/L |
| NH₄—N | 143 | mg/L |
| Organic Nitrogen | 104 | mg/L |
| Coliform Organism Count | 320000 | CFU/mL |
| TOC | 78 | mg/L |

The organic nitrogen refers to the value of the total organic nitrogen including ammonia and proteins. In the case of a protein, for example, the organic nitrogen refers to the amount of nitrogen atoms in the protein and does not include the amount of carbon atoms or hydrogen atoms in the protein. The organic nitrogen does not include inorganic nitrogen such as ammonia and ammonium ions.

TABLE 4

| | Concentration of | Coliform Organism |
|---|---|---|
| Disinfectant | Disinfectant Added | Count |
| Used | (mg/L as Cl) | (CFU/mL) |
| None | 0 | 320000 |
| BCDMH | 2.0 | 52000 |
| | 2.5 | 2800 |
| | 3.0 | 1200 |
| | 3.5 | Not detected |
| Sodium | 6 | 135000 |
| hypochlorite | 8 | 1900 |
| | 10 | 900 |
| | 12 | Not detected |

BCDMH exhibited a germicidal effect at a concentration of ⅓ or less of the concentration of sodium hypochlorite and decreased the coliform organism count to 3,000 CFU/mL or less when added in a concentration of 2.5 mg/L as Cl.

### EXAMPLE 3

Drainage was treated by the system shown in FIGS. 4 to 6. The results are shown in Table 5.

TABLE 5

| | Amount | | | Coliform | Residual |
|---|---|---|---|---|---|
| | of | Disinfectant | | Organism | Halogen |
| | Sewage | | Amount | Count | Concentration |
| | m³/h | Type*1 | Added*2 | CFU/mL | mg/L (Cl₂) |
| Run 1 | 120 | — | 0 | 97 × 10³ | ND*3 |
| | 120 | A | 6.0 | 83 × 10² | ND |
| | 120 | A | 12.0 | 12 × 10 | 0.18 |
| Run 2 | 250 | — | 0 | 68 × 10³ | ND |
| | 250 | A | 5.0 | 18 × 10² | 0.03 |
| | 250 | A | 10.0 | ≦20 | 0.72 |
| Run 3 | 530 | — | 0 | 39 × 10³ | ND |
| | 530 | A | 3.0 | 28 × 10² | ND |
| | 530 | A | 4.5 | 17 × 10 | 0.12 |
| Run 4 | 250 | — | 0 | 46 × 10³ | ND |
| | 250 | B | 30 | 19 × 10³ | ND |
| | 250 | B | 60 | 41 × 10² | 1.53 |

| | | Electrical Conductivity | TOC | NH₄—N |
|---|---|---|---|---|
| | Turbidity | μS/m | mg/L | mg/L |
| Run 1 | 75 | 825 | 72 | 17.4 |
| | 78 | 835 | | |
| | 76 | 810 | | |
| Run 2 | 52 | 485 | 47 | 4.3 |
| | 57 | 472 | | |
| | 48 | 460 | | |
| Run 3 | 37 | 248 | 40 | 3.5 |
| | 32 | 261 | | |
| | 39 | 273 | | |
| Run 4 | 49 | 420 | 60 | 6.9 |
| | 48 | 428 | | |
| | 46 | 415 | | |

*1A represents BCDMH (active halogen concentration 54%). B represents sodium hypochlorite (active halogen concentration 10%).
*2Amount added (mg/L), calculated as chlorine (Cl₂).
*3ND denotes “Not detected”.

In Run 1 (amount of sewage: 120 m³/hour), the coliform organism count could be decreased to 3,000 CFU/mL or less when the amount of BCDMH added was 12 mg/L.

In Run 2 (amount of sewage: 250 m³/hour), when the amount of BCDMH added was 10 mg/L, disinfection was sufficient but the residual halogen concentration was 0.72 mg/L, which was inappropriate. When the amount of BCDMH added was 5 mg/L, the coliform organism count could be decreased to 3,000 CFU/mL or less and, in addition, the residual halogen concentration was 0.03 mg/L. This was appropriate.

In Run 3 (amount of sewage: 530 m³/hour) corresponds to heavy rainfall. In this case, appropriate disinfection was possible when the amount of BCDMH added was 3 to 4.5 mg/L. On this occasion, the duration of contact of BCDMH with rainwater removal sewage was found to be about 50 seconds, meaning successful disinfection in a very short time.

Run 4 (amount of sewage: 250 m³/hour) is a comparative example in which sodium hypochlorite was used as the chlorine-based disinfectant. In Run 4, even when the amount of sodium hypochlorite added was 60 mg/L, the coliform organism count could not be decreased to 3,000 CFU/mL or less, and the residual halogen concentration was 1.53 mg/L, a higher value than LC₅₀ [concretely, 0.4 mg/L calculated as (Cl₂)]. This is inappropriate.

In all of Run 1 to Run 4, the amount of the disinfectant being 0 corresponds to the incoming water quality of wet-weather sewage which flowed into rainwater removal facilities.

### EXAMPLE 4

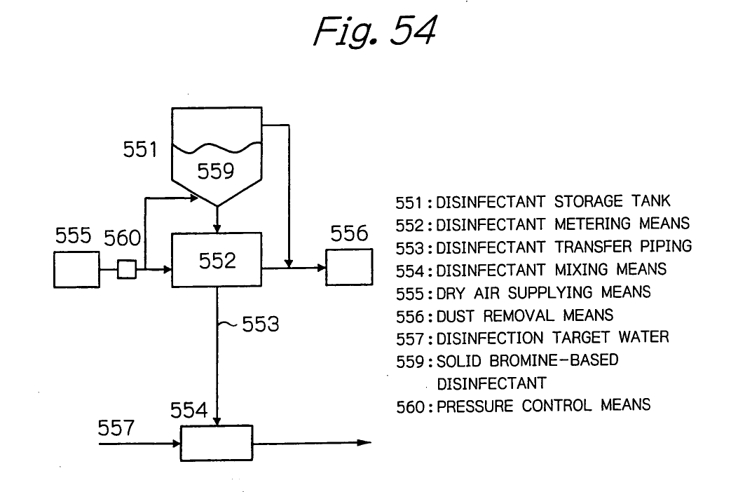

The disinfection of sewer stormwater overflow was executed with the use of the disinfecting apparatus shown in FIG. 54. The specifications of the apparatus are shown in Table 6. The water quality of water to be disinfected is shown in Table 6. As the disinfectant, powdered 1-bromo-3-chloro-5,5-dimethylhydantoin (BCDMH, a product of Ebara Corporation, trade name “Ebasany-4400”) was used. The amount of the disinfectant added and the results of measuring the germicidal effect on the water to be treated after addition of the disinfectant are shown in Table 8.

From these experimental results it has been found that direct addition of the disinfectant in the form of a powder to the water to be treated is effective for rapidly decreasing the coliform organism count up to not more than 3.0×10³ CFU/mL of a discharge regulation value of the remaining coliform organism count.

TABLE 6
Specifications of Apparatus

| Constituting Element | Specifications |
|---|---|
| Disinfectant Storage | Cylindrical, storage volume 1,200 kg |
| Tank 551 | |
| Disinfectant Metering | Table feeder, metering capacity |
| Means 552 | 0.55-4.5 kg/min |
| Disinfectant Transfer | Made of a vinyl chloride resin |
| Piping 553 | |
| Dry Air Supply Device 555 | Refrigeration dehumidifier and |
| | packaged compressor, feeding |
| | capacity 240 L/min × maximum 0.93 MPa |
| Dust Removing Means 556 | Bag filter, Treatment capacity |
| | 10 m³/min |
| Pressure Control Means 560 | Self-operated reducing valve |

TABLE 7
Water Quality of Water to Be Disinfected

| | Immediately | 30 Minutes | 60 Minutes |
|---|---|---|---|
| | after | after | after |
| Item of Water | Starting | Starting | Starting |
| Quality | Test | Test | Test |
| SS mg/L | 340 | 550 | 430 |
| BOD mg/L | 270 | 440 | 360 |
| Coliform Organism | 3.4 × 10⁵ | 7.4 × 10⁵ | 5.5 × 10⁵ |
| Count CFU/mL | | | |

TABLE 8
Amount of Disinfectant Added and Coliform Organism Count

| | | Immediately | 30 Minutes | 60 Minutes |
|---|---|---|---|---|
| | | after | after | after |
| | | Starting | Starting | Starting |
| | | Test | Test | Test |
| Amount of Disinfectant | | 7 | 7 | 7 |
| Added mg/L Amount of | | | | |
| Product Added | | | | |
| Coliform | Target Water for | 3.4 × 10⁵ | 3.4 × 10⁵ | 5.0 × 10⁵ |
| Organism | Disinfection | | | |
| Count | 30 Seconds after | 1.2 × 10⁴ | 4.8 × 10⁴ | 3.0 × 10⁴ |
| | Addition of | | | |
| | Disinfectant | | | |
| | 60 Seconds after | 2.0 × 10³ | 2.2 × 10³ | 9.6 × 10² |
| | Addition of | | | |
| | Disinfectant | | | |
| | 90 Seconds after | 8.2 × 10² | 1.1 × 10³ | 7.0 × 10² |
| | Addition of | | | |
| | Disinfectant | | | |

### EXAMPLE 5

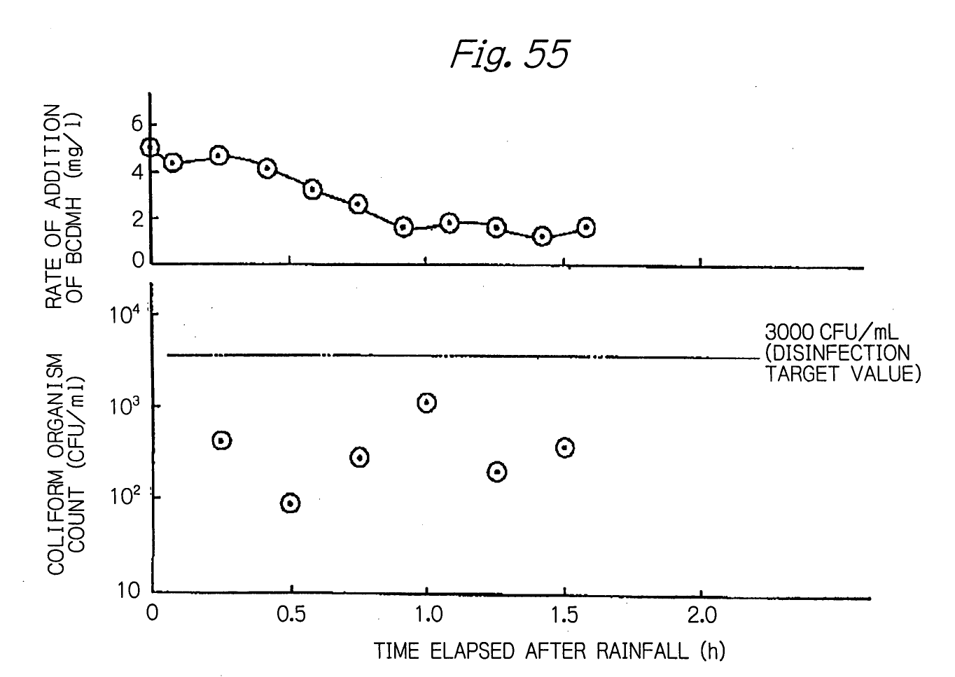

With respect to the sewer stormwater overflow in the sewage treatment facility resulting in FIG. 34 to FIG. 38, the disinfection according to the method of the present invention was executed. As the disinfection device, the device whose constitution is shown in FIG. 39 was used. As the disinfectant, BCDMH was used. While executing disinfection by introducing the disinfectant from a disinfectant introducing means 604, a sample of the water to be treated was collected from the sampling line 612 at a frequency of one time per 10 minutes and introduced into the monitoring tank 613 from the sampling line 612, and a disinfectant 614 having a predetermined concentration was added thereto. The concentration of the disinfectant 614 added here was taken as a disinfectant concentration which was introduced into water to be treated from the disinfectant introducing device 604 at this point of time. Further, the disinfectant concentration on initiation of disinfection was 5 mg/L. The residual halogen concentration in the sample of the water to be treated at the point of time of 20 seconds after BCDMH was added to the sample of the water to be treated in the monitoring tank was measured by a residual halogen concentration measuring instrument 615, and when the measured value was higher than 0.2 mg/L as Cl₂, the concentration of the disinfectant added from the disinfectant introducing means 604 was decreased and on the other hand, when the measured valued was lower than 0.2 mg/L as Cl₂, the concentration of the disinfectant added from the disinfectant introducing means 604 was increased. Disinfection was continued in this manner while adjusting the disinfectant introducing concentration every 10 minutes, and every 15 minutes the coliform organism count in the discharged solution was counted. The result is shown in FIG. 55. From this result, it can be understood that the amount of the disinfectant added varied with time while the coliform organism count in the sewage after treatment could be maintained at the target disinfection value (3,000 CFU/mL) or less.

What is claimed is:

1. A sewer system wherein when sewage flows into a sewage treatment plant in an amount of not more than the treatment capacity of the sewage treatment plant, the sewage is subjected to predetermined treatments in the sewage treatment plant, and then disinfection with a chlorine-based disinfectant, and thereafter discharged to public water body, and when sewage containing rainwater in an amount of more than the treatment capacity of the sewage treatment plant flows or may flow into the sewage treatment plant by a big rainfall, the amount of the rainwater-incorporated sewage exceeding the treatment capacity is branched in sewer stormwater overflow removing facilities in a sewer, then disinfected with a bromine-based disinfectant, and thereafter discharged to public water body while the rainwater-incorporated sewage in an amount within the treatment capacity of the sewage treatment plant is subjected to predetermined treatments in the sewage treatment plant, then disinfected with a chlorine-based disinfectant, and thereafter discharged to public water body.

2. A separated sewer system wherein sewage flowing in the sanitary sewer pipe of the sewer is subjected to predetermined treatments in a sewage treatment plant, then disinfected with a chlorine-based disinfectant, and thereafter discharged to public water body while rainwater flowing in the rainwater pipe of the sewer is discharged from rainwater removing facilities, for example, a pumping station (a stormwater pumping station) to public water body, and rainwater after a big rainfall is disinfected with a bromine-based disinfectant in rainwater removing facilities, and then discharged to public water body.

3. A sewer system wherein when sewage in an amount of not more than the treatment capacity of an aeration tank in a sewage treatment plant flows into the sewage treatment plant, the sewage is subjected to the treatments by a primary sedimentation tank, the aeration tank and a final sedimentation tank in the sewage treatment plant, then disinfected with a chlorine-based disinfectant, and thereafter discharged to public water body, and when rainwater-incorporated sewage containing rainwater in an amount of not more than the treating capacity of the primary sedimentation tank but more than the treatment capacity of the aeration tank flows or may flow into the sewage treatment plant by a big rainfall, the amount of the rainwater-incorporated sewage of more than the treatment capacity of the aeration tank is branched after the treatment by a primary sedimentation tank in the sewage treatment plant, then disinfected with a bromine-based disinfectant, and thereafter discharged to public water body while the rainwater-incorporated sewage within the treatment capacity of the aeration tank, subjected to the treatments by the aeration tank and the final sedimentation tank after the treatment by the primary sedimentation tank, successively disinfected with a chlorine-based disinfectant, and thereafter discharged to public water body.

4. A disinfecting apparatus for combined sewer overflow, separated sewer rainwater overflow or separated sanitary sewer overflow which has a storing/feeding device for a solid bromine-based disinfectant and a disinfectant adding/mixing device for adding and mixing the solid bromine-based disinfectant supplied from the disinfectant adding/mixing device for the solid bromine-based disinfectant to the combined sewer overflow, separated sewer rainwater overflow or separated sanitary sewer overflow.

5. The disinfecting apparatus of claim 4, wherein the storing/feeding device for a solid bromine-based disinfectant has a storage tank for the bromine-based disinfectant and a metering feeder for metering a predetermined amount of the solid bromine-based disinfectant in the storage tank to discharge it, the storage tank and the metering feeder having an agitating means constituted by a plurality of injection openings for injecting compressed air thereinto.

6. The disinfecting apparatus of claim 5, wherein the metering feeder has a rotary table having a metering means.

7. The disinfecting apparatus of claim 6, wherein the disinfectant adding/mixing device has a disinfecting water preparation device which receives part of water to be treated and mixes and dissolves the solid bromine-based disinfectant thereinto and a means to introduce the disinfecting water into the water to be treated.

8. The disinfecting apparatus of claim 7, wherein the disinfectant adding/mixing device is installed in a channel in which the water to be treated flows.

9. The disinfecting apparatus of claim 4 which is constituted by the solid bromine-based disinfectant storing/mixing device and the disinfectant adding/mixing device connected to a storage tank for storing the solid bromine-based disinfectant, respectively, disinfectant transfer piping for transferring the disinfectant in the form of a solid to the point of introduction and a disinfectant introducing device for adding the solid bromine-based disinfectant transferred in the piping to the water to be treated which is connected to the disinfectant transfer piping.

10. The disinfecting apparatus of claim 4, wherein the disinfectant is completely dissolved in the water to be treated while before the disinfectant flows from the site of addition to arrive at the site of discharging the water to be treated.

11. The disinfecting apparatus of claim 4 further comprising a disinfectant addition amount control means having a collection line for collecting a sample of water to be treated, a disinfectant feeding means to add a disinfectant to the sampled water to be treated, an active halogen concentration measuring instrument for measuring the active halogen concentration of the disinfectant added sampled water to be treated, the disinfectant addition amount control means controlling the amount of addition of the disinfectant to the water to be treated by the disinfectant adding/mixing device in accordance with the level of decrease in the active halogen concentration after addition of the disinfectant measured by the active halogen concentration measuring instrument.

12. The disinfecting apparatus of claim 4 further comprising a reducing agent feeding device for adding a reducing agent to the water to be treated after addition of the disinfectant, an active halogen concentration measuring instrument for measuring the active halogen concentration in the water to be treated after addition of the disinfectant and a reducing agent addition amount control unit for controlling the amount of the addition of the reducing agent in accordance with the active halogen concentration in the measured water to be treated after addition of the disinfectant.
